(19) United States
(12) Patent Application Publication
(10) Pub. No.: US 2017/0169520 A1
(43) Pub. Date: Jun. 15, 2017

(54) Time Tracking System and Method

(71) Applicant: Pelorus Technology LLC, Austin, TX (US)

(72) Inventor: Erik Cornet, Austin, TX (US)

(73) Assignee: Pelorus Technology LLC, Austin, TX (US)

(21) Appl. No.: 15/379,410

(22) Filed: Dec. 14, 2016

Related U.S. Application Data
(60) Provisional application No. 62/267,209, filed on Dec. 14, 2015.

(51) Int. Cl. G06Q 40/00; G06Q 30/04

(52) U.S. Cl. CPC G06Q 40/125; G06Q 30/04

(57) ABSTRACT

A system and method to track, report, bill and account for time spent working by a service provider, such as an attorney or other user, is described.

### CROSS REFERENCE TO RELATED APPLICATION

The application claims the benefit of U.S. Provisional Application No. 62/267,209, filed Dec. 14, 2015, the contents of which are incorporated herein by reference.

### FIELD OF THE INVENTION

The field of the current invention generally regards systems and methods for tracking, capturing, billing and reporting on time spent by a service provider, including systems and methods which may link to and operate with electronic devices, client software operating systems universally via automated and manual user prescribed data entry and events.

### BACKGROUND OF THE INVENTION

In the professional services and legal fields, the attorney or other professional spends certain amounts of time during a given day working on various matters. Because such professionals do not manufacture or distribute goods, the value that they provide is typically measured by the amount of time they spend working on a particular matter. Indeed, the one thing that attorneys and other professional service providers have to sell is their time. Accordingly, for many service providers, it is generally imperative that they track their time so that they can account for their effort and doing so via digital methods and approaches that allow a more accurate and refined professional effort and customer/client engagement.

Typically, an attorney or other professional service provider tracks the amount of time spent on various matters throughout each day. And at the end of the month, all the tracked time for the month is typically totaled for the various matters and invoices are generated. However it may be challenging for the attorney or other service provider to accurately track and total time—whether on site or remotely—at the end of the month to ensure that all the tracked time for the month is totaled appropriately for the various matters so that invoices may be generated. As such, business accuracy and correctness may suffer with the use of digital methods and synchronization to ERP solutions.

This level of challenge for an attorney or other service provider to keep track of all the time spent in a given day has become increasingly more complex with the many disparate business process solutions and platforms. In addition to this challenge, attorneys and other professional service providers may be required to work anywhere at almost any time, in close to real time, and at the same time, attempt to keep accurate details of the number of matters in which they are engaged, throughout the day. For example, an attorney may become distracted by handling a number of matters and may simply not track his or her time. Furthermore, if the attorney is working on different matters with various electronic devices, e.g., e-mail, phone, word processing document, he or she may also fail to keep track of the time spent on each device being used on different matters. This problem may increase while the attorney works while traveling.

As a result, portions of a given day spent working on legal or other professional matters may go untracked, such as where the appropriate digital business process orchestration tools and engagement solutions are not fully used. Over the course of a month or a year, untracked time may add up to significant hours which results in significant lost revenue. Accordingly, there is a need for a system and method for an attorney or other professional to readily capture his or her time so that it may be accounted for and billed to a client where appropriate.

Many attorneys and other professional service providers track their time by hand, oftentimes filling out a day planner with different entries. However, this may result in lost time or inaccurately recorded time if the professional service provider or attorney does not diligently record his or her time. Furthermore, tracking time by hand may result in loose papers that may be lost or misplaced. And in this situation, a secretary or other support staff person eventually needs to type handwritten time entries and input them into an accounting system to generate invoices. This is generally inefficient because two people spend time to ultimately record and enter the time into an accounting system. And if the handwriting is illegible, the support staff person may waste time deciphering the time entries.

In recent years, this situation has been somewhat alleviated by time entry software systems coming into widespread use. With such systems, a service professional may type his or her time entries directly into the accounting system. However, not all service professionals want to type in their time. Furthermore, such systems may be difficult to learn and cumbersome to use. Still further, such systems still rely on the service professional or other service provider manually tracking and entering his or her time. As with recording time by hand, if the service professional does not diligently track his or her time spent working on various matters, and then enter the time into the software system, time may be lost or inaccurately recorded.

Accordingly, there is a need for a system and method to efficiently capture, orchestrate and monitor all classes of engagement activities that the service professional spends time on, and enter it into an accounting system that will ultimately generate invoices. This is especially true when considering that the only thing that an attorney or other professional service provider actually “sells” is his or her time.

There is also a need to automatically capture time so that time is not lost or inaccurately recorded. To this end, there is also a need to readily assign captured time to an appropriate matter and to generate invoices, accounting reports and other business analytics based thereon.

### SUMMARY OF THE INVENTION

The current invention addresses the foregoing and other shortcomings by the various inventive aspects described herein.

In a first aspect of the invention, an efficient and improved system and method to track and capture time that an individual spends providing services is described. In this manner, the time which an attorney or other professional service provider spends working on various matters during a given day may be more readily captured and categorized so that time is not lost but is instead more accurately recorded. To this end, the system may automatically start capturing time upon various types of triggers or events. For example, the system may be connected to various electronic devices that a professional service provider may use in a given day, e.g., e-mail, cell phone, land line phone, word processing software, a webpage, etc. The system may then start tracking time when the service provider initiates or answers a phone call on his or her land line or cell phone, opens a received e-mail or starts typing an e-mail, creates or opens a Word document, or begins some other event. The system may continue to track time as the phone call occurs, the service provider reads the e-mail and/or responds, works on the Word document, etc. And when the user finishes working with any of the foregoing devices, the system may stop tracking time so that the time spent on the event is accurately captured.

In this manner, the invention may automatically capture time as opposed to the individual having to affirmatively record time by hand, or enter time into a software program. To provide this automatic capture of time, the system and method of the current invention includes software that serves as an interface between a triggering event (such as the opening of an e-mail) and a timer that tracks time. The captured time may then be sent to the system of the current invention along with other information describing the work performed, the pertinent client matter, etc.

In another aspect of the invention, time that is captured may be deleted from time that ultimately contributes to an invoice and is billed to a client. This is advantageous because while time may be automatically captured upon an event such as making a phone call, if that event turns out to be non-billable, or the user otherwise elects not to bill it, the user may readily delete the time so that it is not billed to a client.

In another aspect of the invention, a system and method for categorizing tracked time according to client matter, practice group, billable or non-billable origin and other parameters is described. In this embodiment, the system may generally store or recall the categorization of time spent on specific emails, documents and other items by their subject line, file names and other characteristics. In this regard, the system may automatically categorize future time spent on the known elements accordingly.

In another aspect of the invention, a system and method regarding the accounting and reporting of time is described. To this end, the invention may perform various accounting functions and analytics regarding recorded time to provide various reports. These accounting and analytical functions may be part of a client devices application environment, supported via an enterprise software ERP service or by connecting to a Software As A Service Cloud environment.

In another aspect of the invention, a system which may interface with a user's device, such as a computer, cell phone, smart phone, smart watch and other devices, and which may track time spent on those devices, is described.

In another aspect of the invention, a series of user interfaces are provided to track, capture, record and bill time. The user interfaces may appear on a desktop or other computer, as well as a tablet, smart phone or other mobile device. The user interfaces preferably provide visual cues to aid the user in tracking time. To this end, the user interfaces may involve different colors to indicate that time is being tracked, or not tracked, to signify that time has been captured and whether it has been readied for billing and whether it has been sent for billing. The user interfaces may also include graphical progress bars that may represent the various time usage metrics. This physical and visual effect aids in the use of the system.

In another aspect of the invention, the system may interface with existing software systems to implement the foregoing benefits. For example, the software of the current invention may interface with Microsoft Outlook and other business process software from social media companies such as Facebook, Twitter, Google Gmail and Apple mail and office products, for tracking time spent reading and/or responding to an e-mail, with Microsoft Word for the time spent typing, revising or otherwise word processing a document, and other systems. Furthermore, the time tracking capabilities described above may be synched with a user's electronic calendar.

This is advantageous because the system of the current invention may be readily implemented with software and networks that are widely used. This allows the system of the current invention to be more readily adopted by users, which in turn may increase the efficiency of the attorneys or other service professionals working at a particular firm.

In another aspect of the current invention, the system may allow the user to place specific programs, applications and webpages on a “do not track” list such that the user's time spent with these programs is not or need not be tracked.

In another aspect of the invention, the system may be integrated with an email and calendar client program such as Microsoft Outlook so that the system may place tracked time usage events within calendars displayed by the program. In this regard, the system may place time usage events that have been properly categorized into specific calendars, and events that have not been properly categorized into different calendars. The system may also provide tools to categorize the various time events, to move the time events from one calendar to another, to combine events within a calendar and to generally manipulate and/or apply other settings to the events.

In another aspect of the invention, the system may track time for “manual” events that may be not be triggered by an electronic device. In this situation, the user may use the system to track by starting a timer. Subsequently, the user may then stop the timer when the manual event is over.

In another aspect of the invention, the system may identify overlapping time events and may provide tools for the user to post the events as-is or to adjust the characteristics and settings of the events accordingly.

In another aspect of the invention, a system which may interface with various third party platforms and systems, such as MS Dynamics AX, is described. For example, the system of the current invention may be used to connect and orchestrate key timing, billing and business intelligence information across disparate operating environments and interfaces. Furthermore, the system of the current invention may be used with automated export services to financial accounting software such as Quickbooks and Xero Accounting Solutions, and with Data File Export Services for Business Intelligence Filing and Visual Representation.

In another aspect of the current invention, the system architecture may structurally include a cloud platform, local components that may reside on the users' local computers and backend components that may reside with the users' backend systems. In addition, databases may be associated with the cloud platform, the local components and the backend systems, and the time tracking system may be able to interface with all of the various databases accordingly. In this regard, data and information may flow between the cloud platform and the local components and their associated databases, both to and from, as well as between the cloud platform and the backend systems and their associated databases, also both to and from. This way, there may be a continuous path for data to flow between all the various elements associated with the time tracking system and the various components of the users' systems. This in turn improves the efficiency and operation of the user's computers as well as the system.

In another aspect of the current invention, the time tracking system may synchronize data across all of the components, databases and systems associated with the time tracking system in order for the most current up-to-date information and data to be available for use by each component and the system as a whole. This ensures the consistency and accuracy of the data across each component across the entire system resulting in accurate data metric calculations.

Other aspects and advantages of the current invention are described herein.

### BRIEF DESCRIPTION OF THE DRAWINGS

Embodiments of the current invention are described herein, by way of example only, with reference to the following drawings.

FIG. 1 shows an overall system diagram.

FIG. 2 shows high level software resident information and feature flow.

FIGS. 3, 3A, 3B, 3B1, 3C, 4, 4B and 4C1 show high level software feature dependency and conditional flow to actionable states around user events, and matter monitoring and documentation review and creation that may lead to billable/non-billable identification and tracking.

FIG. 4C2 shows an unassigned events table.

FIGS. 4D1, 4D2 and 4D3 show the input of time entry information and configuration therefor.

FIG. 5 shows the recording of time spent reading an e-mail.

FIG. 6 shows the manner in which captured e-mail time may be annotated.

FIGS. 7A and 7B show how the tracking of particular e-mail addresses may be avoided.

FIG. 8 shows the tracking of time in the user's calendar.

FIGS. 8A-8L show user interface screens that may be used with a cell phone.

FIG. 10 shows a reference bar where tracked time may be represented in different categories and by different colors or other visual indicia.

FIG. 11 shows a split screen including a typical Microsoft appointment calendar and time sheet calendar for the system where tracked time may be represented in the same manner as in FIG. 10 which preferably provides consistency in the visual indicia of the system.

FIG. 12 shows a time sheet calendar with a reference bar indicating captured time in various categories and objectives.

FIG. 13 shows captured time that has been marked as ready.

FIG. 16 shows the manner in which a captured time event may be deleted.

FIG. 17 shows the manner in which a captured time event may be adjusted in a time sheet calendar.

FIG. 20 shows the manner in which a manual time event may be captured.

FIG. 21 shows the manner in which the time associated with a manual event may be adjusted.

FIG. 22 shows the manner in which the time associated with a manual time event may be adjusted.

FIG. 23 shows how a manual time event may be associated with a particular matter.

FIG. 24 shows how a captured manual time event may be entered into a user's time sheet calendar.

FIG. 25 shows a system icon in the system tray on a computer desktop.

FIG. 26A shows a flowchart representing a system monitoring activities and saving events.

FIG. 26B shows a flowchart representing a system monitoring activities and saving events.

FIG. 27 shows a graphical user interface of an email program and events within calendars.

FIG. 28 shows a system event characterization tool.

FIG. 29 shows a dialog to choose a target project/matter box.

FIG. 30 shows a system event characterization tool.

FIG. 31 shows a system event characterization tool.

FIG. 32 shows a warning dialog.

FIG. 33 shows a system event characterization tool.

FIG. 34 shows a graphical user interface of an email program and events within calendars.

FIG. 35 shows a dialog to choose a target project/matter box.

FIG. 36 shows a system event characterization tool.

FIG. 37 shows a monitor readout.

FIG. 38 shows a graphical user interface of an email program including a system settings toolbar.

FIG. 39 shows a system settings dialog.

FIG. 40 shows a system settings dialog.

FIG. 41 shows a capture time dialog.

FIG. 42 shows a graphical user interface of an email program and contact email settings.

FIGS. 43A, 43B and 43C show screen shots from a calendar program.

FIG. 44 shows an events tracking dialog.

FIG. 45 shows a system event characterization tool.

FIG. 46 shows highlighted overlapping time events within an event characterization tool.

FIG. 47A shows a graphical user interface of an email program with a progress bar.

FIG. 47B shows a progress bar.

FIG. 47C shows a progress bar.

FIGS. 48 and 49 show high level system architectures.

FIGS. 49A-49R show example tables within a local storage.

FIGS. 50A-50K show example tables within a local storage.

FIGS. 51A-51P show example tables within a cloud storage.

### DETAILED DESCRIPTION OF THE PREFERRED EMBODIMENTS

The current invention relates to a system and method to capture time of an attorney or other service provider throughout a given day, to associate that time with a particular matter, to categorize that time as billable or non-billable, to input the captured time into an accounting system, and to provide invoices and other reporting and business analytics functions. The time tracking system of the current invention makes use of the fact that with today's technology, the time spent by an attorney or other professional service provider largely revolves around electronic devices such as computers and telephones.

More specifically, an attorney or other service provider typically spends a significant part of the day reviewing and/or preparing e-mails, working on documents that are opened and closed in a word processing system and making or receiving phone calls from a land line and/or a cell phone. The current invention allows the attorney or other service provider to track the start and end times of their use of any of these devices or software programs to capture time for later processing. The current invention thus allows the attorney to automatically track and capture time by automatically recording the start and end points of a task.

For example, the time that an e-mail is opened may be tracked and the time when the e-mail is closed or responded to may be tracked. In this manner, the time spent addressing an e-mail may be captured. The start and end times spent on a document or a phone call may also be similarly tracked. As such, the current invention allows the attorney to automatically capture time regarding e-mails, documents, land line phone calls and cell phone calls. The current invention also allows the attorney to track “manual” events such as meetings or other events that are not necessarily tied to an electronic device.

The ability of the current invention to track time across multiple devices provides a significant benefit, when considering how professional service providers are faced with the challenge of digital interruption from phone calls, e-mails, impromptu meetings, etc. The challenge becomes even greater when professional service providers must keep track of the time spent on these activities for client billing or internal project management. The current invention addresses this problem of keeping track of time in the overloaded workplace with software and devices that many service providers already use. This includes Microsoft Outlook, Microsoft Word and Excel, and the iPhone and the Android and Windows phones. The current invention connects time tracking data with popular accounting and ERP software, including Dynamics AX, Quickbooks and Xero. Other systems may also be used to receive the tracked-time data through standard CSV data exports.

Beyond the foregoing, the current invention may include add-ins and applications that may communicate with each other and external systems via a web service solution. This is referenced as the Cross Platform Exchange (CPE) herein.

Beyond the foregoing time tracking and capture capabilities, the current invention may also process the captured time in various manners. For example, the user may recognize that all of the time tracked may not be properly billable to a client as when, for example, an e-mail has been opened, but then the user is distracted on another matter before responding to or closing the e-mail that initiated the time-tracking event. As such, the current invention allows the user to ultimately review and decide the amounts of time to be invoiced to a client. The current invention also performs back office actions such as invoicing, accounting and other business analytics as described further below.

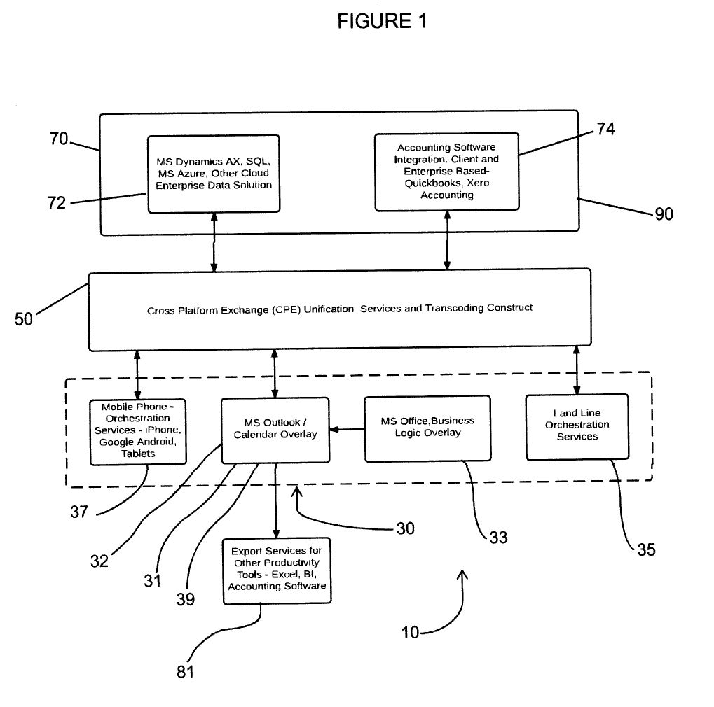

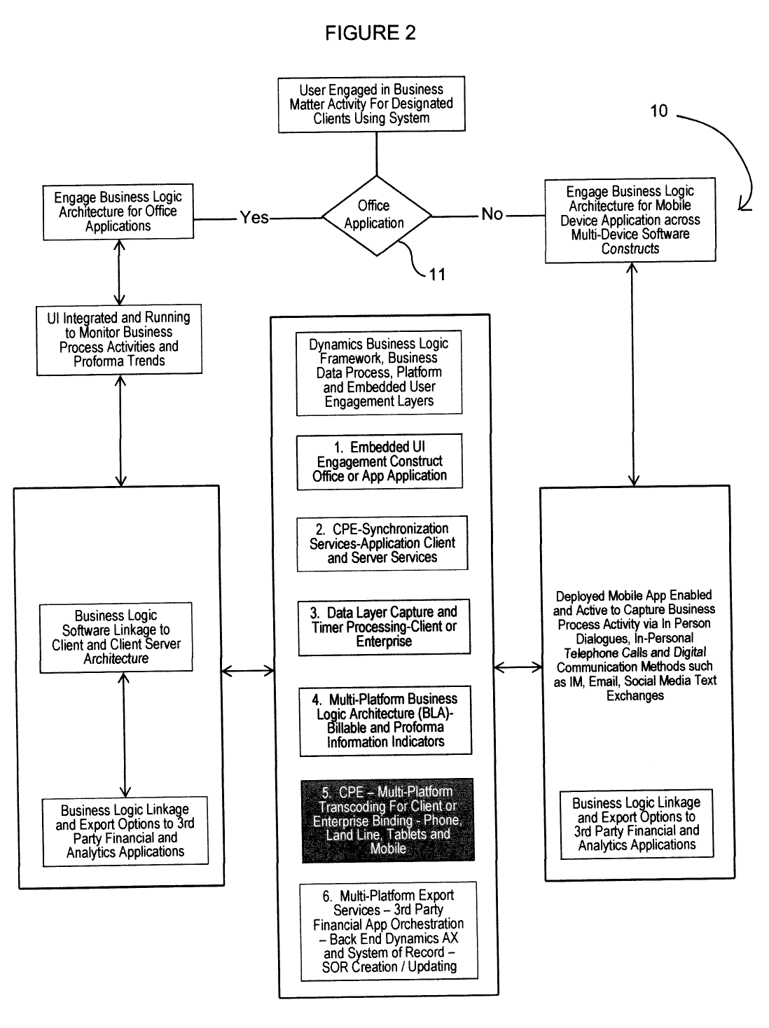

The system and method of the current invention are now generally described with reference to the overall system diagram of FIGS. 1 and 2. Time tracking system 10 may generally include front end 30, cross platform exchange (CPE) 50 and back end 70. Front end 30 may generally include software 32 that may be an add-in component to the user's Microsoft Outlook program, or other e-mail system such as those provided by other companies like Google, Apple, Facebook, LinkedIn or others. While FIG. 2 and other figures reference Microsoft applications, it should again be noted that other systems may be used.

As explained in more detail later, this add-in component preferably appears similar to other features of Microsoft Outlook, or any other e-mail system user interface that is used. In other words, the add-in component of the current invention preferably has the same or similar format to the e-mail system in which it is plugged. This helps reduce or minimize application context switching for business process capture events and specific business activity matters, which in turn may encourage adoption of system 10 and increase the user's efficiency in tracking his or her time.

Software component 32 may generally provide a time tracking function, and as such, serve as a centerpiece for much of the time tracking capabilities provided by system 10, e.g., capturing, categorizing and reporting time, and interfacing with the user for various functions. Software component 32 may also provide various graphical user interfaces (GUIs) or other user interfaces that allow the user to track his or her time on his or her computer and other electronic devices.

In a preferred embodiment, front end 30 allows the user to interface with different programs on his or her computer or other electronic devices that he or she typically uses throughout a work day, e.g., e-mail, word processing applications, a land line telephone and a cell phone or tablet. For example, front end 30 may include e-mail interface 31, Microsoft Office interface 33, land line interface 35 and cell phone interface 37.

E-mail interface 31 may operate with the user's e-mail system, such as Microsoft Outlook, in order to track time spent reviewing, creating and/or responding to e-mails. Microsoft Office interface 33 may operate with the user's word processing system, such as Microsoft Word, or with Microsoft Excel, in order to track time spent creating, revising and/or reviewing these types of documents.

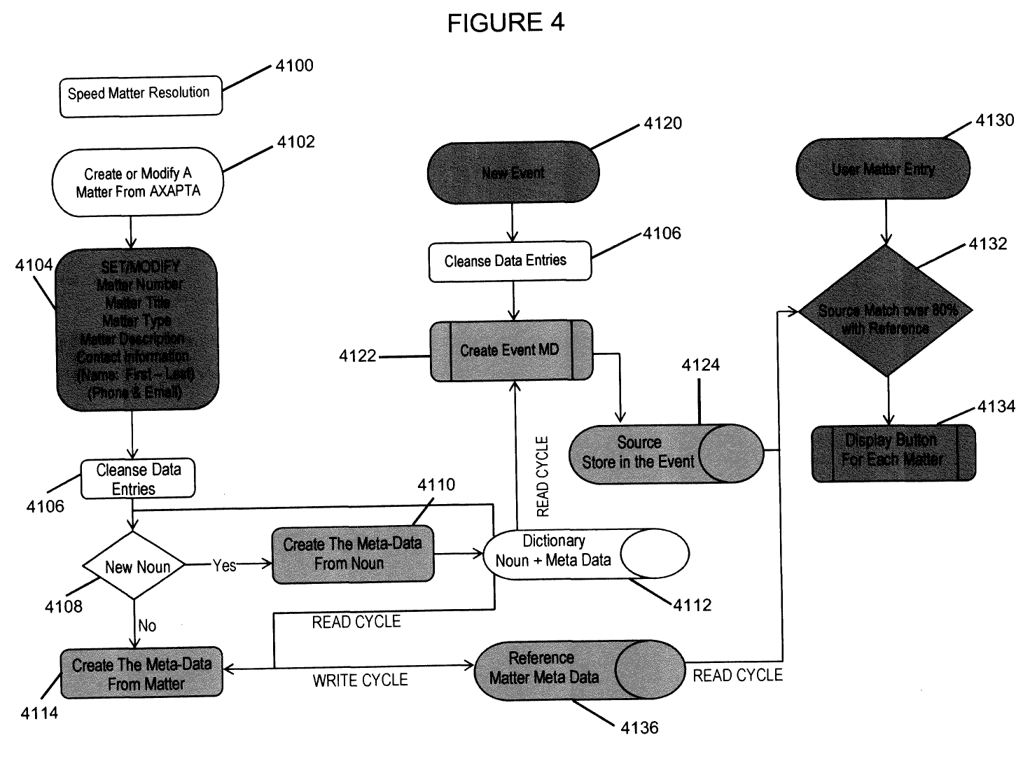

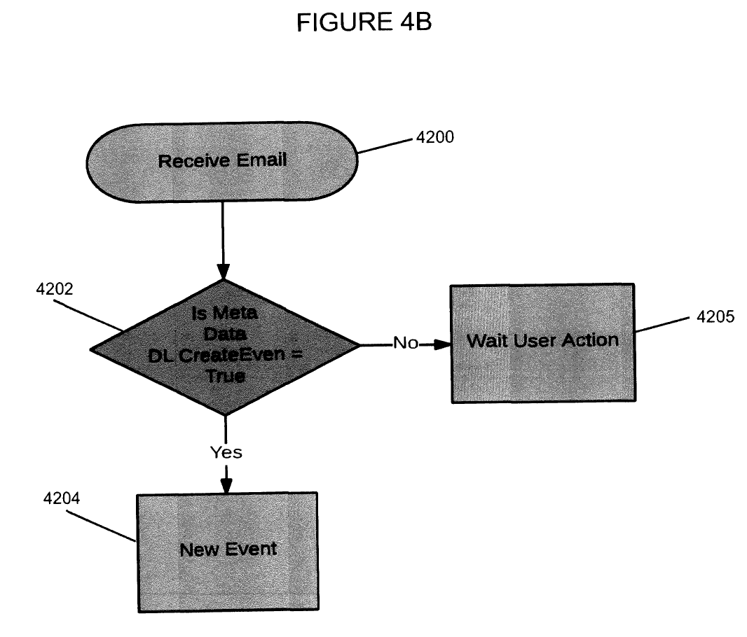

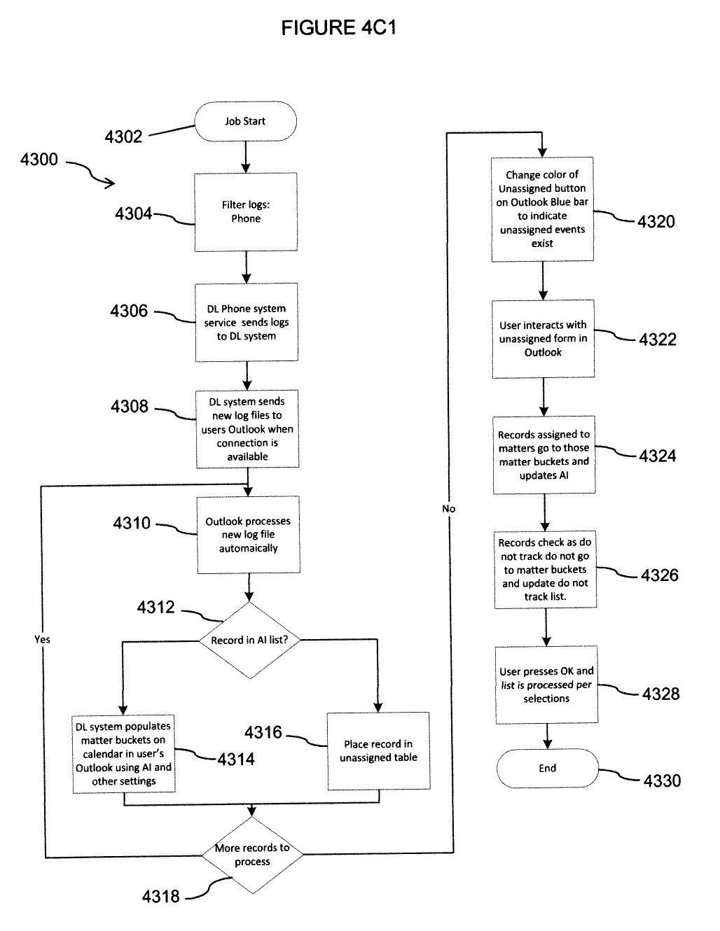

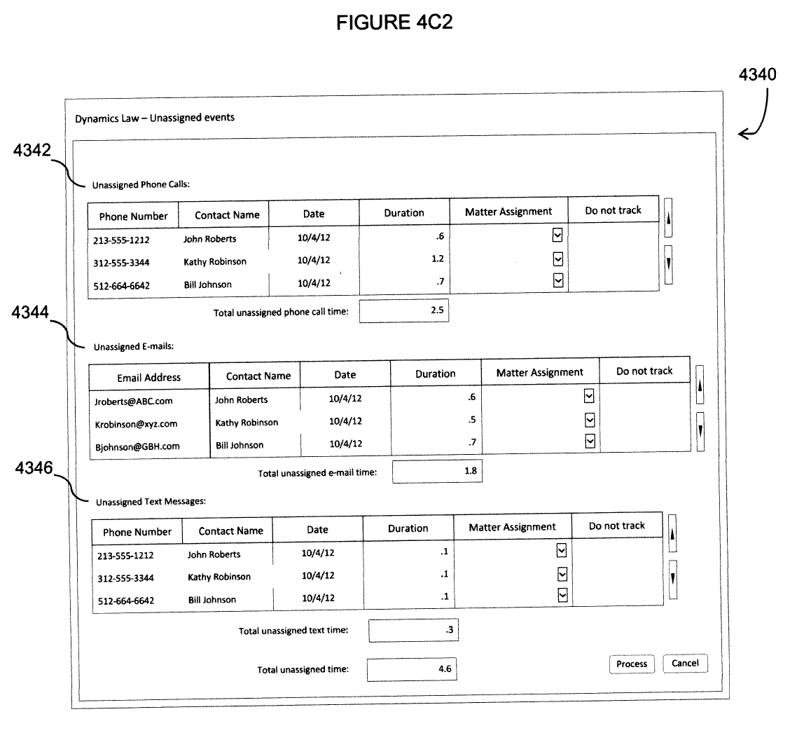

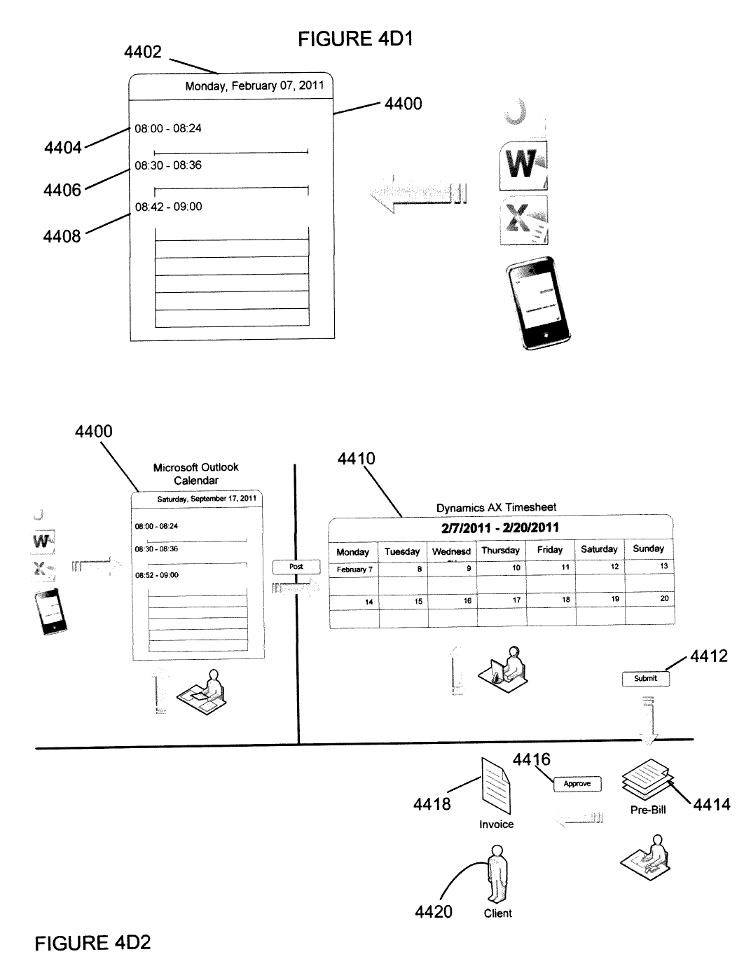

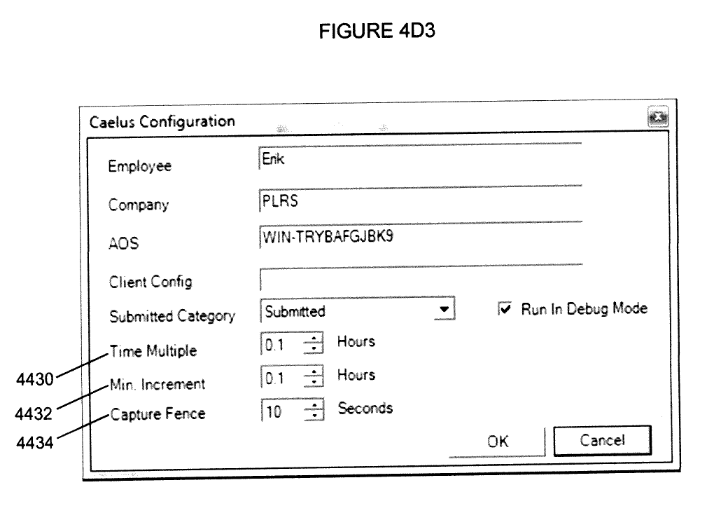

Land line interface 35 may operate with the user's land line telephone to track time spent making and/or receiving phone calls on a land line phone. Land line interface 35 may comprise a separate software component that interfaces with a user's desktop phone system, such as Microsoft Lync, other instant messaging environments in office and social media applications if and when they are used for business process purposes and other suitable software. This software component may record the time of inbound and outbound calls and the calling party, and may also provide an area for notes about the call. This information may be captured and transmitted to software 32 for further processing. As discussed later, land line communication details are preferably coordinated with calendar functions of the Microsoft Product Suite or other business productivity software suites such as those from gmail or linkedin, and through the business logic framework as it pertains to matter assignment. In this manner, the user is required to switch between multiple business applications fewer times, which provides a unique value proposition for this pattern submission. In other words, the user spends less time coordinating land line calls with the rest of the system. The flow of the Land Line Method and approach are discussed later in connection with FIG. 4.C.1 and a screen shot of the land line user interface is shown in FIG. 4.C.2.

Cell phone or mobile phone interface 37 may operate with the user's cell or mobile phone to track time spent making and/or receiving phone calls. To this end, cell phone interface 37 may comprise software to track activities that occur on a cell phone, or a tablet, such as phone calls, e-mails or text messages. The user's cell phone may also be used to track manual events discussed later. As shown in FIG. 1, cell phone interface 37 may communicate directly with CPE 50.

Front end 30 may also include manual interface 39 that allows the user to manually track time for events such as meetings that may not be tied to an electronic device. Manual interface 39 may be included as part of the user's Microsoft Outlook program.

The above-described interfaces may generally appear on the user's computer screen, cell phone, tablet or other electronic device. For example, e-mail interface 31 and manual event interface 39 may appear on the user's computer screen as part of the user's e-mail system. As another example, when a user opens a Word or other document, word processing interface 33 may appear on the user's computer screen along with, e.g., the Microsoft Word document or Excel spreadsheet they are working on. The user interfaces preferably advise the user that time is being tracked. The configurations of these interfaces and the manner in which they operate are described in more detail later.

As also described in more detail later, interfaces 31, 33, 35, 37 may generally track time from when the user opens or starts using one of the foregoing electronic devices, e.g., opening a received e-mail, opening a Word document and/or initiating and receiving a phone call. Time may be tracked until use of the electronic device ends, e.g., the e-mail is closed or sent, the Word document is closed or the user hangs up the phone. Furthermore, if the user has several items open on his or her computer, e.g., e-mail, Word document, etc., system 10 preferably tracks the time of which item is visible to the user. For example, with Microsoft Windows, a user may have several items opened up at the same time, but if some of them have been minimized, system 10 may track that so that it does not record time for that item. Furthermore, if the user has several items open, one behind the other, system 10 is preferably capable of tracking only the time for the item (window) that is visible to the user. These time capture features are discussed later in connection with FIGS. 4D1 and 4D2.

Similarly, manual interface 39 may generally track the start and end times that may manually input into system 10 by the user.

As also described in more detail later, system 10 allows the user to consider whether all the time that an e-mail or document was open, or all the time spent on a phone call, represents time that should ultimately be billed to a client. In other words, while system 10 preferably tracks all the time from start to end, it still allows the user to reduce the tracked time that will be billed as appropriate. System 10 also preferably automatically pauses the timer which tracks time if it appears that the user is no longer working on an opened e-mail, document, etc. This preferably avoids the situation that may occur with other time tracking systems that may end up billing too much time to a client, e.g., when a user leaves an e-mail open but is distracted with another task. In a preferred embodiment, tracked time may fall into different categories, e.g., captured, ready and posted, which may refer time that has simply been tracked, time that may be ready to bill but may still require the user's approval to bill (which may involve the user's consideration whether all the time should be billed) and time that has been billed to system 10.

Referring again to the overall system diagram of FIG. 1, software component 32 is now further described. In a preferred embodiment, system 10 preferably includes an add-in software component 32 to Microsoft Outlook, e.g., versions 2010, 2013 and/or 2016. Because it is an add-in software component, software 32 may generate user interfaces that look and operate in a manner which appear familiar to the user. For example, user interfaces generated by add-in component 32 may readily work with the Microsoft Outlook screen, may complement other Outlook features typically available to the user and need not require the user to learn how to use a completely new type of software. In a preferred embodiment, software component 32 may comprise a time sheet calendar that may be added to the user's Calendar View in Microsoft Outlook. It is also preferred that software component 32 and/or its user interfaces require a reduced number of key strokes to perform tasks, provide visually cleaner menus and screens, allow faster processing of transactions and provide more standard reports.

Accordingly, the manner in which system 10 interfaces with the user is preferably easy to learn and does not represent an obstacle to a law firm or other professional service organization from adopting system 10 of the current invention. Widespread adoption of system 10 may thus readily provide the invoicing, accounting and other business analytics functions as described below. Widespread adoption would also increase the efficiency for the law firm or other professional service organization because its employees may spend less time trying to accurately record their time.

Software component 32 may preferably track time spent on a particular electronic device. Multiple timers may also be run on multiple devices. And to avoid duplicative billing caused by multiple devices being run at the same time, the timers of software component 32 may be synched. In other words, timers may be started, stopped, restarted, stopped, etc., as need be to avoid duplicative billing of time. In a Microsoft Windows environment, the starting and stopping of particular timers may be based on which window is live. For example, where the user has an e-mail and a Word document open at the same time, the timers for each may be started and stopped according to which of those windows is open or visible to the user.

As another example, the timers may be configured to automatically pause, and stop tracking time, if it appears that the user is no longer working on an opened e-mail, document or other item. To this end, system 10 may include an internal timer that is configured to determine whether the user has made any use of, or interacted with, the computer or other device that is tracking time. Where the user is working on a computer, the internal timer may be configured to determine if the user has used the keyboard by typing or scrolling, moved the mouse or made any other use of the computer. Where the user's device includes a touch screen, the timer may be configured to determine if the user has touched the screen. If no such use has occurred within a predetermined amount of time, the timer may automatically pause, and time is no longer tracked until the user again engages the device. The predetermined amount of time may be set to different time intervals, but in one embodiment, the time interval may be set to the smallest increment of time which may be billed by the user, e.g., 0.1 hour or six minutes.

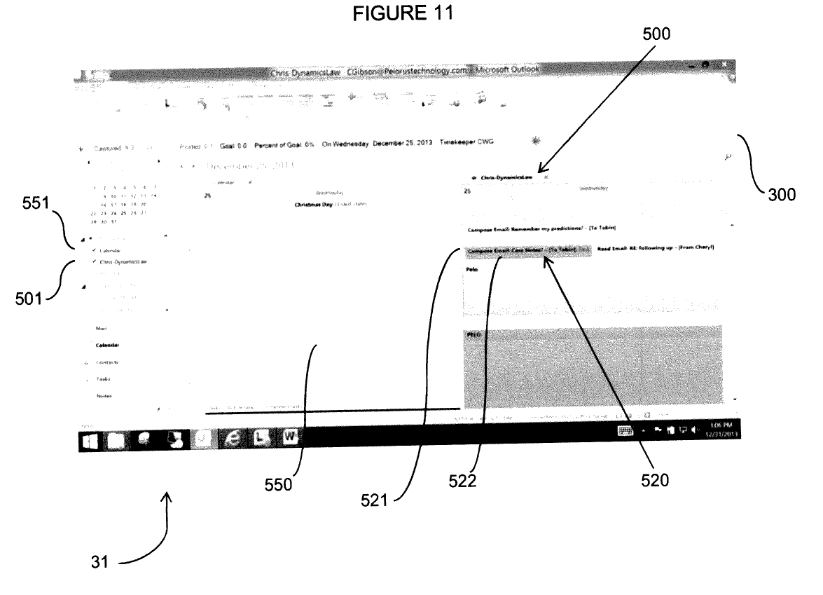

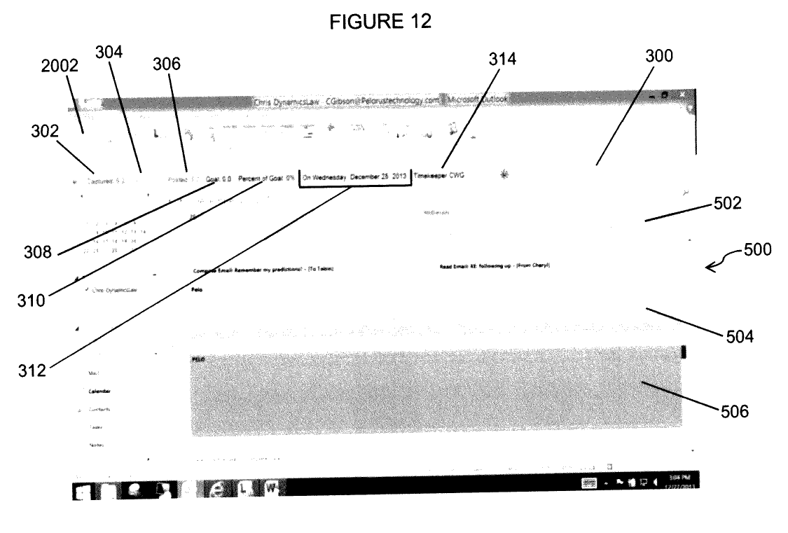

Software component 32 is also configured so that all timers used for each device may operate and look the same way. Furthermore, all timers may feed a central calendar, such as the Microsoft Outlook Calendar in order to keep overall track of time and provide information on the user's tracked time throughout a given day or other desired period. An example is time sheet 500 discussed in connection with FIGS. 11-12 below. In view of the foregoing, software component 32 may facilitate the capability of system 10.

As shown in FIG. 1, software 32 may connect with CPE 50, and in this manner, may serve as the conduit between the various user interfaces 31, 33, 39 and CPE 50 and back end 70, e.g., software 32 may track e-mail work through e-mail interface 31, word processing work through interface 33, and manual events through interface 39, and provide this information to CPE 50 and back end 70. As such, software component 32 may provide time tracking and other functions for the various electronic devices that the user may work with during a given day.

System 10 may also include cross platform exchange (CPE) 50 that may comprise a server, such as a Microsoft IIS server. CPE 50 may serve as an interface between front end 30 (and its various user interfaces 31, 33, 35, 37, 39) and back end 70, which itself may comprise Microsoft AX, SQL, MS Azure or another cloud enterprise data solution, such as Amazon WEB Services or Google Cloud Services. More specifically, as shown in FIG. 1, CPE 50 may interface with software component 32 to allow time tracked through Microsoft Outlook, through Microsoft Office and for manual events to be exchanged with back end 70. CPE 50 may serve as the interface between land line 35 or cell phone 37 and back end 70. The direct connection between phone interfaces 35, 37 and CPE 50 may address the situation when Microsoft Outlook is not available to the user, while CPE service is generally always available.

As noted above, cell phone user interface 37 may directly connect to CPE 50. In this configuration, CPE 50 may allow the exchange of information between software component 32, back end 70 and platforms such as Microsoft Dynamics AX, Apple iOS, Windows Phone and Google Android systems. CPE may accomplish this by including code written by using, e.g., Windows Communication Foundation (WCF), to distribute and collect XML data. In this manner, back end 70 may send data to an AX, iOS, Windows or Android mobile App, and also collect data from them, so that each of these platforms are connected to back end 70.

CPE 50 may also serve as an interface between front end 30 and accounting and/or invoicing system or software 74. For example, CPE 50 may provide information on a user's tracked time so that it may be input into client or enterprise-based Quickbooks, Xero or other accounting software.

System 10 may also include export system 81 that may be connected to front end 30. This allows data file export services for business intelligence filing and visual representation. Export system 10 may also connect to ERP system and provide other exporting services.

The overall operation of system 10 is now further described with reference to FIG. 2, which represents the user interfaces 31, 33, 35, 37, 39 for a Windows Overlay and a Mobile App overlay for Apple and Android Devices. Sample user interface screen shots are described later. The business logic framework shown in FIG. 2 represents the embedded software and cross platform exchange middleware or CPE 50 that supports flow of tracked-time information, and event and matter synchronization. While focus on embodiments in and around edge to enterprise solutions, CPE 50 may be co-resident at some feature level on the actual client platform.

Generally, the framework of system 10 may function with a number of different solution constructs and embodiments. While the following description focuses on the Windows Client Server Model with Land Line and Mobile interfacing, this solution construct could be co-resident on a high performance client on tablet with back end cloud services. Typically, high performance clients or tablets have data storage or small database service resident within the software stack. The flexibility of the architecture would allow this for small and medium size legal and other professional service firms versus large scale legal and other professional service firms that use database software, and in particular MS Dynamics AX software at scale.

Generally, the user engagement activity/events of system 10 may include two high level platform activities that may be centered in and around business process applications, such as e-mail, instant messaging, electronic document reading and telephone conversations. Orchestration of those user events with third party financial and analytics application may also occur, where such third party applications may be supported by the business process, multi-platform architectural method and configuration of system 10. This orchestration and automation of information exchange, and electronic information opening and closing, allow business process events to occur in a more seamless and transparent fashion, and reduces the amount of software application context switching in and around legal and professional services Proforma metrics.

As shown in FIG. 2, this architectural method may comprise six areas that are described later in more detail, but may be summarized as follows:

1. Embedded UI Engagement—Software for Office/Outlook and Mobile App business matter capture and itemization. Direct linkage to CPE Middleware Services.

2. Cross Platform Exchange—Synchronization Service—Application and Client Services that bind business matters to data layer monitoring for client and enterprise activities. The CPE Synchronization Service is a unique part of these Client and Server Services, and is generally referenced herein as cross platform exchange 50 as it pertains to the business software logic architecture.

3. Data Layer Capture and Timer Processing—Software that creates timing initialization, capture and documentation in and around embedded user interfaces. This includes the data capture and digital process that is associated with the actual time and activities in and around the business matter context that is deemed serviceable and billable, and also helps with Proforma indicators.

4. Multi-Platform Business Logic Architecture—BLA. Software that binds billing and Proforma information to timer activities and user input details, and drives the Proforma Real Time Indicator or Blue Ribbon Visualization.

5. Cross Platform Exchange—Multi-Platform Transcoding—CPE Software that supports data flow and platform information synchronization. Transcoding and formatting data information post-capture and in and around Mobile Phones, Land Lines, Desktop Applications and Mobile Speed/Preset Matter Tables. Multi-Platform Business Logic Architecture—Software service that arbitrates and orchestrates user engagement services and actions that allow these business matters to be invoked by end users on behalf of client service and representative activities in the digital domain. and be monitored by on screen indicators for Proforma trends around billable services

6. Multi-Platform Export and Representation Services—The ability of system 10 to highlight these events as professional matters, to track key elements of the events and to export, present and integrate with third party financial applications in both a general and industry-specific compliant method. This is important for the global legal industry and other professional service industries which require considerable detail regarding the manners in which legal or other professional services are billed and representation is documented. This is also important to report on the areas of profit and loss by professional service firms and their practice groups, individual to service value rates and the consumption against these rates by current and new clients.

Referring to FIG. 2, system 10 may first determine whether the user is engaged in an Office application, e.g., e-mail, Word document, etc., as shown in step 11. If so, system 10 may engage the business logic architecture for Office applications. The user interfaces may then be used to monitor business process activities and Proforma trends, and be linked to client and client server architecture and export options. If the user is not engaged in an Office application in step 11, system 10 may engage a mobile device app which may be linked to an enabled mobile device to capture time spent using that device and to also provide linkage to export options. In either of the Office or mobile device scenarios, the above-referenced six areas of the architectural method may then occur.

Back end 70 of system 10 is now further described. As noted above, back end 70 may comprise Microsoft AX though other suitable software such as Quickbooks and Xero may be used. Back end 70 that may interface with CPE 50 to accept tracked time information from front end 30 to provide invoicing, accounting and other business analytic functions. The functions that may be provided by back end 70 include legal (and other professional service provider) billing processes, pay when get paid, retainer management, IOLTA and trust management, electronic invoicing, accounts receivable, discount and write-off management, timekeeper performance management (such as within a human resources module), matter management and accounting, conflict management, multiple matter types, including hourly, fixed fee, contingent, pro bono and collaborative, fee arrangement management, financial and matter budgeting, full general ledger, accounts payable, accounts receivable, bank management, fixed assets and financial reporting, financial statements, cash based and accrual based accounting, partner and former partner payment plans, wizard based user interface for data entry on transactions such as new client and new matter entry. Beyond the foregoing, back end 70 also preferably provides the ability to tune existing reports and create new reports.

Back end 70 may also include additional business intelligence functions 72 that may provide various business analytics. To this end, business intelligence 70 may capture information generated from system 10 for the purpose of producing standard reporting and metrics as well as delivering the data captured by system 10 to enable users to perform desired data analysis

As noted earlier, back end 70 may comprise one or more databases 72 and software 74 to perform various business, financial and other functions. Microsoft AX may serve as the platform 76 for back end 70, though other platforms such as Quickbooks and Xero may be used. To this end, a back end platform that may be designed to operate with companion software on front end 30 may be preferred.

Databases 72 may include various types of information to work with front end 30 through CPE 50, as well as to perform business analytics. For example, databases 72 may include matter and client information, as well as information associated with particular matters or clients. Back end 70 may also store names of individuals or other key terms that are associated with that matter. Similarly, back end 70 may also store names of individuals or other key terms that are associated with a client. For example, if a client is a company, back end 70 may also store the officers' names of that client.

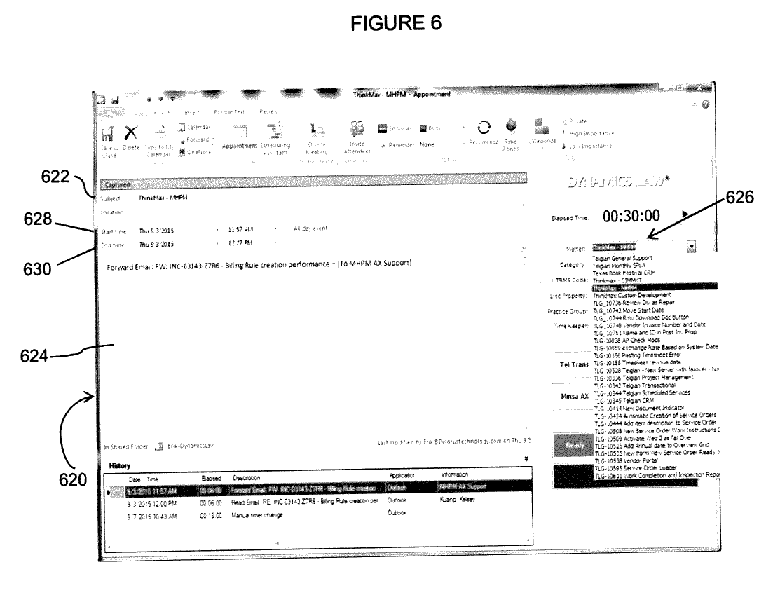

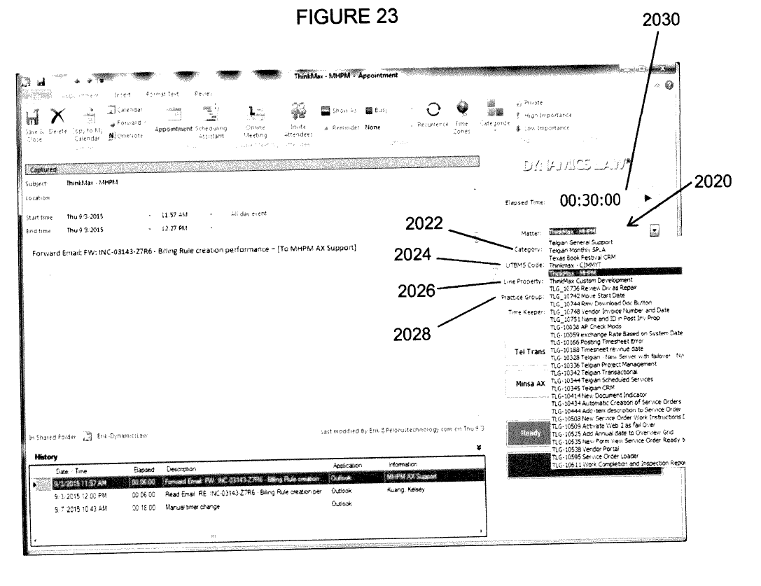

Matter information, client information and information associated therewith may be established by a user when tracking time for a new matter and/or new client for the first time. As discussed in connection with FIGS. 6 and 23 later, when a user is finished with a particular item of work and wants to capture that time for processing by system 10, he or she may be presented with a drop down box for other electronic form at the end of the event, e.g., drop down box 626 in FIG. 6 or drop down boxes 2020, 2022, 2024, 2026, 2028 in FIG. 23. These drop down boxes may include various fields to identify the client, the matter and other information that may be useful for tracking and reporting on time.

When time is captured for a new matter or client for the first time, the fields in the drop down boxes may be empty and the user may be prompted to provide the matter name, a client name and other information. Once this occurs, all this information is preferably stored by software 32. In addition, system 10 also preferably stores names, such as names of individuals who have sent e-mails to the user. The system may also store other key words that may be synonymous with a given matter or client.

It is preferred that the relationships between, e.g., names and matters, are stored by software 32 locally to the user's computer because, for example, the user's definition of such relationships may be subjective and not apply to other users of system 10. Furthermore, a particular user may not want to share relationship information with all members of the firm using system 10. This local storage may involve an SQL database residing on the user's computer. Back end 70 may store foundational information, e.g., client name, that may be accessed by and pushed into front end 30 and software 32 for the user to create relationships for future reference.

In any event, once the appropriate relationship information is stored by software 32, when the user subsequently works on the same matter or client and seeks to capture time spent working for that matter or client, the appropriate matter, client and associated information may prepopulate the fields in the drop down boxes used to capture time. Over time, software 32 preferably associates particular names and/or key words with particular matters and clients so that its library of data grows. Accordingly, after the time of the first event spent working on a particular matter or client has been captured, capturing subsequent events requires fewer key strokes to fill out any drop down box by the user. This makes system 10 more readily adopted.

For example, when a user reviews an e-mail from a particular person, and then seeks to capture the time spent reading that e-mail, system 10 preferably recognizes the e-mail sender's name and prepopulates the fields of the drop down box. More specifically, the e-mail sender's name is conveyed from front end 30, at which time software 32 may recognize the person's name as associated with a particular matter or client and populates the matter drop-down box as. Alternatively, if the person's name alone is not sufficient to identify a single matter, software 32 preferably provides two or more closest possible matches for the user to choose from. And if the user wants to create a new matter, he or she may do so by providing new information to software 32.

It is preferred that the foregoing occur after a conflict check or other internal approval process by the organization for which the user works. This is preferred to avoid capturing time that could potentially create a conflict. It should also be noted that information such as names and other key words may be entered into software 32 and/or back end 70 during the conflict check or other internal approval process so that the artificial intelligence represented by database libraries in back end 70 may be initiated at that time.

As indicated in FIG. 1, CPE 50 and back end 70 may reside at a location or locations that are remote from the user. For example, CPE 50 and/or back end 70 may reside in a firm's IT department. Alternatively, CPE 50 and back end 70 need not be located together and may generally be accessible over the cloud and internet constructs and instances. As shown in FIG. 1, back end 70 may be located at remote location 90 that may be separate from CPE 50.

The foregoing discussion and the more detailed discussion below primarily relates to core platforms and data channels from Microsoft, e.g., Microsoft AX, Microsoft Outlook, Microsoft Office and Microsoft Windows. However, it should be noted that system 10 of the current invention may be implemented through other platforms and data channels. Accordingly, the current invention is not limited to use with only Microsoft platforms. For example, various mobile platforms besides Microsoft Windows may be used such as Apple and Android. Similarly, various landline platforms besides Microsoft LYNC, may also be used such as Asterix, Avaya and Cisco.

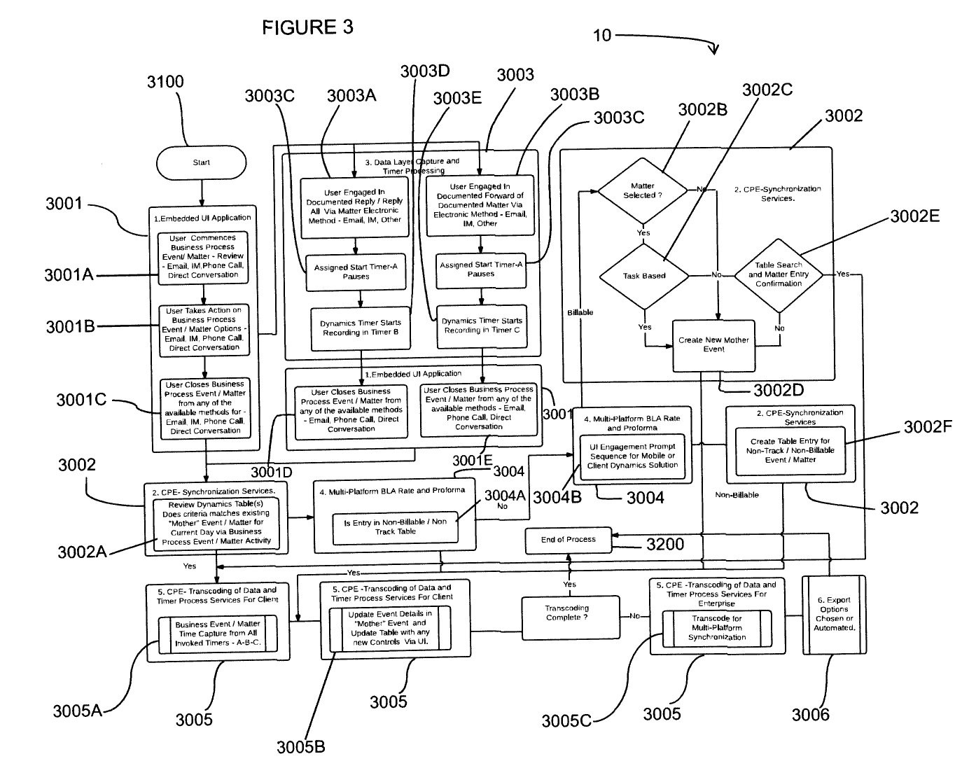

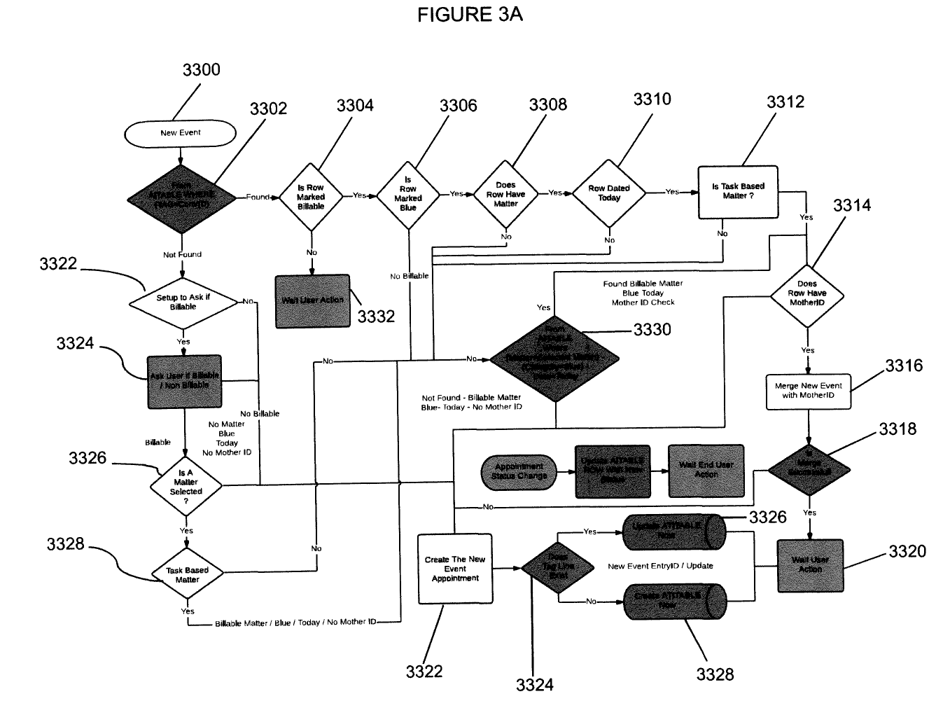

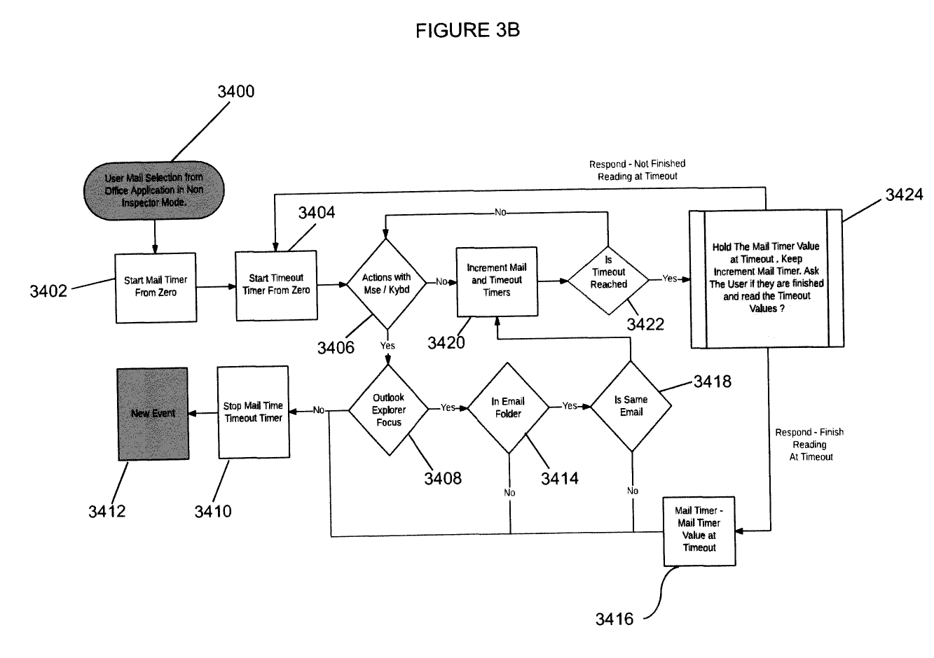

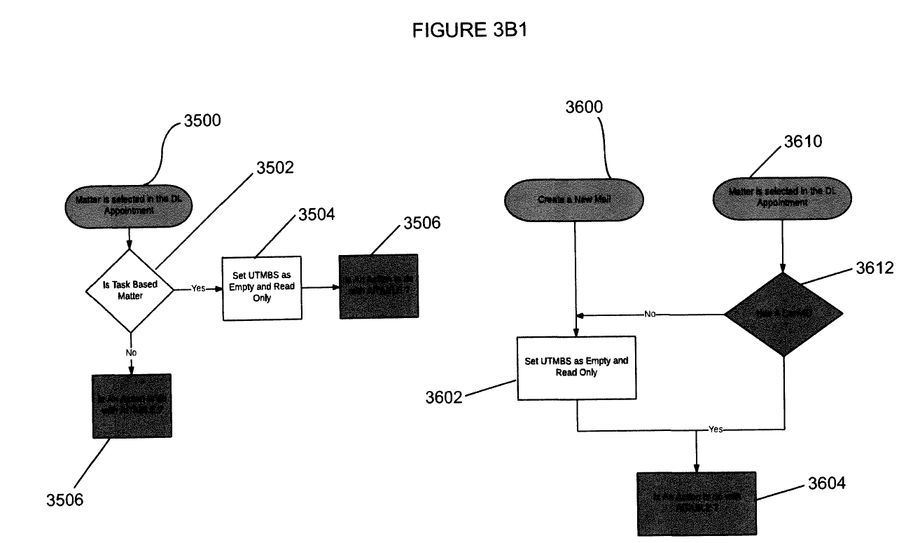

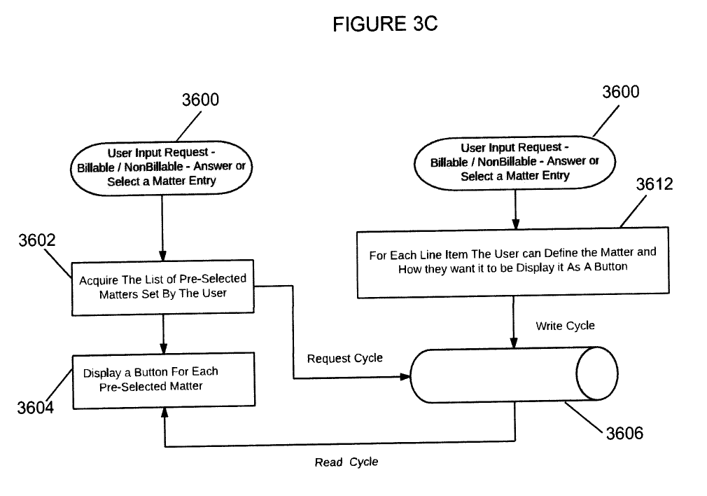

The manner in which system 10 and its software functions in connection with user interfaces 31, 33, 35, 37, 39 regarding orchestrating data documentation, timing and export in and around business matter creation, storage and export, is now further described with reference to FIG. 3. It should again be noted that with respect to cross platform exchange 50, data transcoding and synchronization via multi-platform software to enterprise solutions and enterprise back end software, such as but not limited to MS Dynamics AX, MS SQL Server, are unique to system 10. FIG. 3 also describes the flow of billable time and the process to goal indicator activities along with matter indexing and client responses via digital methods and approaches, and FIG. 3 also relates to the six areas described in FIG. 2 regarding the business logic framework. To this end, these six areas are numerically identified in FIGS. 2 and 3 as item nos. 3001, 3002, 3003, 3004, 3005, 3006.

As shown in FIG. 3, the user may start 3100 to engage system 10 by engaging one of the user interface applications 3001. At this point, the user may commence a business process 3001A such as work on an e-mail, phone call or other type of matter, and then take action 3001B.

Upon taking action 3001B, data layer capture and timer processing 3003 may serve to capture the time spent taking action. For example, the user may take action by replying 3003A to an e-mail or other task or forwarding 3003B. In either scenario, the assigned start timer A may pause 3003C. In the case of a reply, timer B may start recording time 3003D, or in the case of a forwarding action, timer B may start recording time with timer C 3003E.

When the user is finished with acting on the business process by simply closing the e-mail or other item as in step 3001C, or by finishing the reply or the forwarding action as in steps 3001D or 3001E, the tracked-time information that is thus collected may be stored by software 32, and as shown in step 3002, may synchronize this tracked time information with information already stored by system 10. For example, CPE 50 may determine whether the tracked-time information matches any existing matter, client or other related and previously-stored information with which the tracked-time information may be associated as in step 3002A.

If an association exists, the tracked-time information may be transcoded as in step 3005A to capture time from preferably all invoked timers A, B and/or C. At this point, additional transcoding may occur to update event details in the “mother” event and to update tables containing previously-stored information via the pertinent user interface as in step 3005B.

At this point, if the transcoding is complete, the process of user engaging with a business process may be complete 3200. If not, CPE 50 may perform additional transcoding for multi-platform synchronization as in step 3005C. An export option as described above may also be chosen at this point as in step 3006, and the process may then be complete 3006.

Referring back to step 3002A, if no association exists, the tracked-time information may be processed by multi-platform business logic architecture and Proforma software 3004. For example, system 10 may query the user through the pertinent user interface whether the time entry is non-billable or for a non-track table as in step 3004A. If it is, then the tracked time information may proceed to the transcoding step 3005B to update the matter bucket and tables and the process may continue as described above.

If the time entry does not meet this criteria, the entry may be further processed by software 3004 by prompting the user whether the time is billable or not as in step 3004B. If it is billable, the entry may be processed by CPE 50 for additional synchronization services. For example, system 10 may query or determine whether a matter with which the entry is to be associated has been selected as in step 3002B. If it is, system 10 may query or determine whether the entry is task based as in step 3002C. If it is, software 32 may create a new matter bucket as in step 3002D. At this point, the entry and related information may be sent updates by CPE 50 as in step 3005B and the process may continue as described above.

Referring back to step 3002B, if a matter has not been selected, then the entry may proceed to step 3002D to create a new matter bucket and the process may continue as described above.

Referring back to step 3002C, if the entry is not task based, the entry may proceed to step 3002E where tables may be searched for matter entry confirmation. If confirmation occurs, the entry may proceed to step 3005B and the process may continue as described above. If confirmation does not occur, the entry may proceed to step 3002D and the process may continue as described above.

Referring back to step 3004B, if the entry is non-billable, a table entry for the non-track/non-billable, event or matter may be created as in step 3002F, and the process may continue as described above.

The manner in which the business logic architecture, or business logic framework operates is now further described with reference to FIG. 3A. FIG. 3A is the first combination of code loops we can discuss under the Business Logic Framework. Architecture or framework 3004 may comprise a number of user engagement activities in and around events and matters that may be elected as billable or non-billable status, date of actual activity, identification of actual activity and consequently assigned “Blue” status or Mother ID attribution or Mother ID Creation within the AI Table. The AI table may generally be described as memory of how a user has selected an e-mail thread or document associated with a specific project or matter. This preferably helps with historical context switching and return scenarios. The AI table aspect of the current invention is described in more detail later.

As shown, the architecture may start with new event 3300 where the AI table is queried as in step 3302. The AI table may be part of embedded user engagement software 3001 and/or CPE synchronization services 3002.

If a matter is found in the AI table, query 3304 may occur regarding whether the row is marked billable, and if it is, query 3306 may occur regarding whether the row is marked blue, or defined, and if it is, query 3308 may occur regarding whether the row has a matter, and if it does, query 3310 may occur regarding whether the row is dated today, and if it is, query 3312 may occur regarding whether the event is a task-based matter, and if it is, query 3314 may occur regarding whether the row has a Mother ID, and if it does, the new event may be merged with the Mother ID as in step 3316. If the row has no Mother ID, the entry may proceed to step 3322 described below.

At this point, query 3318 may occur regarding whether the merge was successful. If it was successful, system 10, and more particularly, user interface 3001, may wait for user actions as in step 3320.

If the merge was not successful, a new event appointment may be created as in step 3322. At this query, 3324 may occur regarding whether a tag line exists. If it does, the AI table may be updated as in step 3326, and if it does not, a tag line may be created in the AI table as in step 3328. After either of steps 3326, 3328, user interface 3001 may await user action as in step 3320.

Referring back to step 3302, it no entry is found in the AI table, query 3322 may occur regarding if the entry is set up to be billable. If it is, the user may then be asked if it is to be billable as in step 3324, and if it is, query 3326 regarding whether a matter is selected may occur, and if it has, query 3328 may occur regarding whether the entry is a task based matter. If (i) it is a task based matter that is defined and marked as today, but has no mother ID or (ii) it is not a task based matter, the AI table may be looked up as in step 3330 and queried whether (i) found billable matter, which defined, marked as today and associated with a Mother ID, in which case the entry proceeds to step 3314 and continues as described above, or (ii) not found billable matter, which is defined, marked as today and not associated with a Mother ID, in which case the entry proceeds to step 3322 and continues as described above.

Referring to query 3304, if the row is not marked billable, the entry may wait user action as in step 3332. Referring to queries 3306, 3308, 3310, 3312, if any of their responses is “no,” the entry may proceed to step 3320, and then proceed as described above. If the response to any of queries 3322, 3326, 3328 is no, or if the response to query 3324 is non-billable, the entry may proceed to step 3322 and continue as described above.

The queries and steps of FIG. 3A may relate to the above-referenced six areas as follows: queries/steps 3302, 3318, 3324, 3326, 3328, 3330 may pertain to CPE 50 multi-platform transcoding 3005; queries/steps 3304, 3306, 3308, 3310, 3312, 3314, 3322, 3326, 3328 may pertain to CPE 50 synchronization services 3002; and queries/steps 3320, 3324, 3332 pertain to user interfaces 3001. Beyond this, however, it should be noted how the areas 3001, 3002, 3003, 3004, 3005, 3006 work together to provide the benefits of system 10.

System 10 and its software code that starts and stops the timer processing service that are part of the Data Layer Capture and Timer Processing 3003 are now described. Layer 3003 is generally associated with actions in and on electronic information, and the duration of actions, as they pertain to client services and informational reviews. Layer 3003 may also monitor keyboard and mouse activities to ensure the actual user is present in and around the information platform that is displaying the client details or working content to ensure time is captured professionally.

Data Layer Capture and Timer Processing 3003 may be documented in the appropriate increments and may then engage the CPE-Synchronization Services 3002 to ensure timing details are tied to the appropriate “Matter Buckets”, a specific “Matter” and the appropriate billable rate multiplier or progress to goal indicator.

As shown in FIG. 3B, the user may select an e-mail application in non-inspector mode as in step 3400. At this point, the mail timer may start from zero as in step 3402, and the timeout timer may start from zero as in step 3404.

Software 3003 may then query whether the user has taken action with the keyboard or mouse as in step 3406. If yes, software 3003 may query whether Microsoft Outlook Focus or other similar e-mail application is in use as in step 3408. If it is not, software 3003 may stop the mail timer and timeout timer as in step 3410, and the e-mail user interface may await a new event as in step 3412.

Referring back to step 3408, if Microsoft Outlook Focus or other similar e-mail application is in use, software 3003 may query whether the e-mail is in an e-mail folder as in step 3414. If not, the mail timer value is set at timeout as in step 3416. But if it is in an e-mail folder, software 3003 queries whether it is the same e-mail as in step 3418. If it is not, step 3416 may occur. If it is the same e-mail, or if there was no keyboard or mouse action as in step 3406, step 3420 may occur where the mail and timeout timers are incremented. Query 3422 may then occur regarding whether timeout is reached. If it has not been reached, software 3003 reverts to query 3406 to again determine whether there has been any user action with the mouse or keyboard. If the timeout has been reached, step 3424 may occur where the mail timer value may be kept at the timeout timer value, the increment of the mail timer may be kept and the user may be asked, e.g., through e-mail interface 31, whether he or she is finished and then read the timeout values. If the user responds that he or she is finished reading at timeout, step 3416 may occur. And if the user responds that he or she is not finished reading at timeout, software 3003 may revert to step 3404.

Other concurrent software actions in and around user interface actions are now described with reference to the left flowchart in FIG. 3B1. These actions may pertain to capturing an appointment action that may already exist but needs a record update in and around a given AI Table, or if the matter is task based, then to establish a new UTMBS and to jump to the AI Table Decision Tree.

As shown, a user may select a matter associated with an appointment via user interface 3001. Query 3502 may then occur by software 32 regarding whether the matter is task based. If it is, step 3504 may occur where software 3003 sets UTMBS as empty and read only. Step 3506 may then occur where software 32 performs transcoding queries if there is an action to do with the AI table. Referring back to step 3502, if the matter is not task based, step 3506 may again occur.

The right flowchart of FIG. 3B1 regards the creation of the ConvlD. This may occur as part of the appointment process or as part of digital information creation such as e-mail. As shown, a user may create a new e-mail as in step 3600 using e-mail interface 31. CPE synchronization service 3002 may then set UTMBS as empty and read only as in step 3602. CPE 50 may then perform a transcode function to an action to do with the AI table as in step 3604. Also, a matter may be selected that is associated with an appointment as in step 3610. Software 32 may then query if the matter has a ConvID. The matter may then proceed as described above.

Additional actions regarding the multi-platform business logic architecture 3004 are now described with reference to FIG. 3C. More specifically, these actions pertain to the preparation of user buttons and/or prompts that request information from the user regarding billable/non-billable matter conditions. Business logic architecture software 3004 may generally prepare the environment to capture and create event space and progress to goal displays as discussed later in connection with the appearance of user interfaces. Software 3004 may also interface with the mobile app, as well as with the land line and desktop platform applications described later. Software 3004 may also be in communication with CPE synchronization services software 3002 for user inputs regarding matter buckets and matters, directly or indirectly with CPE transcoding and timer services software 3005.

As shown, add-in software 32/3002 may request a user input regarding whether an entry is billable or non-billable, or to answer or select a matter entry, as in step 3600. Business logic architecture software 3004 may then acquire the list of pre-selected matters set by the user as in step 3602. Software 32/3004 may then request a cycle from data layer capture and timer processing software 3003 as in step 3606. After the read cycle, software 3004 may display a button to the user for each pre-selected matter as in step 3604. Alternatively, the buttons of step 3604 may be displayed after step 3602.

As also shown, add-in software 32/3002 may request a user input as in step 3600 and business architecture software 3004 may allow the user, for each line item, to define the matter and how the user wants it to be displayed as a button, as in step 3612. Data layer capture and timer processing software 3003 may then perform a write cycle as directed by the user, and then the buttons may be displayed as in step 3604.

Another feature of the current invention regarding the pre-set indexing and summary listing of information, which is referred to herein as “speed matters” is now described in connection with FIG. 4. Business logic architecture 3004 and user interfaces 3001 may preferably provide pre-existing matters and event details in a summary listing. This summary presentation of matter information is beneficial to users because it helps with context efficiency data entry criteria and synchronized information. For example, the summary lists provided by system 10 may include matter identification and description, contact information and historical billable services against a particular matter or activity.

To provide the summary listing described above, it is preferred that matter and other information has already been stored in add-in software 32 storage, that pre-selected matters are provided with a button or unique identifier, that the user has options to define the matter and how it is to be visually displayed in the user interfaces 3001, that matters may be updated or edited via Dynamics AX or other suitable back end 70 software, that matters are concise and are not updated by other sources, that matters on the summary list may be chosen by the user for updates and that inputting new events may prompt additional information to be added to the speed mater listing.

As shown in FIG. 4, speed matters listing 4100 may address creating or updating matters 4102 as follows. Front-end or add-in software 32/3002 may allow the user to create or modify a matter stored in back end 90. User interfaces 3001 may then be used to set or modify various items such as matter number, matter title, matter type, matter description, contact information and other information related to time entries to be tracked by system 10, as in step 4104. Business logic architecture 3004 may then cleanse data entries 4106, e.g., by ensuring that they are formatted properly to be handled by system 10.

Front-end or add-in software 32/3004 may query whether there are new nouns as in step 4108. If there are, CPE multi-platform transcoding software 3005 may create meta data from the new nouns as in step 4110 and provide this data to front-end software 32. To this end, CPE 50 is preferably always active and available for the edge to enterprise solution to operate and function regardless of its location. At this point, data layer capture and timer processing software 3003 may associate the noun with its meta data in a dictionary as in step 4112. The process may then return to determine whether there are additional nouns, and if so, the loop of steps 4110, 4112 is repeated. If there are no new nouns, or after new nouns are input into the dictionary, CPE transcoding software may then create meta data from the matter as in step 4114.

Regarding a new event 4120 as shown by user interfaces 3001, and as also shown in FIG. 4, a data cleansing step 4106 may again be performed. At this point, front-end or add-in software 32/3005 may create an event ID as in step 4122, through a read cycle of dictionary 4112 being performed. This may then be stored as in step 4124. Reference matter meta data may also be provided by CPE 50 as shown by step 4136 and stored in software 32/3005. Write cycles and read cycles may be performed with the meta data.

User matter entry 4130 is now described. A source match for over 80% with reference may be displayed by user interfaces 3001. This match function may be accomplished using the information stored in databases 4124, 4136. When there is an appropriate match, user interfaces 3001 may display a button for each matter as in step 4134.

Reference is now made to FIG. 4B which relates to monitoring both user interaction and e-mails received to initiate the creation of meta data to commence the operation of business logic software 4004. As shown, a user may receive an e-mail 4200 as shown by user interface 3001. At this point, front-end or add-in software 32 may query whether there is meta data created for an event as in step 4202. If there is, new event 4204 may be displayed to the user. If there is not, the user interface may await action by the user as in step 4206.

The manner in which system 10 may interface with land line phones is now described with reference to FIG. 4C1 which shows a land line call flow sequence 4300, and FIG. 4C2 which shows a user interface for land line call details and matter assignment and pinning.

Referring to FIG. 4C1, land line call flow sequence 4300 may start at step 4302. Filter logs incorporated or otherwise associated with the land line phone may then be activated as in step 4304, and thereafter, the land line phone system sends the logs to system 10 as in step 4306. System 10 may then send new log files to the user's Microsoft Outlook application when the connection is available as in step 4308. Outlook may then process the new log file automatically as in step 4310.

At this point, system 10 queries whether to record log in AI list as shown in step 4312. (The AI list may comprise one or more databases in back CPE 50, back end 70 and/or other location that stores information related to the various matters for which time entries are tracked by system 10.) Where it is to be recorded, system 10 may populate matter buckets on the calendar in the user's Microsoft Outlook using AI and other settings as in step 4314. If the land line phone call is not ready to record, a record of the call may be placed in a table of unassigned calls as shown in step 4316. Thereafter, if there are more records to process as in step 4318, the system reverts back to step 4310 an processes any new log file automatically. This may occur until there are no more records to process.

At this point, as shown in step 4320, the color of the user's unassigned button on the Outlook blue bar may be changed to indicate an unassigned event exists. (As discussed later, the blue bar is a visual feature appearing on the user's Outlook interface that provides various information on the time being tracked by system 10 and its status.) Thereafter, the user may interact with the unassigned form as shown in FIG. 4C2 and discussed below, as shown in step 4322. To this end, the user may assign matters to the appropriate buckets in order to update the AI table as in step 4324.

Records may be checked as in step 4326 to determine if they do not track existing information to avoid assigning matters in the incorrect buckets. When the matter has been appropriately assigned, the user may press OK or other appropriate button on his or her interface and the list is processed per the user's selections as in step 4328. The process of the land line call may then end at step 4330.

Referring now to FIG. 4C2, the unassigned call user interface form 4340 is now described. As shown, form 4340 may provide information about land line phone calls 4342, unassigned e-mails 4344 and unassigned text message 4346. Contact information may be listed for each of the items in form 4340, as well as date and duration information. Form 4340 may also set forth other information. Unassigned matters may be assigned as discussed in connection with FIG. 4C1, and when this occurs, the “matter assignment” section of form 4340 may show a check or other indicia indicating that the matter has now been assigned.

The manner in which system 10 may interface with and track time associated with various electronic applications such as Microsoft Outlook, as well as Microsoft Office application such as Word and Excel, as well as cell phones, is now described with reference to FIGS. 4D1, 4D2 and 4D3. To this end, the following discussion includes automated and manual timing capture for these activities. As noted earlier, it is preferred that system 10 make it easier for the user to capture time, to capture more time and to post that time directly to the accounting and/or invoicing system used by the firm or organization that the user works. This preferably results in a more streamlined overall process for the organization to capture and invoice time, thereby increasing the organization's efficiency and revenues.

As discussed in more detail later in connection with the appearance and user of the user interfaces 3001, system 10 preferably uses the calendaring system provided by Microsoft Outlook (or the calendaring system provided by another suitable electronic application) as the reception point for daily time tracking. As will be appreciated by many users, this type of calendaring system 4400, shown in FIG. 4D1, is similar to the grid-lined paper that has been previously used by many attorneys and other professional service providers. That is, the date 4402 and various time entries 4404, 4406, 4408 may be displayed to receive tracked-time events from Outlook, Word, Excel and a cell phone. Each event may contain the duration of the event as tracked by timers, as well as other information such as event notes, e.g., time entry description, etc. For example, the following events may be tracked.

Manual—record the elapsed time of any event that may not be directly monitored by a system timer. This would include: meetings, phone calls, offsite events, etc.

Outlook E-mail Timer—Records the time authoring, reading and replying to e-mail and creating corresponding events on the Outlook calendar.

Word and Excel Timer—Records the time authoring and editing Microsoft Word and Microsoft Excel documents and creating corresponding events on the Outlook calendar.

With reference to FIG. 4D2, the manner in which event timers may be selected and may operate is described.

Time capture may start in MS-Outlook where the timekeeper (user) may use automatic or manual methods to record time. The time events are preferably only visible to the timekeeper or anyone who is authorized to view the timekeeper's MS-Outlook calendar 4400. Events may be added, changed and/or deleted on the calendar 4400.

Posting events to the MS-Outlook calendar 4400 may end the time and events to the timekeeper's timesheet 4410. The timekeeper or the timekeeper's assistant (if authorized) may add, change and/or delete entries on the timesheet 4410.

Submitting timesheets as in step 4412 preferably moves the entire timesheet 4410 to the “Pre-Bills” section 4414 in the financial system, which may be used to generate draft invoices for review. Edits to the pre-bills may then occur for approval 4416.

Approval of a pre-bill may then create an invoice 4418 to send to client 4420.

With the foregoing methodology, the timekeeper is preferably able to capture more time without having to do more work to capture that time. Additionally, the time events are preferably converted into timesheet entries automatically through posting, which reduces errors and creates efficiencies by eliminating the need to transcribe handwritten notes, and sends these events directly to the financial system for invoice generation.

System 10 of the current invention makes unique use of timers with widely used electronic applications. For example, Microsoft Word and Microsoft Excel are commonly used by professional service provides, whether they be used to read or draft documents, evaluate financial information, etc. System 10 includes built-in timers to capture the time spent by a time keeper's using these applications. As such, the time captured helps complete the picture of how the time keep has spent his or her day.

Microsoft Word and Excel applications may include built in timers that start recording time automatically once a document is opened. Events may be created on the user's Outlook calendar once the document is closed. The time captured may be modified by configuration variables such as capture fence, minimum time increment and time multiple.

Activities regarding Word and Excel documents that may be created when either of these document types is open is as follows:

Create new MS-Word document: Event placed on Outlook calendar for captured time as Document Authoring Document Name.

Edit existing MS-Word document: Event placed on Outlook calendar for captured time as Document Editing—Document Name.

Create new MS-Excel document: Event placed on Outlook calendar for captured time as Workbook Authoring—Document Name.

Edit existing MS-Excel document: Event placed on Outlook calendar for captured time as Workbook Editing—Document Name.

As noted above, the time captured with the timers associated with Word or Excel may be modified by configuration variables such as time multiple 4430, minimum increment 4432 and capture fence 4434. These are now described with reference to FIG. 4D3 which shows a drop down box or other user interface form in which these variables may be used to set how time will be captured.

Time Multiple—Valid entries may be in decimal form # #. This is the time multiple 4430 that may generally be used for invoicing and that may reflect an agreement between the attorney or other service provider and client. Such an agreement may also provide for rounding up or rounding down in the case where elapsed or tracked time falls between time multiples 4430. In this case, time multiple 4430 represents the increment to which the elapsed time may be modified (by rounding up or down). Example: If time multiple 4430 is set to 0.1 and time capture is 7 minutes 30 seconds, the resulting time is preferably reduced to 0.1 to avoid overbilling, or may be rounded up to 0.2 if permitted. The foregoing may generally apply to individual time entries. Alternatively, extra time sub-increments, such as the extra 1 minute and 30 seconds in this example, may be added at the end of the day where block billing is used to avoid loss of time. The overall block billing total time may then be rounded up or down as appropriate.

Minimum Increment—Valid entries are in decimal form # #. This is the minimum time that will be placed onto an event once the capture fence is breached. Example: If set to 0.1 and time capture 4 minutes 30 seconds, the resulting time may be rounded up to 0.1 if permitted or otherwise appropriate as per client engagement and/or pertinent professional rules.

Capture Fence—Valid entries are in seconds. This is the minimum time a timer has to run in order to cause an event capture. Example: If set to 10 seconds, a timer has to run for at least 10 seconds to create a time capture.

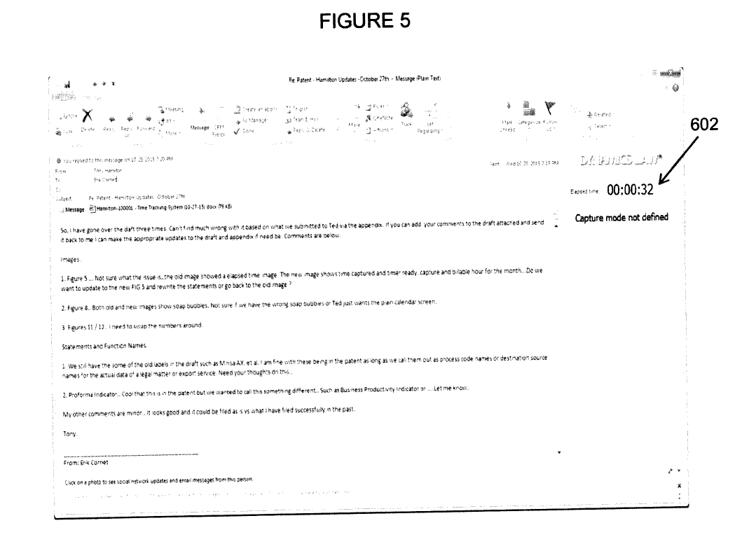

The tracking of time in connection with e-mails is now further discussed with reference to FIG. 5 and other figures. As an initial matter, e-mail interface 31 preferably appears as part or similar to the user's Microsoft Outlook screen as shown in FIG. 5. When a user opens an e-mail, the start time may be tracked by system 10. Tracked time information 602 may appear on the user's screen as shown in FIG. 5.

The time used to track time may start at 0 if this is the first time the user has opened the e-mail. Alternatively, if the user had opened and closed the e-mail previously, the time for which the e-mail had been open may have been tracked but not yet captured. Accordingly, when the e-mail is reopened, the timer may start at the time where the first review of the e-mail left off.

As the e-mail remains open while the user reviews the e-mail, the timer ticks off the seconds. When the e-mail is closed, the timer may stop, and the elapsed time may be automatically recorded to the user's time sheet calendar 500 as discussed later in connection with FIGS. 11-12. Alternatively, system 10 may pause the timer if it is determined that the e-mail, document or other item is behind another open window. As a further alternative, system 10 may automatically pause the timer if it is determined that the user has not interacted with the device, e.g., use keyboard, move mouse, touch a touch screen, etc., for a predetermined time interval.

At the same time, however, the user may be presented with an electronic form and/or drop down box or screen 620 as shown in FIG. 6. Form 620 may summarize information associated with the event, such as start date and time 628 and end date and time 630. Form 620 may also allow the user to input additional information about the event. As shown, form 620 may provide a subject field 622 in which the user may enter a subject regarding the work performed during the event. Form 620 may also provide field 624 in which the user may provide a description of the work performed during the captured time. A drop down box 626 may also allow the user to enter a matter or client designation 626. As discussed above, after information about a particular matter or client has been retained by back end 70, drop down box 626 may be prepopulated with potential choices for the user to select from.

When the user writes a new e-mail, or when the user hits reply, reply all or forward regarding an opened e-mail, user interface 31 and system 10 may automatically treat that as a new e-mail, and another timer may start running. In this manner, the time spent reviewing the original e-mail, and the time spent responding or forwarding the original e-mail with comments, may be automatically tracked as separate events. When the user hits send for the reply or forwarded e-mail, the timer may stop running and another pop-up box may appear and allow the user to enter whatever information that may be necessary or desired when capturing the time.

It is preferred that over time, the addresses of individuals who send e-mails to a user, or the addresses of individuals to whom the user sends e-mails, are stored in software 32 local to the user's computer. It is also preferred that these stored e-mail senders and recipients may become associated with a particular client matter, so that when a user opens an e-mail, or sends an e-mail, to a stored address, the time captured for the e-mails events is automatically associated with a particular matter. In this manner, when the user is done reading the e-mail, or sending an e-mail, form 620 may be completely or almost completely prepopulated except the description field 624 which will generally vary with each event.

The user may also block e-mail addresses from becoming logged into software 32, such as where the address is associated with a personal friend or other non-billable e-mail address. This is preferred so that personal e-mails and the like will not be stored by system 10 as potentially associated with client-billable matters. This avoids irrelevant time entries from appearing in later pre-bills or invoices. In order to block such an e-mail address, the user may right click the email address, i.e., by right clicking an e-mail from a third party sender in the user's inbox or a third party recipient in the user's “sent” box.

As part of system 10, the drop down box provided by the user's Microsoft Outlook program preferably includes an option for the user to choose system 10. The user may then select to, e.g., “Do not track time mail from [the email you right-clicked will be listed here].” In this manner, system 10 may create a “do not track” filter so that each e-mail sent and/or received from that address does not form the basis for captured time that may then be included in a client invoice.

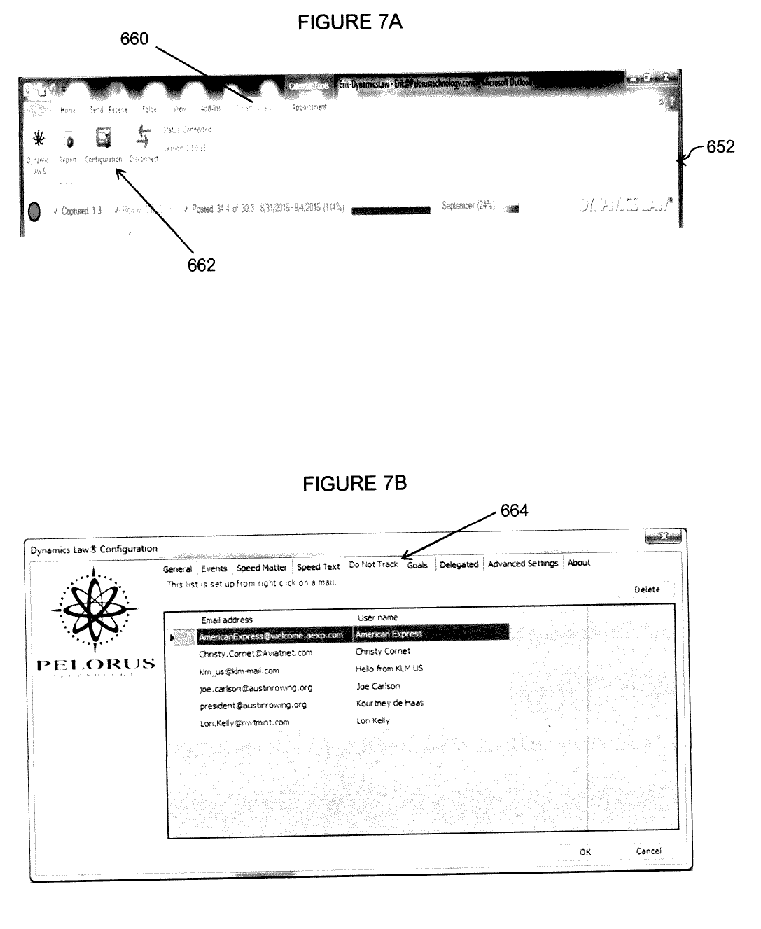

The user may also see a summary of e-mail addresses that are not tracked by system 10 for time capturing purposes. For example, as shown in FIGS. 7A and 7B, the user's Microsoft Outlook ribbon 652 may include icon 660 that is associated with system 10. Upon clicking on system icon 660, the user's ribbon may provide different options for the user. Upon clicking configuration icon 662, the user may be presented with several tabs as shown in FIG. 7B for different options. The user may then click on the “do not track list” icon 664 to be presented with a list of such e-mail addresses.

To reinstate a particular e-mail address so that it may form the basis of time to be captured, the user may right click the desired e-mail address and choose the option associated with system 10. Upon clicking on this option, the user may then select “Track time mail from [email name]” which may remove the filter. In this manner, the user's time spent reading or sending e-mails to that e-mail address may result in captured time to the user's time sheet calendar 500.

There are generally two modes in which tracked time may be entered into system 10 for ultimate billing. The first may involve rounding up, which as mentioned above should only occur per a client engagement and/or pertinent professional rules. With this mode, any time entry that does not reach a time increment set by the user may be rounded up to a value that is expressed in that increment. For example, the billing increment may be set as six minutes, i.e., tenths of an hour or 0.1 hour. If the time tracked for the user's entry is eight minutes, the entry may be rounded up to 0.2 if permitted. Alternatively, the entry may be rounded down to six minutes or 0.1 hour. As another example, if the time tracked for the user's entry is 93 minutes, the entry may be rounded up to 1.6 hours or rounded down to 1.5 hours. This rounding up or down is largely based on the fact that system 10 operates on standard time increments. Alternatively, time in excess of the established increments may be tracked, but in any event, as noted below, after the time is captured, the user is provided the opportunity to delete some captured time so as to not over bill the client.

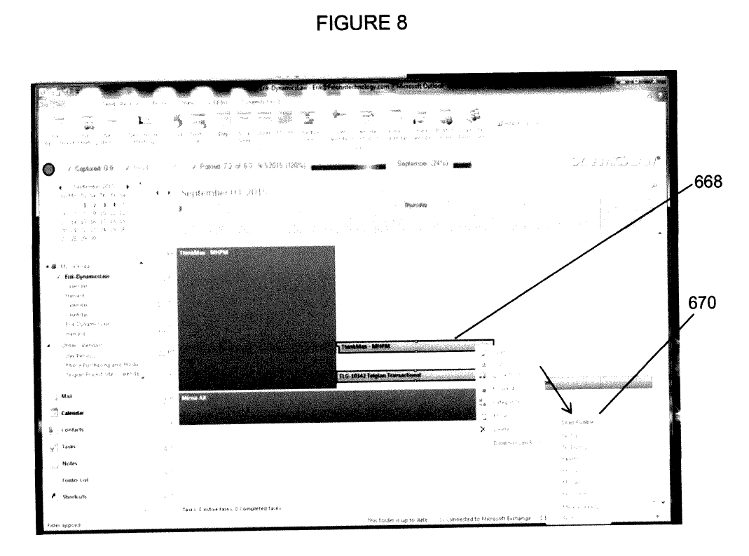

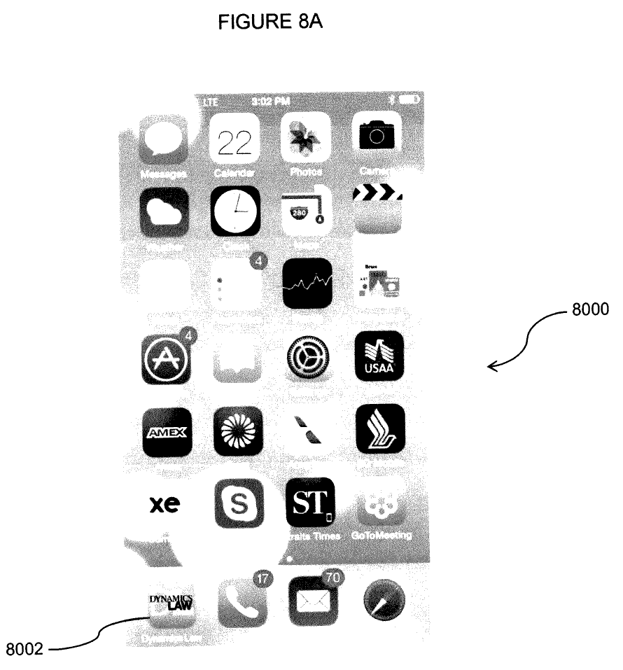

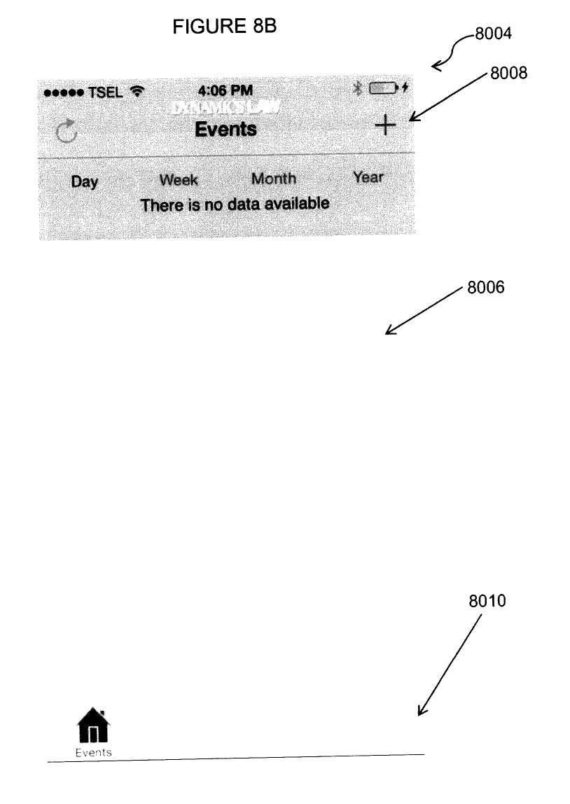

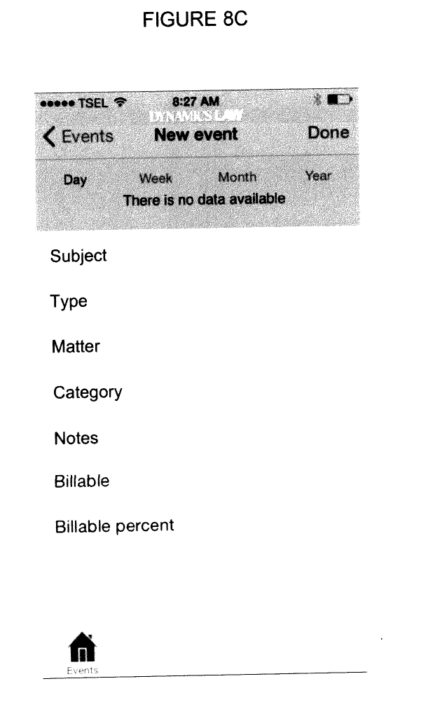

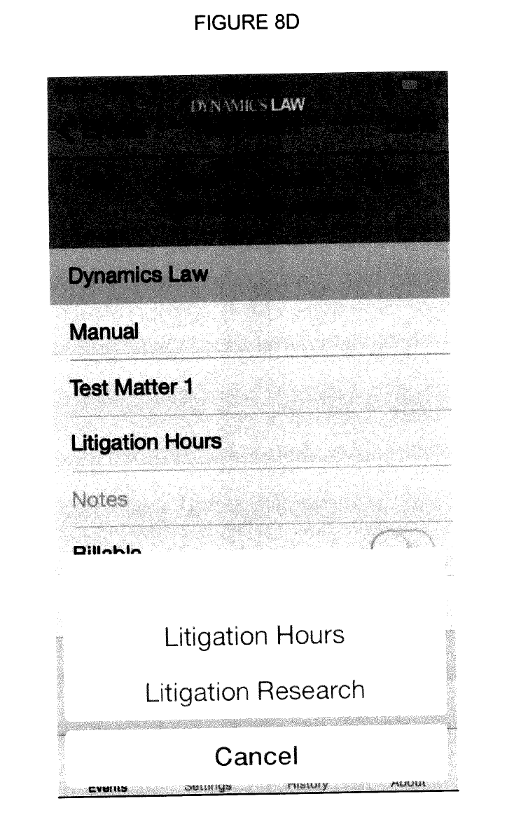

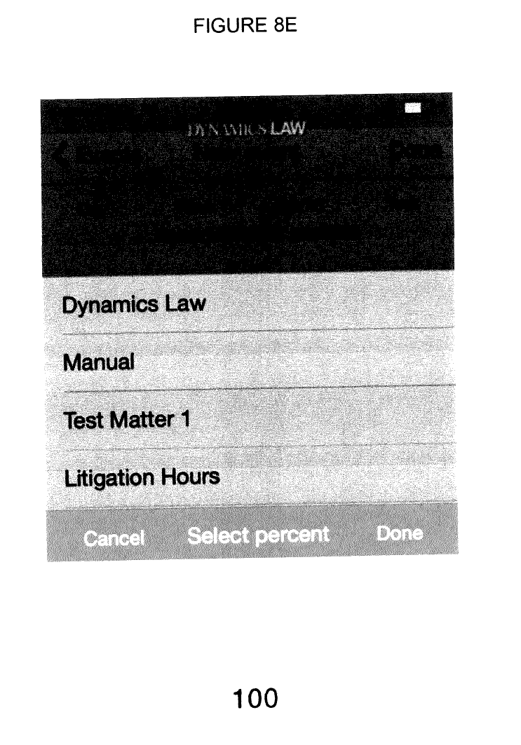

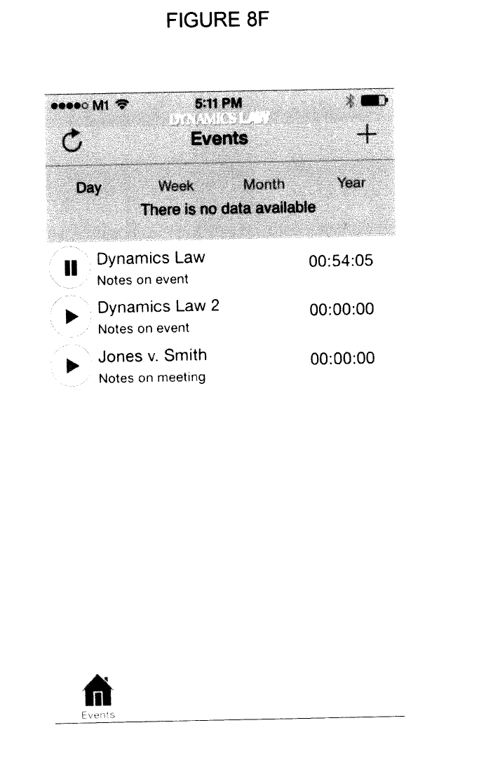

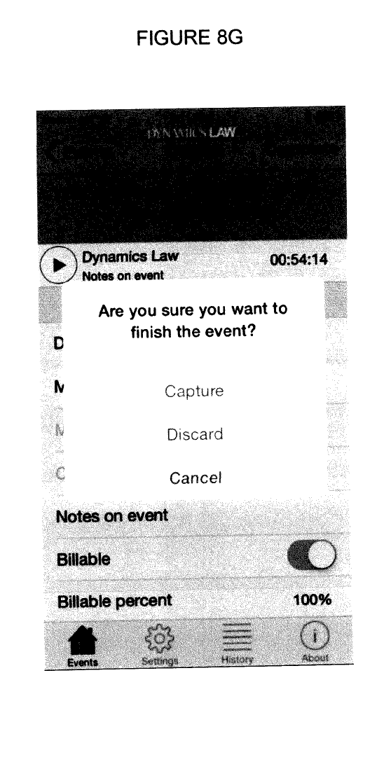

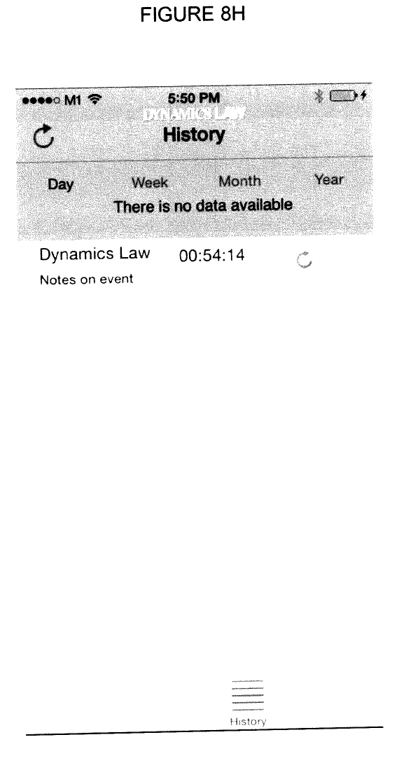

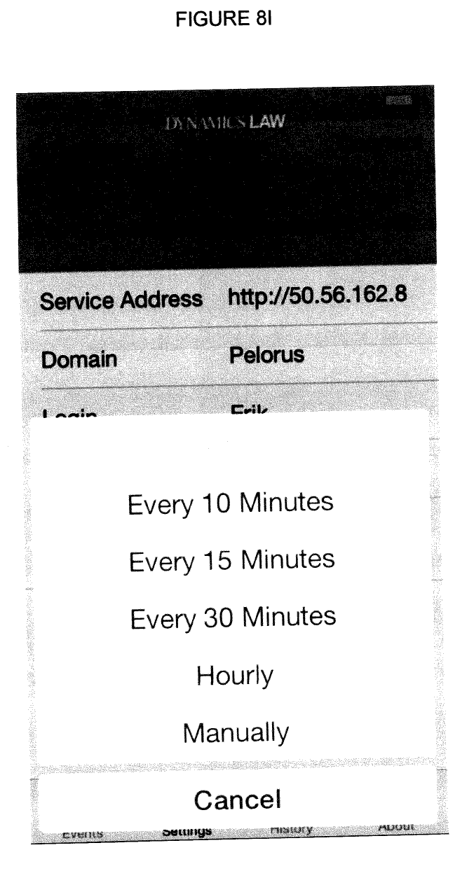

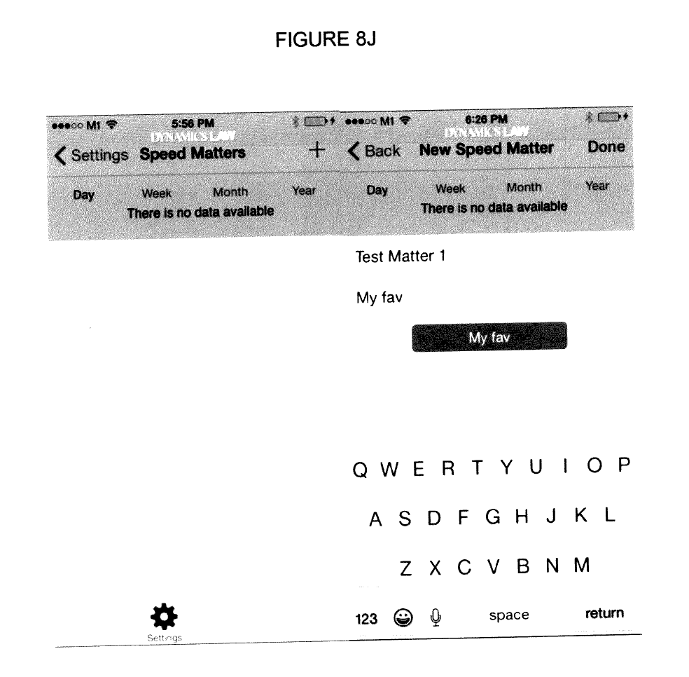

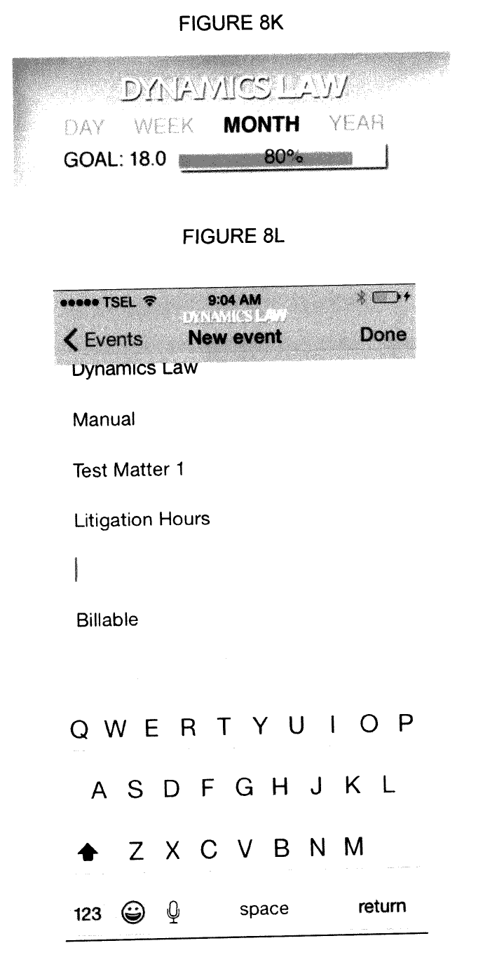

The second mode, with reference to FIG. 8, may involve an open bucket where all tracked time for a given day and matter may be combined. In current invoicing systems, this may be referred to as block billing. In this mode, after all the tracked time entries for a given day may be combined.

The user may combine entries selecting the time entries on the user's time sheet 500 by holding down the shift key and clicking each of the items to be combined. They may then be highlighted with a black outline 668. The user may right click one of the items with the black outline, choose the system 10 option, then click “Soap Bubble” 670. This will combine the entries' time and text into a single entry. Again, the user is provided the opportunity to delete some captured time to avoid overbilling the client.

The manner in which tracked time may be reduced to account for time in excess of established increments, to provide for discounts or for other reasons is now further described. As discussed later in connection with blue bar 300 and the different categories in which captured time may be placed, captured time may be “marked as ready,” and a pre-bill may be generated by the user to see the overall billings that would be sent to a client but for any modifications.

At this pre-bill step, tracked time may be erased to show discounts or for any other reason. This method may generally be referenced as capture and erase. With this feature of the current invention, clients may easily be apprised of discounts they are receiving. Alternatively, the user may simply erase time in excess of established and/or to avoid any possible rounding-up if not appropriate, or if he or she otherwise believes that too much time was tracked and would rather not display any perceived inefficiencies to the client.

The capture and erase method of the current invention is advantageous in that a user/timekeeper need not hunt around for time that he or she knows was worked but was not recorded. This often happens in manual systems where time entries are recorded by hand or entered into a system like carpe diem. That is, if the user/timekeeper forgets or is not diligent in recording or entering time entries, that time is generally lost; or the timekeeper may waste time trying to recall or reconstruct when the time was worked and exactly what work was performed. This ultimately results in a double waste of time. The current invention's capture and erase aspect avoids this situation.

Mapping of Time; Proforma Indicator Blue Bar

Now that the capture of time spent working with e-mails has been described, the manner in which system 10 may display the captured time to the user is now described. The manner in which the user may process that captured time into different categories is also described. For example, the user may “map” the captured time as a billable event if appropriate.

System 10 may include another graphical user interface (GUI) that may display the user's captured time and may also aid the user in converting that time as described below. In a preferred embodiment, this GUI may be referenced as blue bar 300. Blue bar 300 may be used with any of the user interfaces 31, 33, 35, 37, 39 so that the user may view his or her time spent working on of his or her electronic devices coupled to system 10. Blue bar 300 preferably involves the use of different colors to or other visual indicia so that the user may readily discern the category of time that has been captured. This provides a physical and visual element of the invention that preferably increases efficiency.

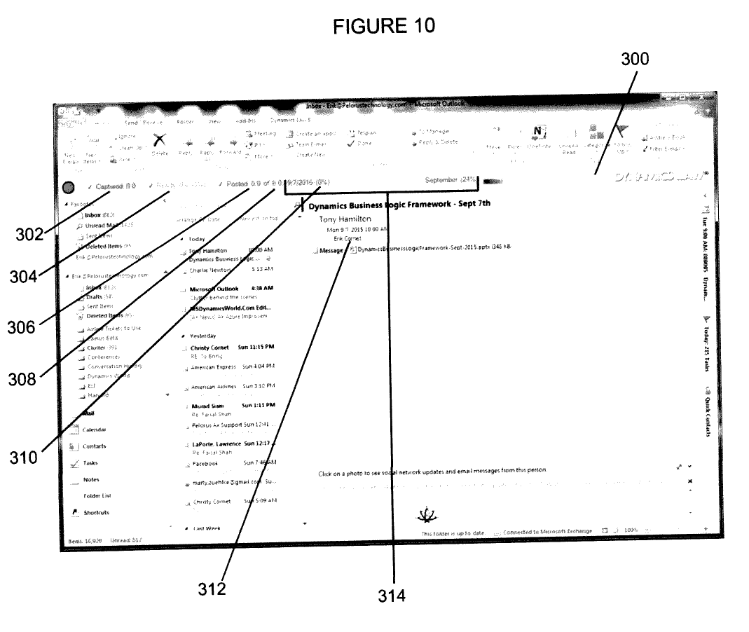

As shown in FIG. 10, blue bar 300 may represent a real-time status indicator for the user's time and billing. As its name implies, blue bar 300 may appear as a blue bar in the user's Microsoft Outlook, Microsoft Word and Microsoft Excel. However, other colors or indicia may be used, and this aspect of the invention may be used in other software programs besides Microsoft Outlook.

Blue bar 300 may provide information on a user's time and billing which may be continually updated in real time throughout the user's work day. For example, blue bar 300 may provide “captured” (blue) time 302 that represents the raw time worked by the user that has been captured, e.g., such as the time spent working with e-mail as described above. Blue bar 302 may also provide (orange) time that is “ready” or is “marked as ready” 304 and “posted” (green) time 306. Each time categories may represent the following.

Blue—“captured” time—These entries may represent a user's raw captured time from all of the user's devices that has been captured through user interfaces 31, 33, 35, 37, 39, i.e., automatic or manually added. Each captured time event may be assigned to a client matter (as discussed above in connection in connection with FIGS. 6 and 23), posted for billing (as discussed below) or left unutilized.

Orange—“ready” or “mark as ready” time—These entries may depict raw captured time event(s) that have been reviewed and assigned (with user notes if appropriate as discussed below) to a client matter. When a captured time event has been selected and processed as “ready” or “mark as ready,” the event entry preferably changes from blue to orange on blue bar 300 as well as in time sheet calendar 500 (as discussed below in connection with FIG. 11). Captured (blue) time may be converted to mark as ready (orange) time by the user pressing or clicking on the “marked as ready” button or icon. All things beings equal, changing time from captured to ready would change the numbers in blue bar 300 of FIG. 10 by decreasing the blue captured number 302 and increasing the orange ready number 304. In any event, the orange depiction notifies the user (timekeeper) that the captured or raw time event has been reviewed and assigned, and now is ready for posting to the financial system.

Green—“posted” time—These entries may represent a captured time event and all its associated information that has been approved and posted to the financial system of back end 70 for billing, accounting and other analytics purposes. When a captured time event has been “posted,” the event-entry will change from orange to green on blue bar 300 and calendar 500 (as discussed in FIG. 11 below). All things beings equal, changing time from ready to posted would change the numbers in blue bar 300 of FIG. 10 by decreasing the orange ready number 302 and increasing the green posted number 304. In any event, this notifies the timekeeper that the time event has been posted to the financial system and will be incorporated into an invoice and be available for business analytics and other back end functions.

It should be noted that the foregoing colors may vary, and that other indicia may be used to represent the foregoing categories of time. In any event, an advantage of using colors and/or indicia is that it represents a physical and visual effect to help the user track, categorize and report his or her time.

Still referring to FIG. 10, blue bar 300 may also provide information about the user's goals for billing such as a time “goal” (black) 308, “percentage of goal” (black) reached 310, and the date range 312 over which the goal times are measured. The user may set date range 312. As shown, the date range chosen in FIG. 10 is Monday to Friday, December 16 to 20. For these five days, the user has selected a goal 308 of 29.3 hours, and because the user's amount of green posted time 306 is 31.8 hours, the percentage of goal 310 is indicated to be 108%.

A significant advantage of the foregoing is that the user is not asked to learn anything new in order to track this time. Instead, system 10 automatically records time, shows the user what time is being recorded and then asks the user if the time is billable. Indeed, when used in a Microsoft environment, system 10 only serves to add a second calendar to the Microsoft Outlook Calendar view. Again, there is no new format or completely new software that must be learned by the user. This preferably allows quick adoption by a law firm or other professional service provider organization, which in turn may increase the efficiency of the firm.

Referring again to the tracking of time spent on e-mails, when an event has been captured, it automatically creates an entry on the user's time sheet calendar. As explained in more detail below, the user's time sheet calendar is another calendar view that may be added to the user's Microsoft Calendar application. Each tracked event may encompass the pertinent time of the calendar, so that a short event will encompass only a small amount of the calendar, while an event that took several hours will encompass more of the calendar. In this manner, each tracked event is conveyed to the user in a highly physical and visual manner.

The manner in which a user's captured time is displayed on the user's calendar is now described. This process of converting captured time into ready time or posted time is then described.

Time Sheet Calendar

The manner in which captured time may be displayed on the user's time sheet calendar 500 is now discussed with reference to FIGS. 11-12. As shown in FIG. 11, the user's time sheet calendar 500 may be another calendar view added to the user's Microsoft Calendar application. To this end, FIG. 11 shows a typical Microsoft Outlook screen (i.e., user interface 31) in a split screen configuration. This split screen configuration may be achieved by checking the typical calendar box 551 as well as the time sheet calendar box 501.

As shown, time sheet 500 and the time sheet calendar box 501 may be entitled by the user's name and time tracking system name, e.g., Dynamics Law™. In the split screen, the user's typical calendar 550 may be to the right where appointments and other events may be scheduled and/or otherwise noted. The user's time sheet calendar 500 may be on the left and may show captured time entries to be stored. An advantage of the split screen format is that the user may look at calendared events 550 on the right and compare them to his or her time sheet 500 on the left to ensure that his or her time is being captured.

In other embodiments, the user's time sheet calendar may be included in other calendar applications such as Lotus Notes. As such, the format of the time sheet calendar appears similar to the calendar function with which the user typically uses and is familiar. Again, this helps a law firm or other professional service provider organization readily adopt the system and method of the current invention.

Time sheet calendar 500 may generally be accessed by the user at any time during the day or at the end of the day, and may include interim totals or totals for that day. The tracked time for each event, regardless of the device it was tracked on, or whether it was manually tracked, may be represented on the user's time sheet calendar.

Referring now to FIG. 12, time sheet calendar 500 is discussed in more detail. Time sheet calendar 500 may include blue bar 300. As with blue bar 300 in FIG. 10, blue bar 300 may again include captured time 302 in blue, ready time 304 in orange and posted time 306 in green. The goal 308, percentage of goal 310 and time period 312 over which the goal numbers are measured may also be included; as may be the user or timekeeper name 314. To aid in the user's assessment of his or her day, the user may set the time period 312 as that particular day, so the other time numbers in blue bar 300 relate just to that day. In this manner, the user can keep a running tally of how well he or she is capturing time for that day. Keeping with the same color scheme, time sheet calendar 500 may display the total captured time 502 in blue, ready time 504 in orange and posted time 506 in green. These colors may have the same meaning as with the colors on blue bar 300.

Each category of captured, ready and posted time 502, 504, 506 may physically encompass a proportionate amount of space on time sheet calendar 500 indicating how much time of the day has been allocated to that category. For example, in FIG. 12, a significant portion of the user's time for day has already been converted to posted time 506 and is thus green. Another significant portion of the user's time for the day has been made ready 504 and is thus orange. A lesser portion of the user's time for the day has only been captured 502 and is thus blue. In sum, this provides a physical and visual cue for the user to see how his or her time has been recorded for the day.

Individual matters may also be displayed on time sheet calendar 500. Referring back to FIG. 11, time entry 520 is shown, and because it is green, it signifies to the user that the time has been posted. Time entry 520 may include two portions. Portion 521 may have a vertical height that is visually commensurate with the amount of time spent on that task. This portion may appear at the left of time entry 520 and may match up with the exact time of day that was tracked for that event. The other portion 522 is larger and may display text reflecting the user's comments on how the tracked time was spent. As shown, portion 522 includes the user's notes that he or she composed an e-mail re case notes.

The manner in which time entry 520 is depicted is another physical and visual aspect of the current invention. That is, the user has an immediate visual cue of how much time he or she spent working on the task represented by time entry 520 by looking at portion 521. However, because that time was short, it would not provide enough space for text describing the event. Accordingly, portion 522 is larger to provide that room. Where the user spent a significant amount of time working on event, portion 521 may be as vertically tall as portion 522, i.e., there would be no skinny neck portion 521 to the left of text portion 522. In this situation, another visual cue is provided to the user immediately conveying that he or she spent significant time on the event.

The user may double click on any of the calendar entries to obtain more information about that entry. This may include the notes that the user has entered into system 10 when, e.g., filling out form 620 of FIG. 6, that may describe his or her effort during the captured time event, which notes may be provided by back end 70 for use in creating invoices and providing other business analytics and reports.

The user may check his or her time sheet calendar 500 throughout the day to see his or her progress in tracking time by seeing how much blue captured time 502 appears. And throughout the day, if the user has already reviewed some captured time and converted it to ready time 504 or posted time 506, those colored sections will appear on time sheet calendar 500 as well.

It may be that the user is in the habit of converting captured time 502 to ready time 504 or posted time 506 at or around the time the event actually occurred earlier in the day. In this case, when the user views time sheet calendar 500 at the end of the day, different colored regions will appear. Alternatively, the user may simply just capture time throughout the day so that his or her time sheet calendar 500 contains all or mostly blue captured time 502 at the end of the day.

This latter method may be preferred where the user wants to see how much time has been spent overall in a given day on various matters. This may in turn influence whether the user decides to erase time as described above, e.g., in the case where the user believes that too much time was spent on a given event. This may also occur when the user wants to wants to provide a discount to the client and wants to show that discount, but the amount of the discount may depend on the overall time spent on a given matter.

The manner in which time may be converted into other categories is now further described. FIGS. 11, 12 and 13 relate to converting raw captured (blue) time to marked as ready (orange) time. FIGS. 11 and 12 relate to converting ready (orange) time to posted (green) time.

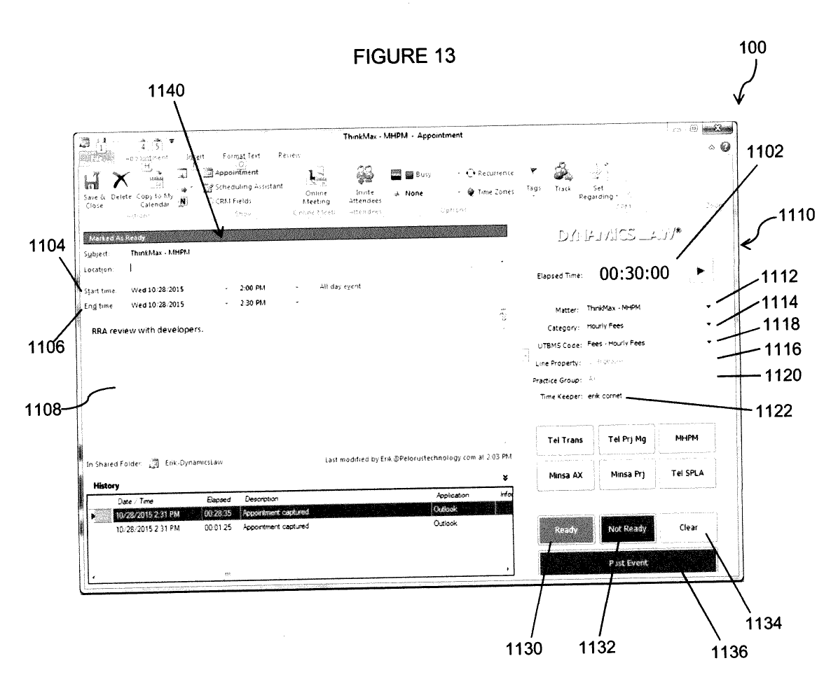

The user may convert raw captured (blue) time to ready (orange) time by clicking on any of the entries of blue captured time 502 in time sheet 500. At this point, the captured time entry may appear on graphical user conversion interface 1100 as shown in FIG. 13, which allows the user to review, assign and detail the raw captured entry as follows.

Conversion interface 1100 may provide basic information of the captured time event such as the amount of time captured 1102, start time 1104 and end time 1006 of the event. The description of the captured time entry 1108 that the user input when capturing the time as described in connection with FIG. 6 may also be provided. Generally, the captured time will remain blue until marked as ready, at which point it may change color.

Conversion interface 1100 may also allow the user to input additional matter information 1110 information so that the captured time entry is associated with a particular matter for billing purposes, and so that the captured time entry is classified in other desired manners for accounting and analytics purposes. To this end, conversion interface 1100 may allow the user to select a matter identifier 1112 with which the captured time should be associated, billing type 1114 such as hourly fees (or other billing arrangement as discussed alter), line property type 1116 such as chargeable, UTBMS code 1118 which is a classification provide by the Litigation Section of the American Bar Association to classify various tasks, practice group 1120 which may allow the time to be attributed to a particular practice group within the firm for later accounting and analytics reporting and 1122 which may further classify the captured time.

As shown in FIG. 13, the foregoing information may be selected by the user via drop-down boxes. In this manner, matter information 1110 may already be stored by system 10. For example, matter identifications 1112 may alphabetically list all the matters previously stored by system 10. Where matter identification 1112 is not yet stored by system 10, the user may be prompted to manually enter it so that it may be stored by system 10 for later access. (It is preferred, however, that a given matter identification 1112 is not stored by system 10 so as to be automatically accessible by a drop down box, until the matter has cleared conflicts and has otherwise been approved by the law firm or other professional services organization employing system 10.)

At this point, the user may review all the matter information 1110 that has been entered, and may also review the description 1108 of the captured time event. If the user is satisfied, he or she may then convert the captured time to ready time by clicking on the “mark as ready” icon 1130. At this point, what had been the blue bar may change color to become orange bar 1140 which allows the user to readily see how this time entry has been categorized. As this conversion occurs, the user's calendar 500 is also adjusted to show orange as opposed to blue for the particular captured (blue) time just converted to ready (orange) time.

If the user calls up the readied entry later on, and after further review believes it should be converted back to only captured status, the user may click on the “un-mark as ready” icon 1132. When this occurs, the time represented on the user's calendar 500 will show an increase in captured (blue) time and a corresponding decrease in ready (orange) time. Alternatively, the user may hit the clear coding icon 1134 which may remove all coding such as Matter, UTBMS, etc.

The user may also click on the “post event” icon which may serve to convert the ready time to posted time. When this occurs, what had been orange bar 1140 would become green bar 1150 to reflect the posted (green) time. When this occurs, the user's calendar 500 will show more green posted time and less orange ready time.

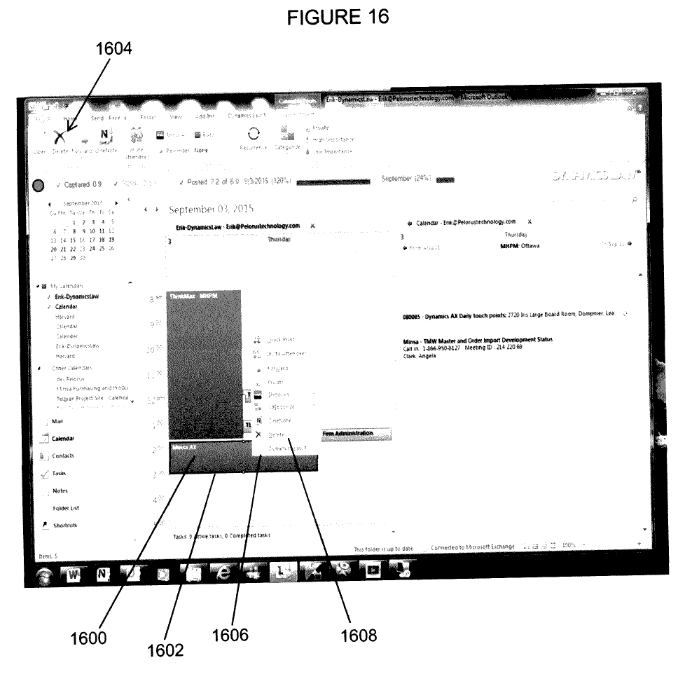

Beyond the tracking and converting of captured time, the user may also modify his or her time sheet calendar 500 as desired. For example, as shown in FIG. 16, the user may delete an event from time sheet calendar 500 that has already been recorded. This may be accomplished by selecting the entry 1600 to be deleted by clicking on that entry in time sheet 500. This may occur with a single click on entry 1600. As shown, that entry will become highlighted, e.g., by a dark border 1602 appearing around the periphery of entry 1600. At that point, the user may click delete 1604 in the ribbon. Alternatively, the user may right-click on entry 1600 at which point a drop-box 1606 of options may appear, and the user may click on delete 1608. As further alternatives, after highlighting entry 1600, the user may press the delete key on the keyboard or use the keyboard combination of Ctrl+D.

The foregoing is another example of how the use of system 10 may be similar to the use of the user's existing Microsoft Outlook system. That is, the right-click function may operate similar to it typically does in Outlook. As such, it is preferred that system 10 may be readily adopted by users.

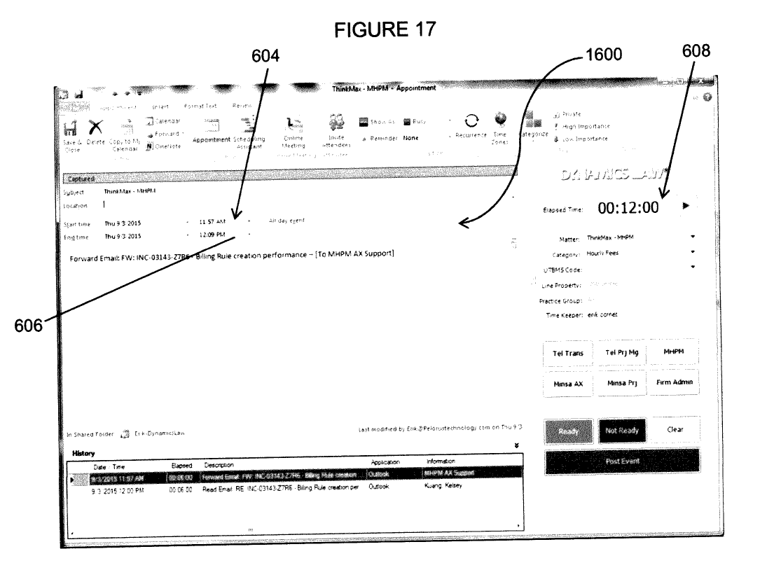

The user may also adjust a time entry that has already been entered on time sheet 500. To accomplish this, as shown in FIG. 17, the time entry 1600 to be adjusted may first be opened by double clicking on entry 1600. This may bring up the time capture user interface previously discussed in connection with e-mails above, and as will be discussed in connection with other devices below. After entry 1600 has been opened, the user may change the start time 604 and/or end time 606. Alternatively, the user may change Elapsed Time field 608 to adjust the time to the desired overall time spent on the event. Elapsed Time field 608 may be adjusted in two ways. First, the user may enter the desired decimal form in hours and tenths, e.g., 1.7 is equal to 1 hour and 42 minutes. Second, the user may enter the standard format in hours, minutes, and seconds (HH:MM:SS), where a zero (0) zero (0) would be entered in for seconds.

Tracking Time of Cell Phone Calls

The tracking of time regarding cell phone calls is now described with reference to FIGS. 8A-8L. As shown in FIG. 8A, a user's cell phone 8000 may include icon 8002 that may represent an app or other gateway to system 10. It should be noted that the use of cell phone 8000 with system 10 may also occur through other engagement solutions and constructs.

Once icon 8002 is clicked, a main or “events” screen 8004 may be launched as shown in FIG. 8B. Events screen 8004 may connect to the user interface section 3001 of system 10 and may be supported by business logic architecture 3004 and CPE synchronization software 3002.

Still referring to FIG. 8B, the middle white section 8006 may show timers that are not submitted to system 10. These timers may be either running or paused. The user may have multiple timers running. The timer software is part of the Business Logic Framework 3004 that may run timers based on User Engagement Actions in and around Events and Matters and is architected as part of the Data Layer Capture and Timer Processing Architecture and Service 3003.

The “PLUS SYMBOL” 8008 may be the UI Trigger for time capture processing or how to invoke and engage the “Data Layer Capture and Timer Processing” Sequence. This sequence may be defined as in the previous software architecture diagrams in this document. To “Begin” this sequence a new event needs to be created and documented on the Events Screen.

The bottom section 8010 of screen 8004 may contain navigation icons. These navigation icons may help with the next level of data capture and user entry and pertain to personalized and documented details of client engagement activities, client identification specifics and billable/non-billable considerations for professional services.

Once a user decides to invoke a new event, which ties into the Embedded IU Application Software layer 3001 of the business logic framework 3004, key entries may occur to document the actual subject, type, matter, category, key notes and billable considerations. While most of these items may be additive in nature and predetermined over the course of application usage, there is some amount of data entry that may be needed to make use of the application usable and effective.

This area of UI 3001 and business logic framework 3004 may be a focused use of the Embedded UI Application Software 3001, Multi-Platform BLA and Proforma Service 3004, CPE—Synchronization Services 3005 and Data Layer Capure and Timer Processing 3003.

As shown in FIG. 8C, various information may be used. For example, the “type” may be identified as a digital communication method such as phone, e-mail, text, meeting, manual, or other communication.

Matter may be identified as the actual case or service that is occurring via this particular digital communication method.

Notes may be the user's personalized commentary and thoughts in and around a particular event and matter from digital engagement with clients.

Billable/Billable Percentage may be the go/no go on if that particular client is to be charged with a particular fee for these services and at what rate based on who the professional service knowledge worker is and is in turn engaging with.

As shown in FIG. 8D, this image highlights the options for the Litigation Hours categories that may help with detail and percentage billing decisions. The drop down box highlights litigation hours, litigation research and a “cancellation” options of the litigation “category” entry.

As shown in FIG. 8E, this image highlights the unique pin wheel selection, software rotating dial, UI for selecting billable percentage rates for a given entry also provides “cancel” and exit options for litigation hours drop down exit of completion. This UI Features ties in with the Business Logic Framework Embedded UI Software Interface, the CPE-Synchronization Services and the Business Logic Architecture.

As shown in FIG. 8F, once details and category thoughts are entered into the events screen, the new event is read and displayed on the Event Listing UI. More Events may be added by pressing the “Plus Symbol.”

The events and event timers may be started and stopped via the icon to the left hand side of each event description. An event running an actual timer will move to the top of the event list. If the event is stopped or paused then the symbol will change to the left side of the actual event description. So the user has the ability to run and stop instantly all classes of professional services activities.

To complete the actual event process and move to a capture or discard drop down box the user must first stop the actual event timer press on the “complete” button and select and answer from the finish event drop down box. This can is highlighted in the image below.

As shown in FIG. 8G, the completion of an event sequence or multi-event sequences ties in with the Business Logic Framework Embedded UI Services 3001, CPE-Synchronization Services 3002 to ERP or Dynamics AX Software, Business Logic Architecture UI Priming and Indicator Software and the Time and Data Capturing Process.

As shown in FIG. 8H, confirmation of Data Synchronization to Enterprise Software such as general ERP Solutions or MS Dynamics may be done via the History Section in the user Interface. The Synchronization loop icon on the top left of the History Screen may indicate that this is a user option to select. Once this icon is selected the active synchronization icon with operate next to the actual event description. Red indicates that the event is not yet synchronized but will do so and Green indicates that event has been synchronized to the back end software solution via CPE-Transcoding Services.

This Real Time Active Process of Data Transfer, Transcoding and Time and Proforma Details happens via the: 1. Embedded UI Application Service, 2. CPE—Synchronization and Transcoding Services, 4. Multi-Platform BLA Rate and Proforma Services orchestration in software.

As shown in FIG. 8I, as previously mentioned Business Process Framework can operate both independently and in orchestration with cloud and back end dedicated ERP Solutions and MS Dynamics AX Software. To choose the former, a number of connectivity parameters have to be entered into the Dynamics APP that tie and bind those particular infrastructure domains together. This entails the known service address of the actual back end solution, a given domain identifier, login details and passwords. Also there is an option to selected automated synchronization.

As shown in FIG. 8J, a unique efficiency feature of the Dynamics Law Mobile Product is a pre-set option for keep track matters in a more concise fashion. “Speed Matters” typical live within the listing area under shortened names and are faster to access versus going over the longer list of matters in the main user Interface flow of tables and drop down boxes.

When matters are selected the speed matters will show as blue buttons. Pressing on the desired speed matter selects that matter for the event. Again, this is a faster process that scrolling through a long list.

Adding a Speed Matter commences with the user selecting the “Plus Symbol from the top right hand side of the UI Screen and once entered and defined pressing the “Done Symbol” when the entry is completed.

As shown in FIG. 8K, the top part in blue is similar to the blue bar 300 of system 10 as shown in, for example, FIGS. 10-12, regarding MS-Outlook. This section contains a progress bar showing the amount of posted hours compared to the goal for the user of the device. The goal is displayed on the lower left. The example below shows the user is 80% to the goal of 18.0 hours.

This may provide a Proforma indicator and around the higher level software architecture of the Business Logic Framework 3004.

Above the progress bar are the words: Day, Week, Month, Year. The default is Month. The user can select Day, Week, Month, or Year by pressing on the word. Selecting a word changes the goal and the progress bar to that date range. In the example above Month is selected therefore the goal of 18.0 is for the current month and the progress of 80% is to that goal.

Selecting Day would cause the goal and progress bar to change to the current day. Selecting Week would cause the goal and progress bar to change to the current week. Selecting Month would cause the goal and progress bar to change to the current Month. Selecting Year would cause the goal and progress bar to change to the current Year.

This section is always present regardless of what other screen may be selected as it pertains to mobile app solutions for Apple, Android and Windows Phones and Platforms.

Tracking Time of Manual Events

The tracking of time regarding manual events is now further described with reference to FIG. 11 and other figures. As noted earlier, the current invention is advantageous because in addition to automatically capturing the time that a user spends working with the electronic programs linked to system 10, manual events may also be tracked. Manual events may include time spent reading hard copy documents, business lunches, meetings, court appearances or other events on which a user does not work on his or her electronic devices.

To track a manual event, the user may select the calendar view in Microsoft Outlook, e.g., the My Calendars view, such as by clicking icon 501 in FIG. 11. (It should be noted that the current invention may also be used with software programs other than Microsoft so while the following discussion focuses on Microsoft, the current invention is not limited to use with that software. To this end, the calendar view of another software program being used may be selected.)

This selection preferably provides the split screen view shown in FIG. 11 which includes the user's appointment calendar and time sheet calendar 500. This may be preferred because seeing both calendars at the same time may remind the user that he or she should be starting to track a manual event. At this point, the user may select his or her calendar time sheet 500, e.g., Dynamics Law Calendar, in order to make that calendar active so that the view shown in FIG. 12 appears.

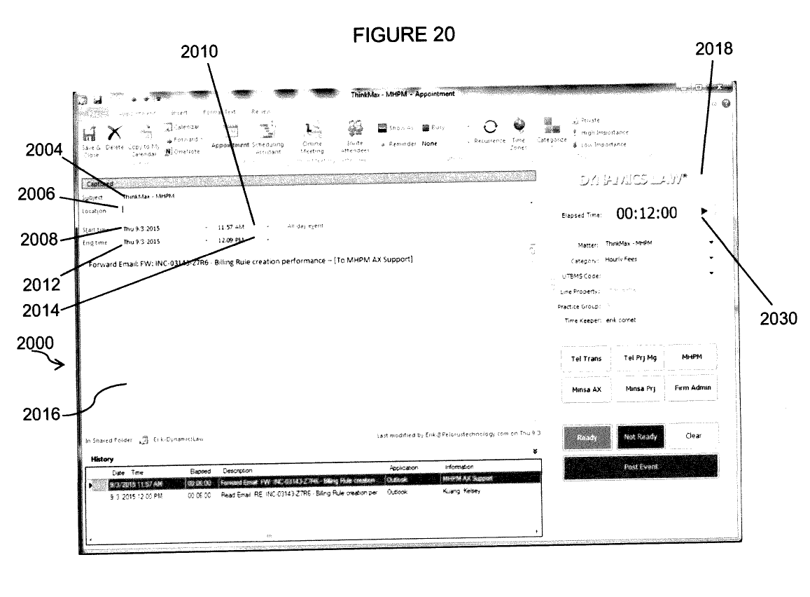

The user may then click on the New Appointment icon 2002 in Microsoft Outlook which will provide the user with manual event user interface 2000 shown in FIG. 20. At this point, the user may enter information about the manual event that is to occur, is occurring or has occurred. For example, the user may assign the client matter, add notes, modify time or add time and enter all pertinent details using the fields described below.

More specifically, the user may enter the subject of the manual event, e.g., court appearance for client ABC, Inc., in subject field 2004. The location of the event may also be added using location field 2006, though this information may not necessarily be transmitted to system 10. The start date 2008, start time 2010, end date 2012 and end time 2014 may also be entered using drop down boxes as shown in FIG. 20. Start and end times 2010, 2014 may also be entered with the user's keyboard. The user may use notes field 2016 to enter a description or notes of the manual event that may appear on the pre-bill and client invoice. Spell check may also be performed on the notes by pressing F7.

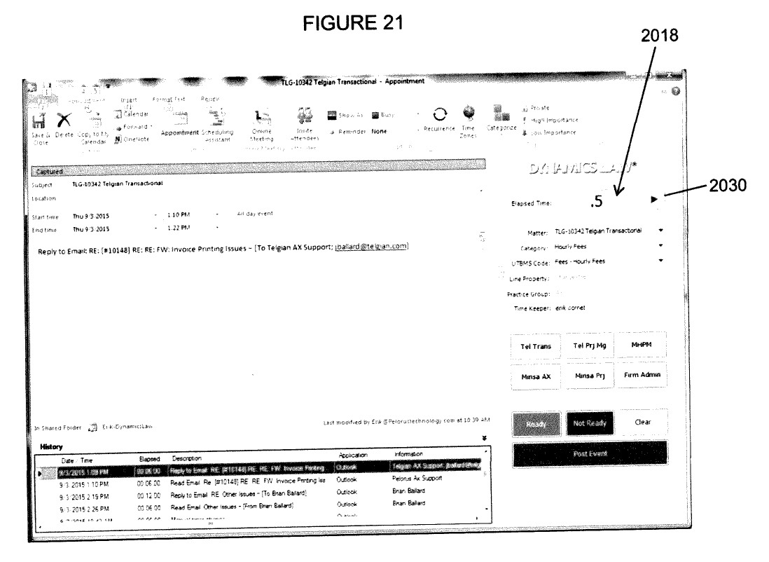

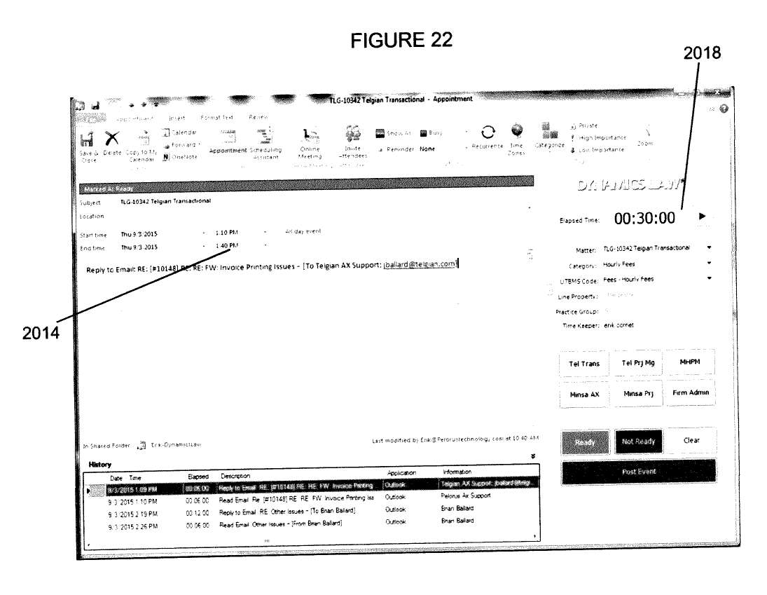

The time spent on a manual event may be captured in several ways. For example, time may be entered directly into system 10 through interface 2000. This may occur when the user entered the start time 2010 and notes the time when the event actually ends. In this manner, when the event is over, the user may simply enter the time spent directly into system 10. To achieve this, as shown in FIG. 21, the user may click on the Elapsed Time field 2018 and enter the time in increments of 0.1 (decimal format). This entry will change to clock time when the user leaves the Elapsed Time field 2018 as shown in FIG. 22. As shown, in this example, the entry of 0.6 is automatically converted to 36 minutes. As this occurs, the time in the Ending Time Field 2014 is also updated to include starting time plus elapsed time.

In another example of entering time, if the manual entry ends up starting and ending at the start and end times 2010, 2014 entered by the user, Elapsed Time field 2018 will display the time spent as shown in FIG. 20. This may be useful when there is an event for which a definitive amount of time has been allotted, and the user knows that the elapsed time spent on the manual event will be according to the entered start and end times 2010, 2014.

Beyond capturing the time spent on the manual event, the user may enter information so that the time is associated with the proper matter, etc. To this end, the user may assign the proper client matter from the matter drop down menu 2020 as shown in FIG. 23. The other field that may be used to code the manual event entry may be auto-populated based on settings in system 10 back end 70. Alternatively, the user may enter information such as category of billing time 2022, line property 2024, UTBMS Code 2026 and practice group 2028.

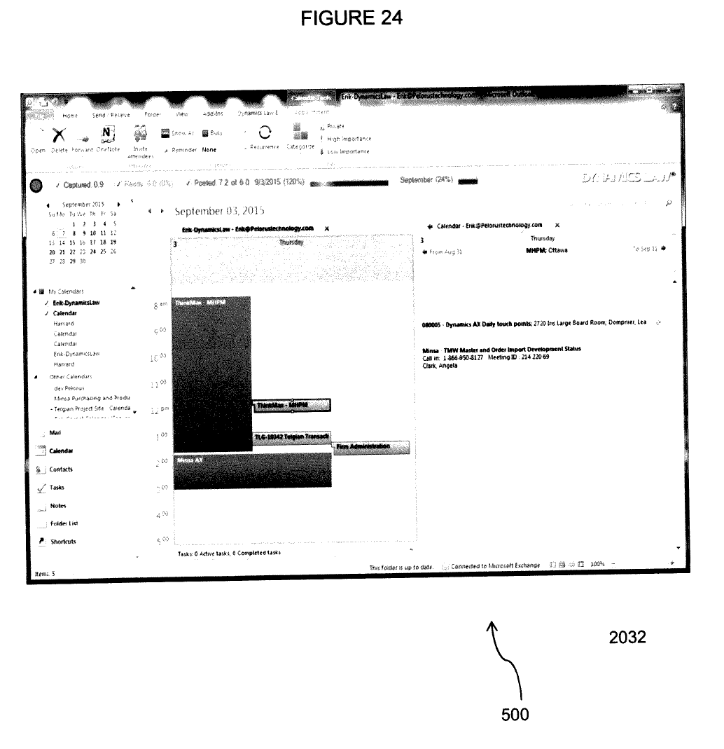

To save the manual time entry, the use may click on the green arrow 2030 (or other icon associated with saving manual time). This saves the manual time entry to the user's time sheet calendar 500 and closes the manual time event interface form 2000. In so doing, the user's time sheet calendar 500 is adjusted to reflect the saved manual time event. As shown in FIG. 24, the manual time entry 2032 is inserted into the user's time sheet calendar 500 at the time slot selected by the start time and end time fields 2010, 2014. In the example of FIGS. 20 and 24 where the manual time event 2032 was 30 minutes long from 3:30 to 4:00 p.m., this time slot is taken up by time entry 2032. It is preferred that this event 2032 is depicted visually in relation to the time bar to the left of the calendars. Because this manual event 2032 comprised 30 minutes, the vertical height of this depiction is not as large as other entries in the user's time sheet calendar 500. In this manner, the user may readily see how different portions of his or her day were taken up by various tasks.

No Charge/Special Billing Insert

Another feature of the drop-down box when tracking time is preferably a non-billable, or no-charge, column. Categorizing time in this column allows that pre-bills will show “no charge” as to the pertinent time, as opposed to waiting until the pre-bill to indicate no charge.

Another feature of the drop-down box when tracking time is that certain time may automatically be billed at a lower hourly rate or at a designated percentage of the user's normal hourly rate. For example, the user may intend that his or her travel time be billed at only 50% of his or her normal hourly rate. This is not uncommon, especially in today's economy, where clients simply will not pay full hourly rates for travel. With this feature, the user may simply check a box or otherwise indicate to system 10 that certain tracked time should be billed at an alternative rate.

Speed Matters

As noted earlier, software 32 preferably saves various information regarding the matters and clients that a user works on. However, software 32 may also save information regarding the user's law firm or other professional service organization. Information on the following categories may be saved in back end 70: User Personalized Allias for Matters or Speed Matters, Examples could be Tel trans; Tel prj mg; MHPM; Minsa AX, Minsa Prj, Firm Administration, UTBMS (ABA) Code, Line Property and Practice Group. This information may be locally stored in software 32 on each user's computer or other device for each in a given law firm or other organization. And when a particular user captures time, his or her efforts may be tracked under any of the foregoing categories. In this manner, for example, a user's captured time that may be recorded by back end 70 with a view towards contributing towards the overall captured time of that user's practice group. In a law firm, for example, with multiple practice groups for different areas of law, this may be helpful in gauging how busy, successful, profitable, etc., each practice group is.

When software component 32 is connected to Microsoft Outlook, it may provide a dashboard for the user to quickly view his or her time and billing status for a specific matter, date range and month to date. And this may occur for time spent working on e-mails, documents and phone land lines. With this dashboard feature, a user's time may be presented in different colors to aid in quickly understanding the tracked time. This physical and visible feature is an advantage of the current invention. In a preferred embodiment, this dashboard may be referred to as the Blue Bar. With the Blue Bar dashboard, a user's time may be captured, ready and posted, and each may be represented by a difference color.

Software component 32 may also provide artificial intelligence capability for system 10. More specifically, system 10 preferably operates so that one or more of user interfaces 31, 33, 35, 37, 39 may learn how to automatically apply a client matter to an event for which time is being tracked. In this manner, system 10 may automatically know which client matter, and ultimately, which invoice the tracked time should be allocated to.

As an example with e-mail, a user may read, compose, reply and/or forward an e-mail. It is preferred that the user need input information about the matter related to this e-mail only the first time any of these e-mail operations occur. In this manner, the next time a subsequent action involving that e-mail or e-mail string occurs, the relevant matter will be applied automatically to the time the user spends addressing that e-mail, without interrupting the user by requesting this information.

This feature may apply to the word processing interface 33 as follows. Once a Word document has been created or opened, the user may assign a matter to it. And in the future when that the user works with that document again, the same matter may be applied to the time spent working on it.

Regarding land line phone interface 35, the first time a user punches in a particular phone number, for example, he or she may be prompted to enter a matter number. But when the user makes or receives a call to or from that number in the future, system 10 automatically associated the time spent on that subsequent call with the previously-entered matter. The same procedure may be used with cell phone calls.

The manner in which a particular embodiment of the artificial intelligence feature operates is now discussed in more detail. Regarding e-mails, the artificial intelligence aspect of system 10 is preferably able to analyze the content and the people associated with the e-mail, search the databases contained in software 32 and propose potential matters that may match the user's current e-mail, document, phone call, etc. In a preferred embodiment, system 10 may provide the user with three matters that potentially match. This is beneficial because multiple matters may exist for a given client and so automatically just providing one potential matter match may result in the wrong matter being proposed.

With three potential matches provided, the user may easily choose the correct one and proceed. By doing so, the artificial intelligence feature of system 10 learns from that choice and is able to better discern which matter or matters to propose the next time a particular e-mail, document, phone call, etc. is at issue.

In another embodiment of the current invention, system 10 may have the ability to create additional calendars within Outlook to store the elapsed time recordings for different types of events, projects or matters. In one example, system 10 may create an Uncategorized Events Calendar to store elapsed time recordings and other information for events that may not have been previously categorized, or for events that may not have their own event monitors. Note, as described above, events related to programs and applications such as email, Microsoft Word, Microsoft Excel, Microsoft Lync, Microsoft PowerPoint, Microsoft Visio, and Microsoft Visual Studio and other programs and applications may have pre-existing event monitors and may be excluded from this functionality.

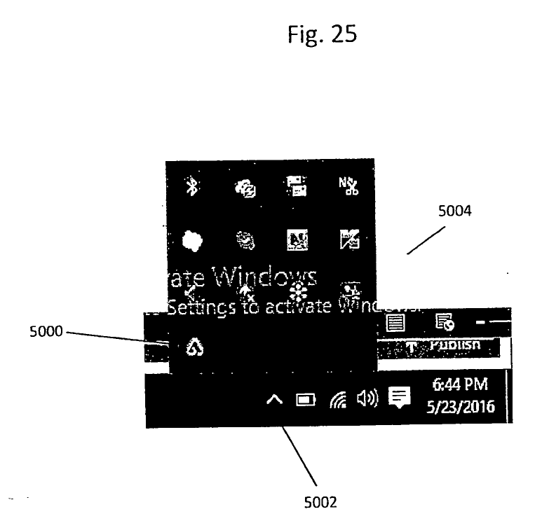

As with the other embodiments described above, system 10 may run as a service on the client personal computer and may start upon the computer's power-up and the loading and initializing of the computer's operating system. Once loaded and started, system 10 may place an icon 5000 representing system 10 in the system tray 5002 of the computer's desktop 5004 as shown in FIG. 25.

Upon clicking on the system 10 icon 5000, the user may initiate a control dialog box that may allow the user to interact with various function controls including but not limited to:

START: This function control starts the system 10 service if it has not already been started. If system 10 has already been started, as with the start-up of the computer and the loading of the computer's operating system, this function control may be ghosted.

STOP: This function control stops the system service 10. If the system 10 service is stopped, the function control may be ghosted.

SETTINGS: This function control displays the settings dialog for the system 10 service and may allow the user to edit the various settings as necessary.

MONITOR: This function control displays the monitor readout for the system 10 service so that the user may monitor the service's activities in real time.

Next, when a user opens and begins using a previously uncategorized software program or application on his or her computer, system 10 may execute a capture event sequence that may include initiating a timer on a new and independent thread for the new event. Note that the functionality and sequence of this may be the same or similar as for the previously described events in the above sections for other types of programs and applications. During the capture event sequence, system 10 may collect or attempt to collect a variety of data elements from the current application or program being used during the capture event. Such data elements may include but are not limited to the following:

DATE: This may be the capture date shown on the user's computer. Data type=date.

HANDLE: This may be the Window's handle for the source program being used by the user during the capture event. Data type=string.

PROGRAM NAME: This may be the program name from the capture such as Internet Explorer, Microsoft Edge, etc.

DOCUMENT NAME: This may be the name of the document or webpage that is opened by the program during the capture event. For web applications, this may be the name of the webpage being viewed by the browser such as “CNN—Breaking News”. For non-web applications, this may be the Windows name caption of the program such as “TiMUniversal.docx”.

FILE OR DOCUMENT PATH: For web applications this may be the URL of the webpage being viewed, such as “http://edition.cnn.com”. For non-web applications, this may be the file path such as C:\OneDrive\TiM\Development\TiMUniversal.docx.”

ELAPSED TIME: This may be the amount of time in seconds spent on the current program event. There may be a start time and a stop time, and the elapsed time may be the difference between the start time and the stop time. It should be noted that this data element may be captured upon a save event trigger as described below.

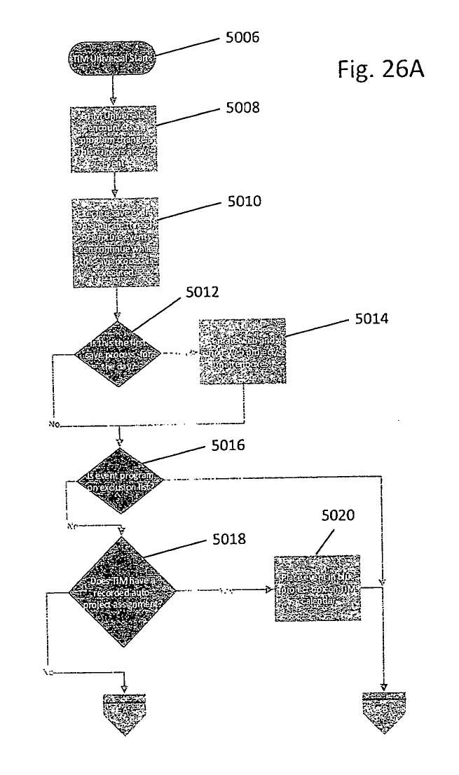

As shown in 5006 in FIG. 26A, system 10 may start and execute as described above and may continue monitoring the activities on the computer. The timer may continue to record the elapsed time that the user has spent focusing on the current application or program until a trigger occurs that system 10 may identify as a save event trigger as shown in 5008. This save event trigger may include the user closing the program or application, pausing for a predetermined amount of time, bringing the window of a different program or application to the foreground of their monitor, or any other activity that may signify that the user has generally switched their focus to a new application or program. When system 10 recognizes a save event trigger, system 10 may execute a save event which may include initiating a sequence of events to properly resolve and store the various data elements described above to the uncategorized events calendar.

It is important to note that upon a save event trigger, system 10 may execute the save event on a separate thread while also beginning the capture event for the new program or application that the user may have turned their attention to. This ensures that the system 10 may accomplish both tasks simultaneously. That is, system 10 may execute the save event sequence for the previous event and may also execute the capture event for the new event. In addition, system 10 may employ buffering as necessary to ensure that system 10 may process the save events in sequence if the user is switching between programs or websites in a rapid fashion. This is shown at 5010 in FIG. 26A, and improves the operation of the computer and system.

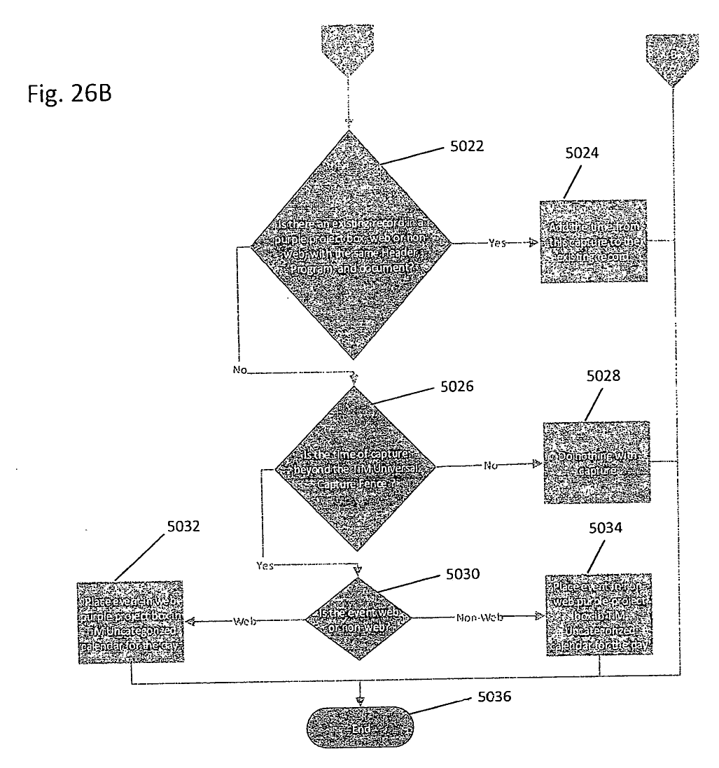

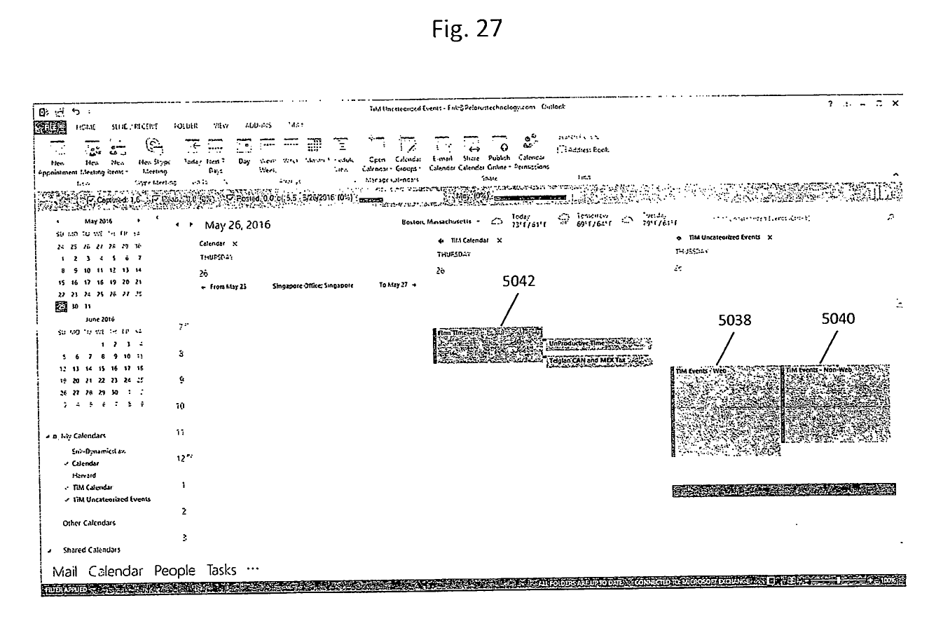

Upon initiating a save event sequence, system 10 may next determine if the save event is the first save event for the day as shown in 5012. If the answer is yes, and the save event is the first save event for the day, system 10 may create one or more project/matter boxes in the Uncategorized Events Calendar. In one embodiment system 10 may create a single Uncategorized Event Calendar for all of the uncategorized events. In another embodiment, system 10 may create one Uncategorized Event Calendar for web events that may include all Internet browser events, and one for non-web events that may include all non-browser events. Other types of calendar boxes for events having other types of characteristics may also be created. This step is shown in step 5014 of FIG. 26A and the web and non-web boxes within the Uncategorized Events Calendar are shown in FIG. 27 as 5038 and 5040 respectively. Uncategorized data elements for the day may then be placed in these calendar boxes throughout the day as described below. Note that the default color for these boxes may be purple but any color may be utilized. After this step is completed, system 10 may move to node 5016 of FIG. 26A.

If the answer is no and the save event is not the first save event of the day, then system 10 may have already created the uncategorized box or the web and non-web boxes described above and system 10 may move directly to node 5016.

As stated above, some events may have their own event monitors such as email, Microsoft Word, Microsoft Excel, Microsoft Lync, Microsoft Power Point, Microsoft Visio and Microsoft Visual Studio, and other events, programs and applications, and these events may therefore be excluded from the Uncategorized Event Calendar. In addition, other programs and applications may also be excluded from the Uncategorized Event Calendar by the user in the service exclusion settings.

At node 5016, system 10 may determine if the event program or application is an excluded event as described above. If the answer is yes, and the event program is an excluded event, system 10 may end the save event at node 5036. If the answer is no, and the event is not an excluded event, system 10 may next determine whether or not the event has a recorded auto-project assignment as shown in 5018. That is, system 10 may determine if it has a record of the document or webpage and the program already in memory and assigned to a specific project. If the answer is yes and the document or webpage is already assigned to a specific project, then system 10 may add the captured data elements to the Categorized calendar within Outlook as shown in 5020 and end the save event. If a Categorized calendar box within Outlook does not currently exist yet for the day, system 10 may create one to add the captured data elements in order to perform and end the save event. Note that the Categorized calendar box is shown at 5042 in FIG. 27.

If the answer is no and the document or webpage and program is not already in memory and assigned to a specific project, system 10 may next determine if there exists a record in the Uncategorized calendar boxes with the same Windows Handle, program and document (node 5022). If the answer is yes and a record exists in the Uncategorized calendar box for the program/website and program combination, then system 10 may add the captured data elements to this existing record or project/matter box (node 5024) and end the save event at node 5036.

If the answer is no and a record does not exist in the Uncategorized calendar box, then system 10 may next determine if the captured elapsed time element is greater than or equal to the capture fence. Note that the capture fence is the minimum amount of time that the captured elapsed time element must be in order to be recorded to the calendar box, and that the capture fence within system 10 may be different than the capture fence within Outlook. If the captured elapsed time element is not greater than or equal to the capture fence as determined in node 5026, system 10 may do nothing with the captured data elements and end the save event at node 5036.

However, if the captured elapsed time element is greater than or equal to the capture fence, system 10 may, in the case of a single uncategorized calendar, create a record in the uncategorized calendar box. However, if the uncategorized calendar has both web and non-web boxes, system 10 may next determine if the event is web related or non-web related as shown in node 5030. If the event is web related, system 10 may create a record in the web box within the Uncategorized calendar and place the captured event data elements within this record as shown in node 5032. And if the event is non-web related, system 10 may create a record in the non-web box within the Uncategorized calendar and place the captured event data elements within this record as shown in node 5034. In either case, system 10 may then end the save event at node 5036.

The captured event data elements, that may be present in the Uncategorized calendar from the above described sequence of actions, may be data elements that system 10 may not have the ability to categorize automatically. For this reason, system 10 may allow the user to categorize and port the event data elements from the Uncategorized calendar into applicable project/matter boxes within the Categorized calendar through the use of system 10 processing tools.

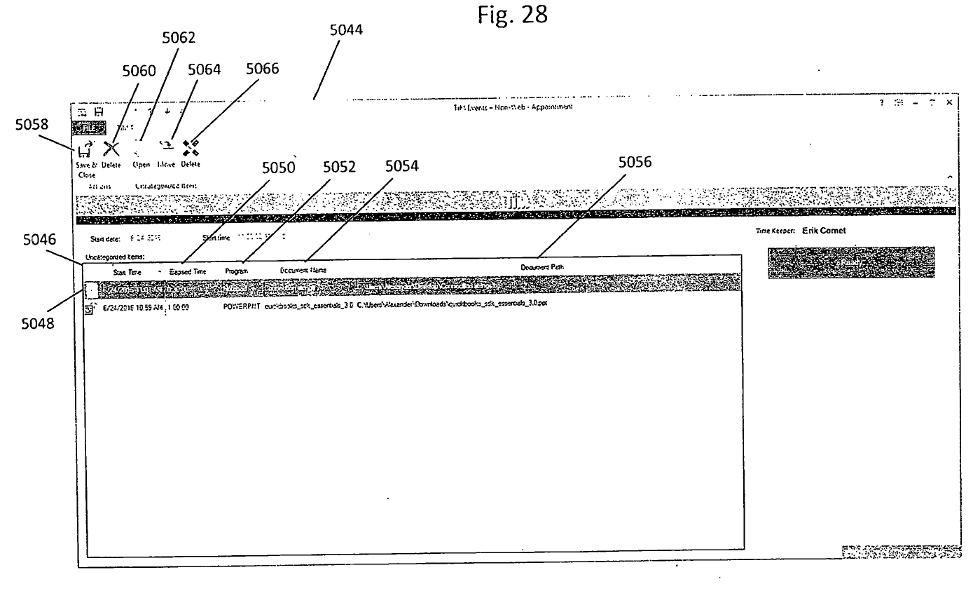

As shown in FIG. 28, system 10 may present to the user an event characterization tool 5044 that may allow the user to categorize the captured event elements that may reside in the Uncharacterized calendar boxes. As shown, tool 5044 may include an event grid 5046 that may display a variety of captured data elements in columns that the user may highlight and edit using tools within the tool 5044. It may be preferred that system 10 present tool 5044 to the user directly after the completion of the save event, or shortly thereafter, so that the event is fresh in the mind of the user such that the user may be able to accurately edit or otherwise characterize the saved data elements for the recent event. However, this may not be required and system 10 may present tool 5044 to the user at any time. Note also that while tool 5044 is displayed to present the various captured data elements in column format, other formats may also be utilized. The data columns within tool 5044 may be but are not limited to the following:

HANDLE: This may display the Windows handle of the program source for the captured event. Note that this column may not be shown but may be used within the logic tree.

PROGRAM ICON: This may display the program icon of the respective program or application from which the data elements were captured. If the icon is not available a generic icon may be displayed instead.

ELAPSED TIME: This may display the total elapsed time for the document or webpage and program for the capture and save events.

PROGRAM: This may display the name of the program used to view, edit, etc. the document or webpage. Examples are Internet Explorer, Notepad, etc.

DOCUMENT: This may display the name of the document or webpage that was opened, edited, etc. by the program. For web applications, this may be the title of the webpage being viewed such as “CNN Breaking News”. For non-web applications, this may be the name of the document such as TiMUniversal.txt.

FILE OR DOCUMENT PATH: This may display the path of the location of the webpage or the document. For webpages, this may be the URL such as http://edition.cnn.com. For non-web applications, this may be the drive path of the location of the document such as C:\OneDrive\TiM\TiM_Universal.docx.

As shown in FIG. 28, these columns may be generally displayed as a grid 5046 in tool 5044, with the ability of each element within the grid to be highlighted and edited by the user. In one embodiment of tool 5044, PROGRAM ICON may be shown at 5048, ELAPSED TIME may be shown at 5050, PROGRAM may be shown at 5052, DOCUMENT may be shown at 5054 and DOCUMENT PATH may be shown at 5056. Other elements not displayed in FIG. 28 may also be included. Note that the order of the columns may be changed and that sorting and filtering of the grid may also be possible by clicking on the grid headers and moving the columns and by clicking on the sort arrows associated with each column respectively.

Tool 5044 may also include a variety of additional tools that the user can use to edit and otherwise characterized the displayed captured data elements as desired. These tools may be represented by clickable tool icon buttons within tool 5044, may be displayed from within a toolbar or may be generally accessible using other means. For example, as shown in FIG. 28, tool 5044 may include SAVE AND CLOSE button 5058, DELETE (ACTIONS) button 5060, OPEN button 5062, MOVE button 5064, and DELETE (EVENTS) button 5066.

To employ the functionality of these buttons to specific data elements, the user may highlight a particular data element within grid 5046 and may then choose and click the desired tool icon tool button to then apply that tool to the highlighted element. Note that the user may select and highlight more than one data element at a time by holding down the SHIFT key while clicking on the different data elements of choice. The functionality of tools 5058, 5060, 5062, 5064 and 5066 are described below:

SAVE AND CLOSE button 5058: Clicking this button saves any changes made to the system 10 Uncategorized project/matter boxes 5038, 5040 and closes the window.

DELETE (ACTIONS) button 5060: Clicking this button will delete the entire matter/project boxes 5038, 5040. Upon the user clicking on this DELETE tool 5060, tool 5044 may display a warning to the user that this action will delete the entire matter/project box, and the warning dialog box may require to user to click a YES or NO button to confirm the deletion.

OPEN button 5062: Clicking this button opens the document or webpage associated with the selected event.

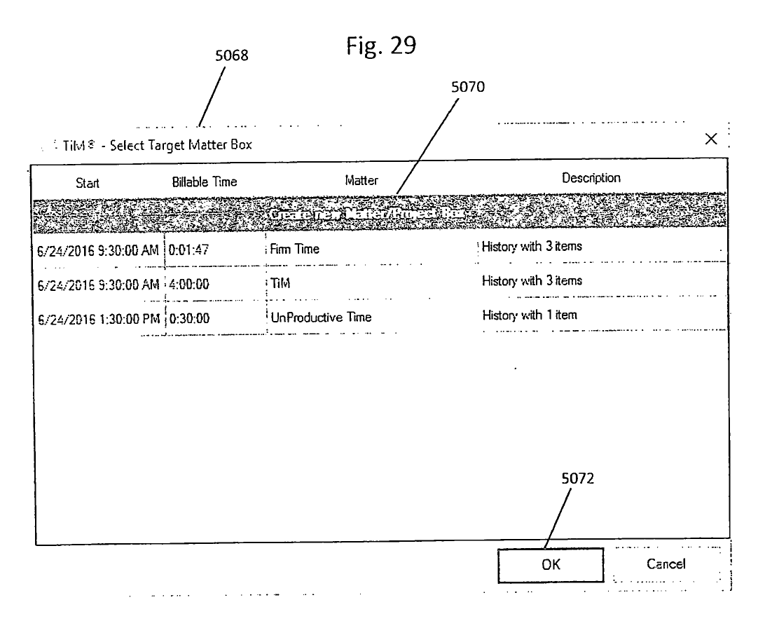

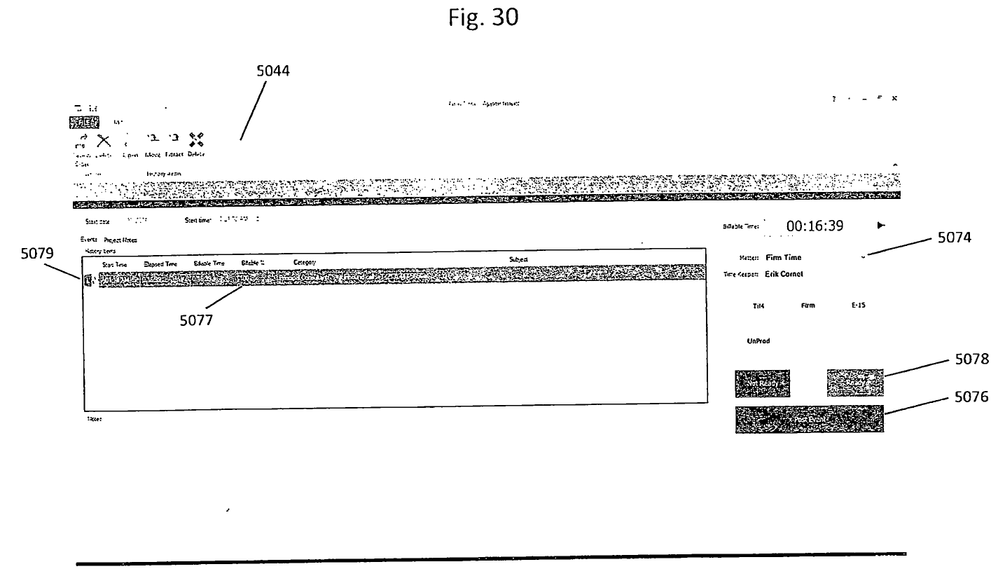

MOVE button 5064: Clicking this button moves the selected event(s) to an existing categorized project/matter box or allows the user to create a new categorized project/matter box within the Categorized calendar of system 10. Upon selecting an event(s) and clicking the MOVE tool button 5064, the dialog box 5068 shown in FIG. 29 may appear. Interacting with dialog 5068, the user may either choose an existing available project/matter box from the list or may create a new matter/project box by clicking on the CREATE NEW MATTER/PROJECT BOX button 5070. If the user chooses an existing project/matter box available from the list and then clicks the OK button 5072, tool 5044 may be displayed showing the new matter/project box location of the selected event(s) in field 5074 as shown in FIG. 30. At this point, the user can click on the POST EVENT button 5076 to complete the move sequence, close tool 5044 and enter into the post event sequence.

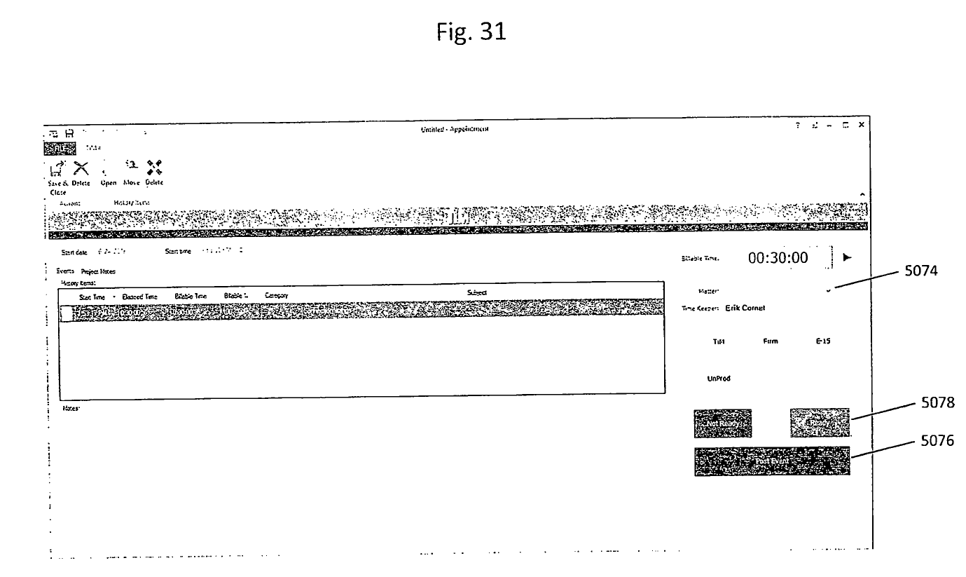

If the user clicks the CREATE NEW MATTER/PROJECT BOX button 5070 then a new project/matter box within the Categorized calendar may be created and tool 5044 may be displayed as shown in FIG. 31. The user may then click the READY button 5078 to create and name the new project/matter box in the Categorized calendar in system 10 but note that the project/matter location field 5074 may be blank in this circumstance. Accordingly, the user may need to choose a new matter/project location from the drop-down menu for the matter/project. Once this is completed, the user may click the POST EVENT button 5076 to complete the move sequence, close tool 5044 and enter into the post event sequence. Note that clicking the POST EVENT button 5076 may not allow the user to enter into the post event sequence if the matter/project location field remains blank.

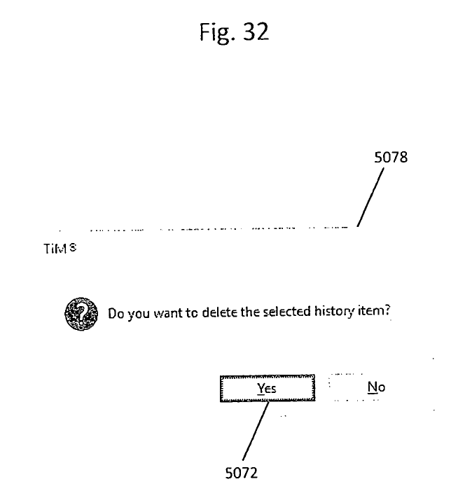

DELETE (EVENTS) button 5066: Clicking this button deletes the selected items(s) from the uncategorized project/matter box. Upon selecting an event(s) and clicking the DELETE tool button 5066, the dialog box 5078 shown in FIG. 32 may appear. This dialog box may require the user to confirm that they wish to delete the selected items by clicking the YES button 5080. This may act as a failsafe against the possibility of inadvertently deleting events that the user does not wish to delete as deleted items may not be recoverable.

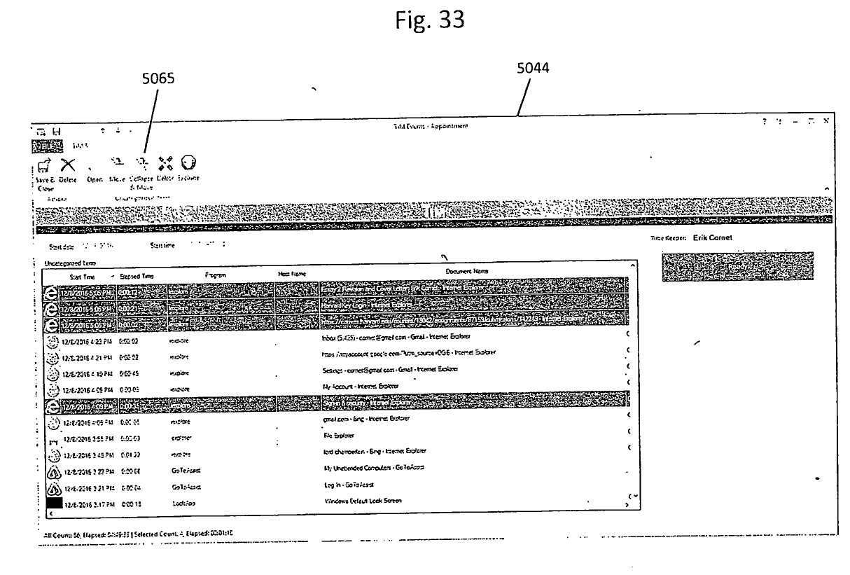

In another embodiment of tool 5044 as depicted in FIG. 33, tool 5044 may also include COLLAPSE AND MOVE tool button 5065. Remember that the daily uncharacterized project/matter box within system 10 may contain events captured by system 10 that may not yet be characterized. Tool 5065 may allow for some or all of these events to be consolidated and combined into one event within the main time calendar of system 10. In one example of this as shown in FIG. 34, system 10 uncharacterized event calendar may include matter/project box 5041. Upon opening matter/project box 5041, dialog 5044 as depicted in FIG. 34 may appear and display the various events contained within matter/project box 5041. At this point, the user may select the events that he/she may wish to consolidate together to be combined into a single event with the main time calendar. In this example, the user may highlight events 1-3 and 8 (shaded) and may click the COLLAPSE AND MOVE button 5065.

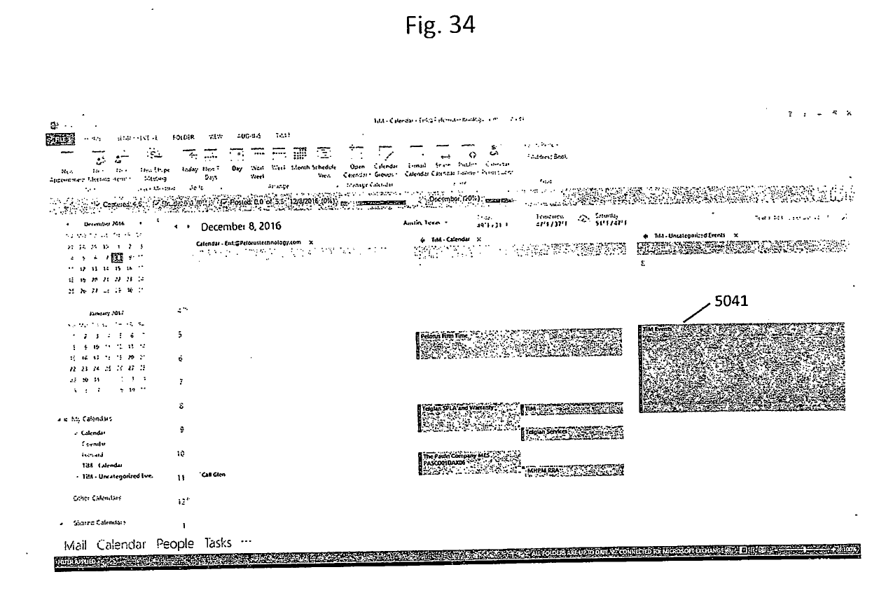

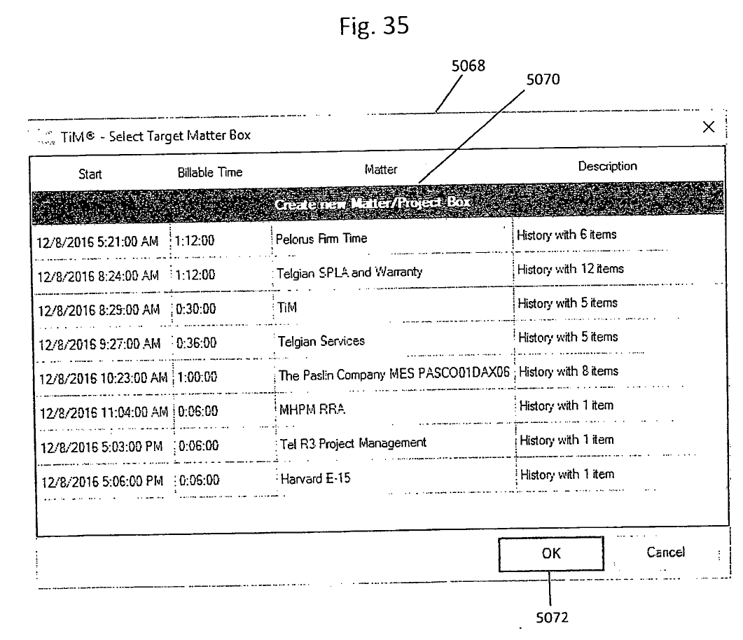

Dialog 5068 may next appear as depicted in FIG. 35 displaying the various existing project/matter boxes within the main time calendar of system 10 that the newly consolidated events may be combined into. The user may next select an existing project/matter from the list or click the Create New Matter/Project Box 5070 to create a new project/matter within the main time calendar of system 10 to add the newly consolidated events into. To finish the process, the user may then click OKAY button 5072 and the selected events may be consolidated and moved into the selected or newly created matter/project box in the main time calendar.

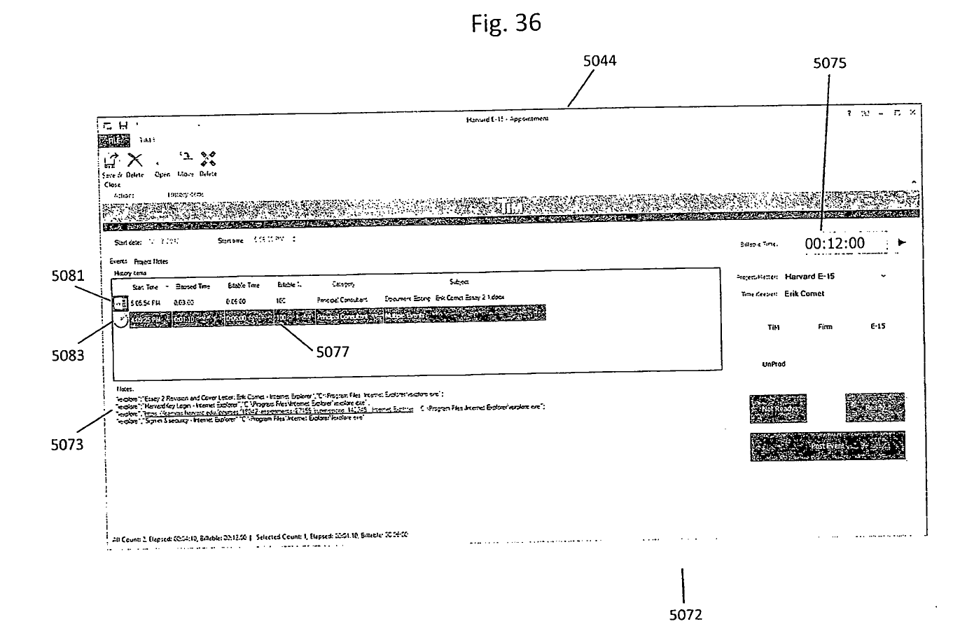

FIG. 36 depicts dialog 5044 that displays for this example the project/matter box in the main time calendar that may now contain the consolidated events from project/matter 5041. The notes section 5073 in dialog 5044 may display the details of the consolidated events. In addition, the captured time associated with the consolidated events may be added to the originally captured time of the chosen or newly created project/matter to create a new total time captured for the project/matter as shown in field 5075.

Referring to FIGS. 30 and 36, dialog 5044 may list the various events that may be contained within a particular project/matter after the MOVE functionality 5064 or MOVE AND CONSOLIDATE 5065 functionality has been implemented. For example, the events in the dialog 5044 of FIG. 30 may contain moved event 5079 and the events in the in dialog 5044 of FIG. 36 may contain consolidated and moved events 5081 and 5083. In these embodiments of tool 5044, billable % field 5077 may be an editable field. Note that this field may be editable in other embodiments of tool 5044 as well. The billable % field 5077 determines the percentage of captured time for each event that will be allocated as billable time when the event is posted to the backend/cloud platform of system 10. For instance, the default value of the billable % field 5077 is 100 such that if this setting is left at default when the event is posted then 100% of the captured time will allocated as billable time. However if the user edits billable % field 5077 to be 75 instead, then 75% of the captured time will be allocated as billable time when the event is posted. Note that billable % field 5077 can be set to any value between 1 and 100 and that the resulting billable time is adjusted using the billable % variable when the event is posted to the backend platform of system 10.

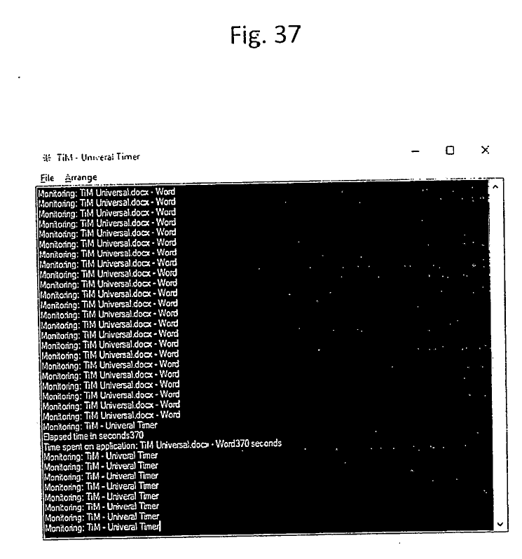

In addition to the functionality of tool 5044 as described above, the user may right-click on tool 5044 in Microsoft applications and choose MONITOR to display the pop-up monitor readout as shown in FIG. 37. This readout may display the programs, applications, software and other items that system 10 may be monitoring in real time.

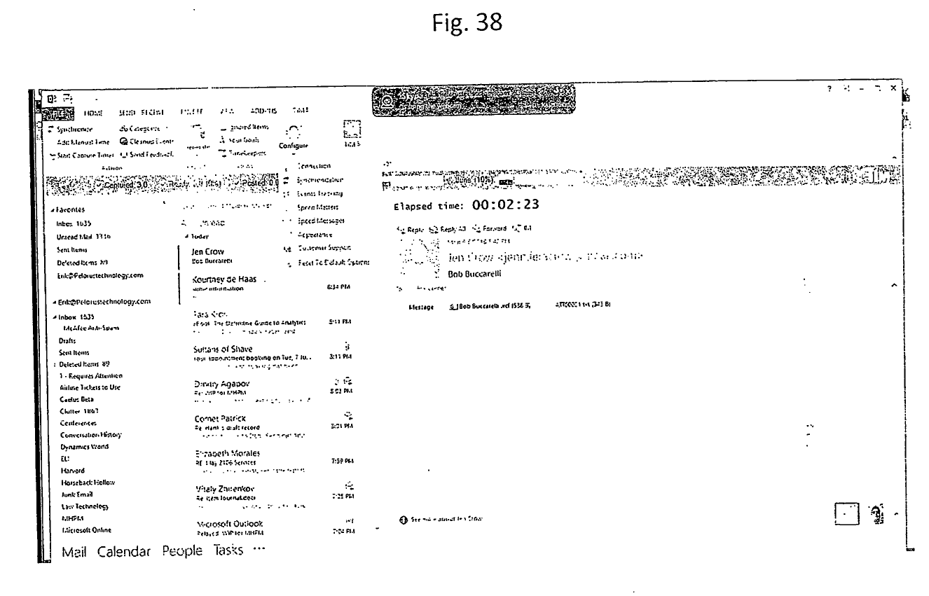

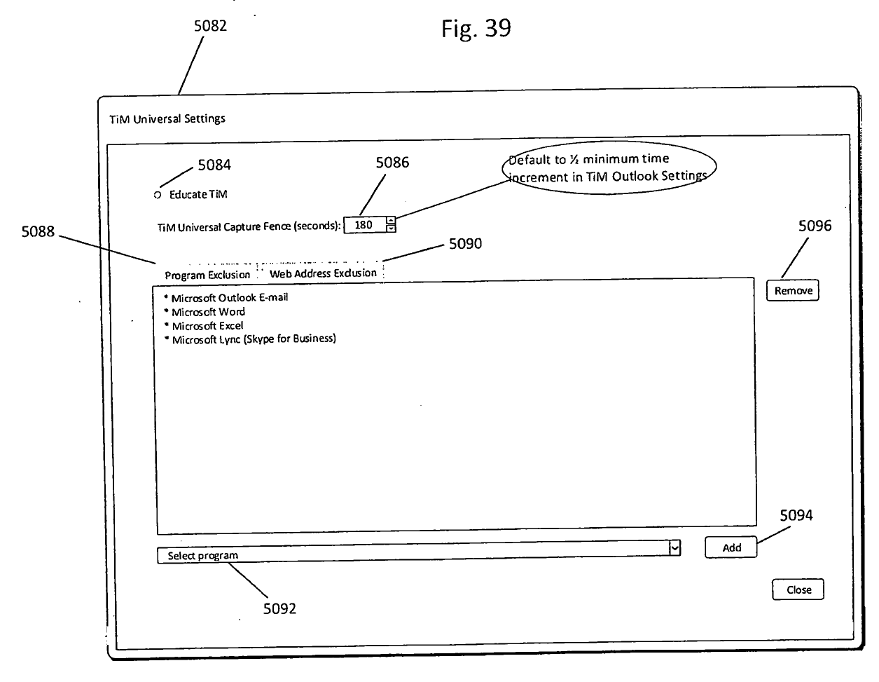

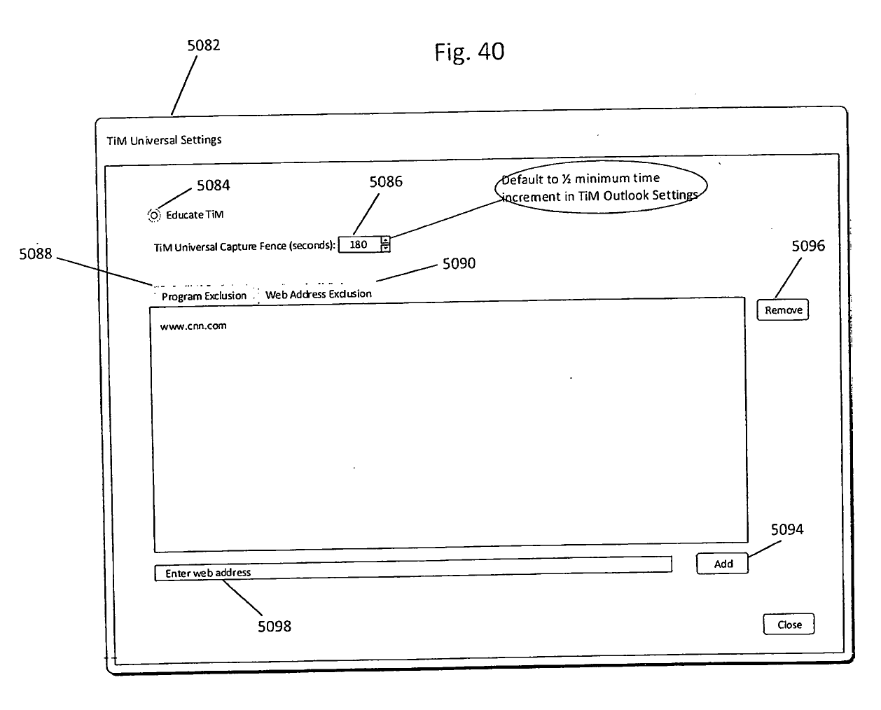

System 10 may also include a settings dialog that may be launched from the tool bar within Microsoft Outlook in the system 10 ribbon in the configure menu as shown in FIG. 38. Once launched, system 10 may display the settings dialog 5082 as shown in FIGS. 39 and 40. Within the settings dialog 5082, the user may configure a variety of settings that system 10 may use to control and configure its operation and performance. Below is a list of possible settings that may be included:

EDUCATE: Turning on this the educate setting 5084 may instruct system 10 to record the user's project/matter assignments implemented using the MOVES tool button 5064 as described above, and to use these same selections the next time system 10 encounters the same program or webpage URL in the future. This function may be turned on by default.

CAPTURE FENCE: The capture fence setting 5086 is the minimum amount of time that the captured elapsed time element must be in order to be recorded and placed into a matter/project box in the system 10 Uncategorized calendar, Categorized calendar or other types of calendars within system 10. The time units may be in seconds, minutes or in other units.

PROGRAM EXCLUSION: The programs listed in the program exclusion tab 5088 shown in FIG. 39 may be excluded from being monitored with the intent to place captured data elements in the Uncategorized calendar. The user may add and remove programs using the ADD and REMOVE buttons respectively. To add a program or application to the exclusion list, the user may use the Select Program drop-down menu 5092 to select the desired program to add to the list and then click ADD button 5094. The Select Program drop-down menu 5092 may list all the programs or applications installed on the host computer. To remove a program or application from the list, the user may select a program or application from within the list by clicking on it and then clicking REMOVE button 5096. Note that this tab may include preloaded programs and applications that are excluded by default by system 10 and that may not be removed from the exclusion list. These programs and applications may include programs such as email, Microsoft Word, Microsoft Excel, Microsoft Lync, Microsoft PowerPoint, Microsoft Visio, Microsoft Visual Studio and other programs and applications that may have pre-existing event monitors.

WEB ADDRESS EXCLUSION: The web addresses or URLs listed in the program exclusion tab 5088 shown in FIG. 40 are excluded from being monitored with the intent to place captured data elements in the Uncategorized calendar. The user can add a web addresses to the exclusion list by typing the web address or URL directly into the Enter Web Address text box 5098 and clicking ADD button 5094. To remove a web address from the exclusion list, the user may select a web address from within the list by clicking on it and then clicking REMOVE button 5096.

System 10 may include a setup program that loads and generally sets up system 10 onto the user's computer using default settings. The setup program may set up all the various programs, applications, modules, objects, routines, subroutines, variables, files, images and other components of system 10 that may be necessary to run system 10. Note that some of the components may or may not be loaded upon the setup program detecting the existence or the nonexistence of specific programs or applications already loaded onto the host computer.

In another embodiment, system 10 may provide functionality for the user to designate or generally categorize a time event in a number of different ways. For example, a user may be able to categorize a time event as 1) an event that should not be tracked for this specific instance of the event but should be tracked beginning again on the next instance or 2) an event that should not be tracked for this instance of the event or for any future instance of the event. The various types of events that these types of categorizations may apply may include but are not limited to a specific portion of an email thread, and email address, a document, a phone call or other types of events.

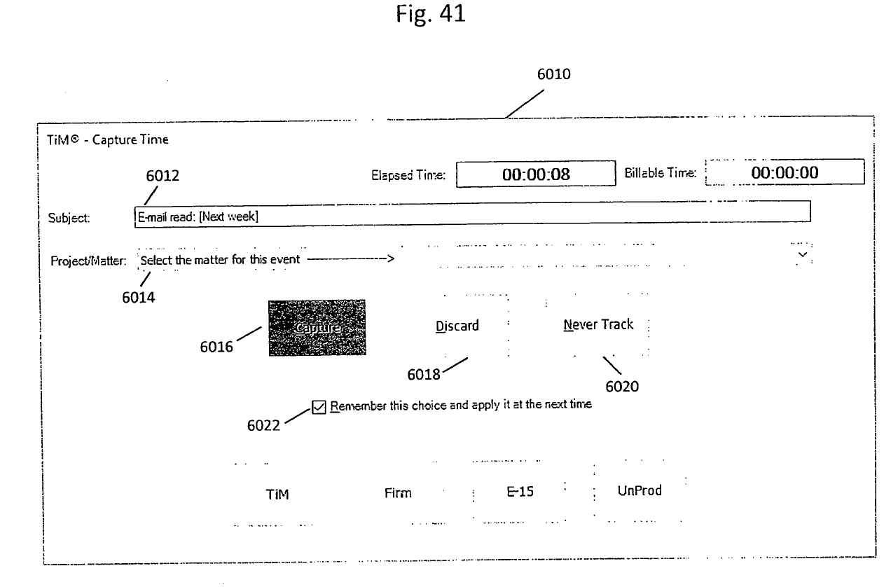

Referring now to FIG. 41, at the end of an event, system 10 may present the capture dialog 6010 to the user. Capture dialog 6010 may include a subject field 6012 that may be prefilled with the existing subject title of email thread, email address, document or phone call. However, this field 6012 may be editable such that the user may change the subject name of event as desired. In addition, capture dialog 6010 may also include a project/matter dropdown menu 6014 that when clicked may present all the available project/matter listings that the user may choose from to categorize the new event. Upon choosing a listed project/matter, the dropdown menu 6014 will display the chosen project/matter in the field. At this point, if the user desires to save the new time event, he/she may click the capture button 6016 and the new event will be saved to the system 10 calendar with the subject title and project/matter information entered. The capture dialog 6010 may disappear and the new event 6008 may appear in the system 10 calendar as a blue event (not shown). Being a blue captured event of system 10, the event may then be modified in the usual way as described in the above sections.

However, if the user does not wish to save the new time event, he/she may click the discard button 6018 and the capture sequence will be terminated without saving the new event. It is important to note the “Remember this choice and apply it at the next time” checkbox 6022 in the dialog 6010. If the user wishes to discard only the current instance of the event, that is, not have it tracked, but wishes to track future instances of the event, the user may click the Discard button 6018 but not check the “Remember this choice and apply it at the next time” checkbox 6022. That way, the current instance will be discarded but the system 10 will not be told to apply this choice to future instances of the event such that future instances may be tracked.

However, if the user desires to not or never track the new time event, he/she may have two sequence options that will achieve this outcome. The first option is for the user to simply click the Never Track button 6020. This will cause the current instance of the event to not be tracked, and will also cause future instances of the event to also not be tracked. The second option is to check the “Remember this choice and apply it at the next time” checkbox 6022 and click Discard button 6018. This will discard the time event and tell the system 10 to discard any future instances of this event as well. It is important to note that the user may reverse any of these settings at any time by interfacing with the appropriate dialogs or administrative control panels and applying the applicable settings.

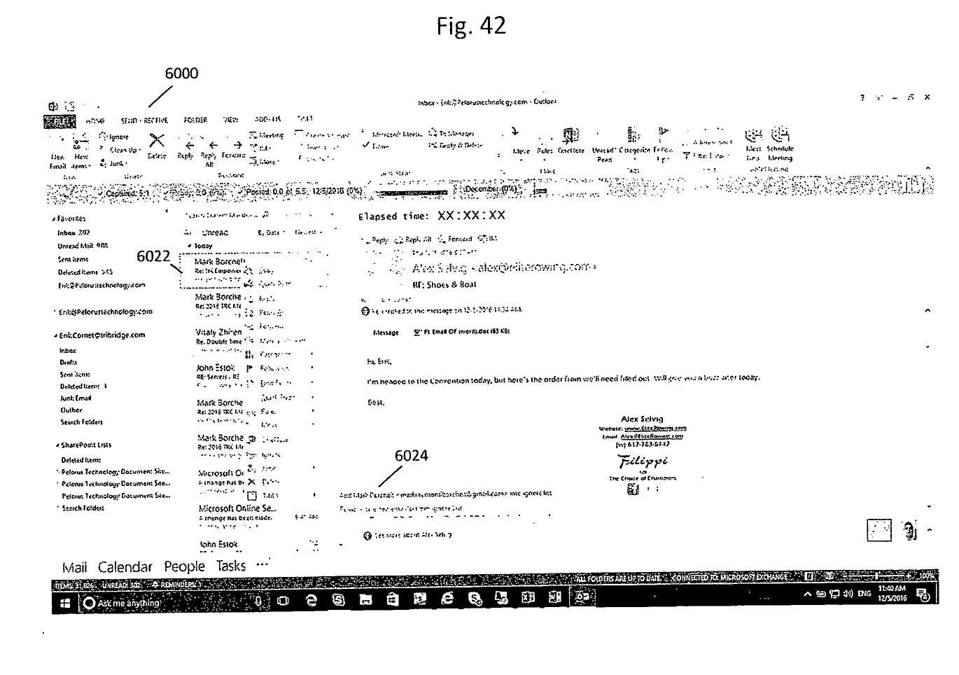

In the case of removing a specific email address from being tracked, system 10 may provide the functionality for the user to place the email address in an “ignore email address” list such that any email messages received from, read, forwarded or otherwise interacted with from the email address will be ignored and not tracked. To add the email address to this list, the user may open Microsoft Outlook 6000 configured with system 10 as shown in FIG. 42 and right mouse click on the email address desired, for example email address 6022. This will cause the system to display a list of functions or operations that may be performed from which the user may select “TiM->Add [email address] into ignore list” and release the mouse button. This will add the email to the ignore email list. To reverse this setting so that the email address may once again be tracked by system 10, the user may again right mouse click on the email address and choose “TiM->Remove selected email from ignore list” and release the mouse button.

In another embodiment, system 10 may allow the user to drag and drop events from one calendar to another. This functionality may greatly improve the ease and user experience of adding and defining new time entries, events and other types of information to the various calendars within system 10.

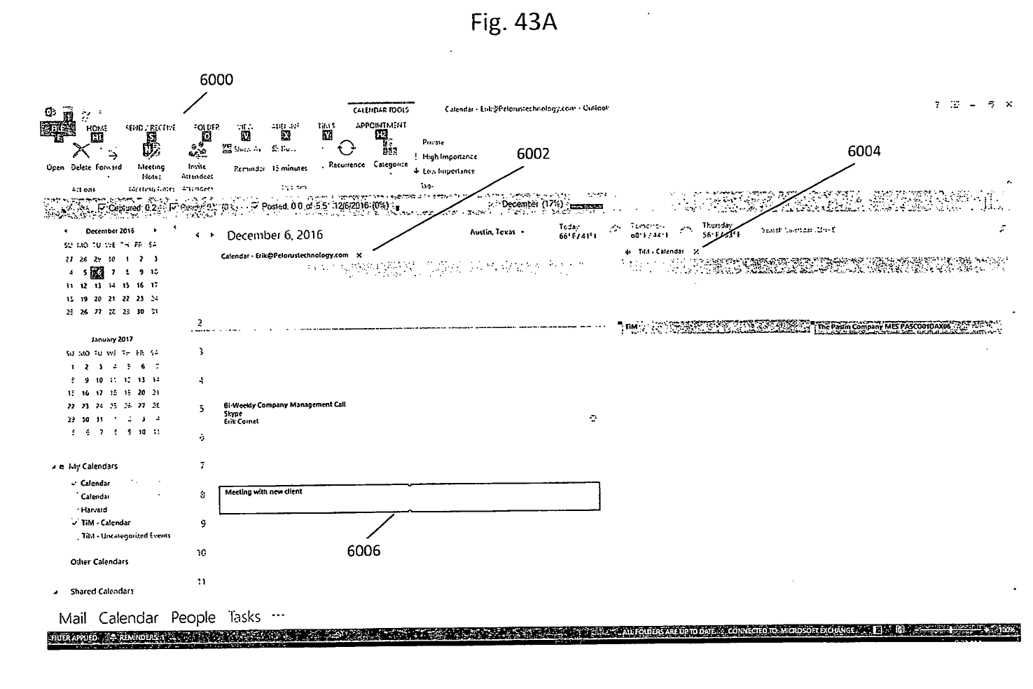

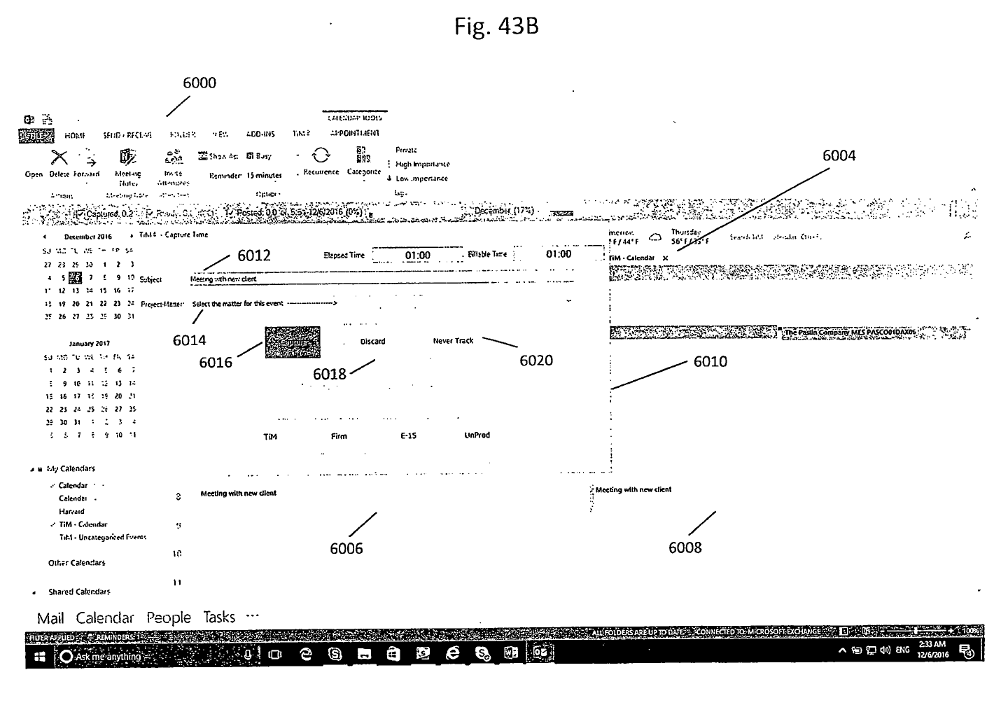

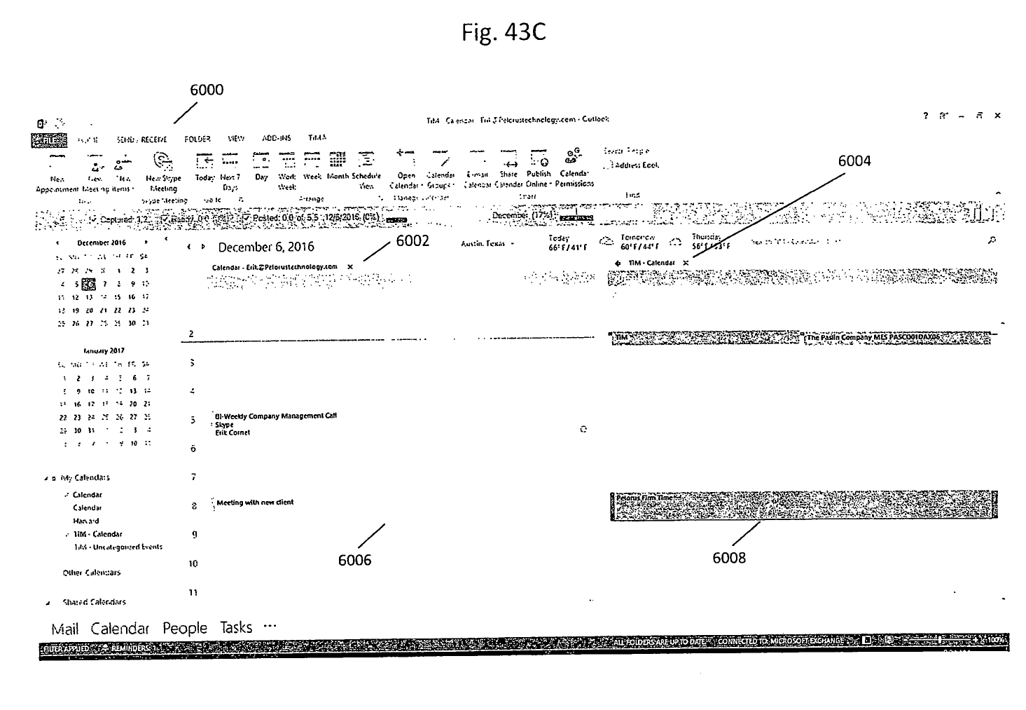

In one example of this, system 10 may have the functionality to allow the user to drag and drop an event from a standard planning calendar to the system 10 time usage calendar. Note that the standard planning calendar and the system 10 time calendar may both reside in a local program such as Microsoft Outlook that may run on the users' local computer and interface with system 10 as described in earlier sections. Example user workflow steps for this example will now be given with reference to FIGS. 43A, 43B and 43C.

FIG. 43A depicts a screenshot from a calendar program 6000 such as Microsoft Outlook that may have local system 10 components installed in order to interface with system 10 as described above. Within program 6000, standard planning calendars 6002 may be displayed that may allow the user to enter scheduled events such as meetings, phone calls, appointments and other types of events that the user may want to store within the calendar for reference. One example event may be a “Meeting with new client” as shown in calendar box 6006. In addition, program 6000 may also display the system 10 calendar 6004 as shown. If the user would like to move an event already entered into, defined and displayed within the planning calendar 6002, for example event 6006, the user may use his/her mouse to click and hold the event 6006 box, and then to drag the event box 6006 to place it in the desired time slot within the system 10 calendar 6004. Upon doing this, a new green time entry 6008 may be created in the system 10 calendar 6004 matching the dragged calendar event 6006 as shown in FIG. 43B. At the same time, a system 10 capture dialog 6010 may appear to allow the user to capture the new time entry 6008 and categorize it with a matter or project.

Capture dialog 6010 may include a subject field 6012 that may be prefilled with the subject title that was entered for event 6006. However, this field 6012 may be editable such that the user may change the subject name of new time entry 6008 as desired. In addition, capture dialog 6010 may also include a project/matter dropdown menu 6014 that when clicked may present all the available project/matter listings that the user may choose from to categorize the new event 6006. Upon choosing a listed project/matter, the dropdown menu 6014 will display the chosen project/matter in the field. At this point, if the user desires to save the new time event 6008, he/she may click the capture button 6016 and the new event 6008 will be saved to the system 10 calendar 6004 with the subject title and project/matter information entered into capture dialog 6010. The capture dialog 6010 may disappear and the new event 6008 may appear in the system 10 calendar as a blue event as shown in FIG. 43C. Being a blue captured event 6008 of system 10, the event may then be modified in the manner as described in the above sections.

However, if the user does not wish to save the new time event 6008, he/she may click the discard button 6018 and the capture sequence will be terminated without saving the new time event 6008, the green time event 6008 box in the system 10 calendar 6004 may disappear and the capture dialog 6010 may terminate. If the user desires to never track the new time event 6008, he/she may click the Never Track button 6020 which will categorize that new time event 6008 as an event that may not be tracked. The user may also check the “Remember this choice and apply it at the next time” checkbox 6022 and click Discard button 6018 to achieve the same outcome. At this point, capture dialog 6010 may terminate.

Because system 10 may be configured to interface with a multitude of different programs and devices, such as different programs running on local computers, Android mobile phones, iPhone mobile phones, backend systems and other types of programs and devices, captured time usage from different programs and/or devices may overlap. For example, a user may be reading an email on his/her local computer while system 10 tracks the time spent on the email through local Microsoft Office and Windows component 202 and the user's Android Phone may ring from the client associated with the same project/matter. At this point, the user may answer the phone and the Android Phone component 210 configured with the user's Android Phone may begin tracking the time spent on the phone call while at the same time Microsoft Office and Windows component 202 may continue to track time spent on the email since the email window is still active on the user's computer. In this example, if the phone call lasts a few minutes and the user then turns his/her attention back to the email for the duration of the time event, it can be seen that the Android Phone time event may be contained within the email time event. In this case, the two time events may overlap, and this overlapping may or may not cause time usage and/or billing errors within system 10.

In order to prevent errors that may occur due to the possibility of overlapping time events, system 10 may be configured with functionality to bring any overlapping time events to the attention of the user so that the user may make the proper decision on how to rectify the situation. System 10 may also include the tools necessary to allow the user to make their decision more effectively and to best rectify the issue.

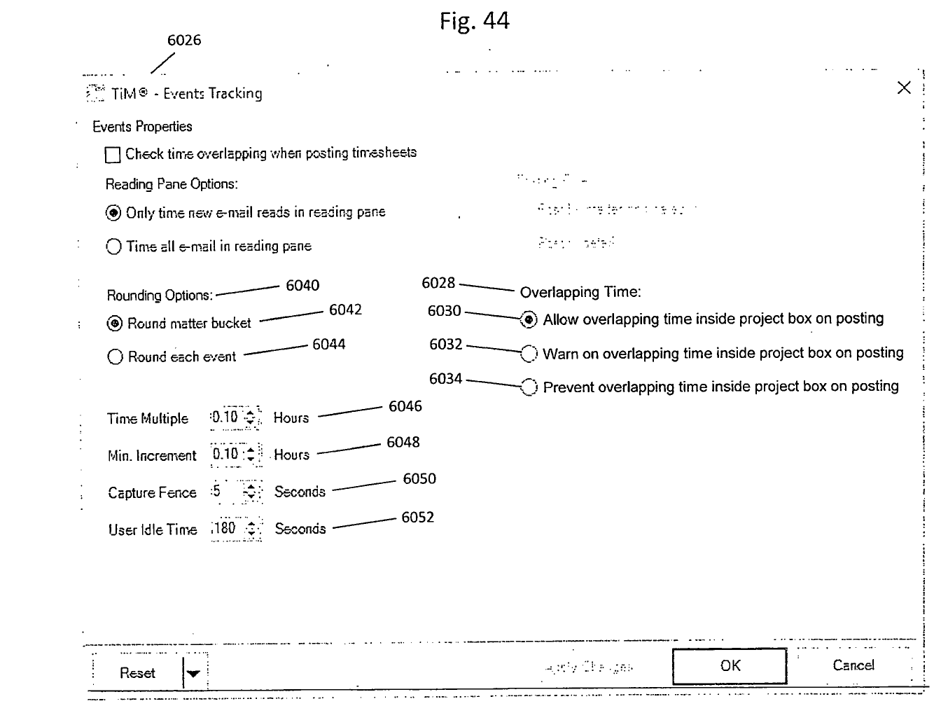

For example, as depicted in FIG. 44, system 10 may include an Events Tracking dialog 6026 that may allow the user to set a variety of settings associated with the time event. Pertinent to this example, events tracking dialog 6026 may include an Overlapping Time section 6028 that may include a number of radio buttons such as 1) “Allow overlapping time inside project box on posting” 6030, 2) “Warn on overlapping time inside project box on posting” 6032, and 3) “Prevent overlapping time inside project box on posting” 6034. Note that with radio buttons, only one choice may be chosen active and enabled. The functionality of these particular radio buttons is described below:

ALLOW OVERLAPPING TIME INSIDE PROJECT BOX ON POSTING 6030: With this radio button chosen and enabled, system 10 allows the overlapping events to be posted per the standard operation of system 10.

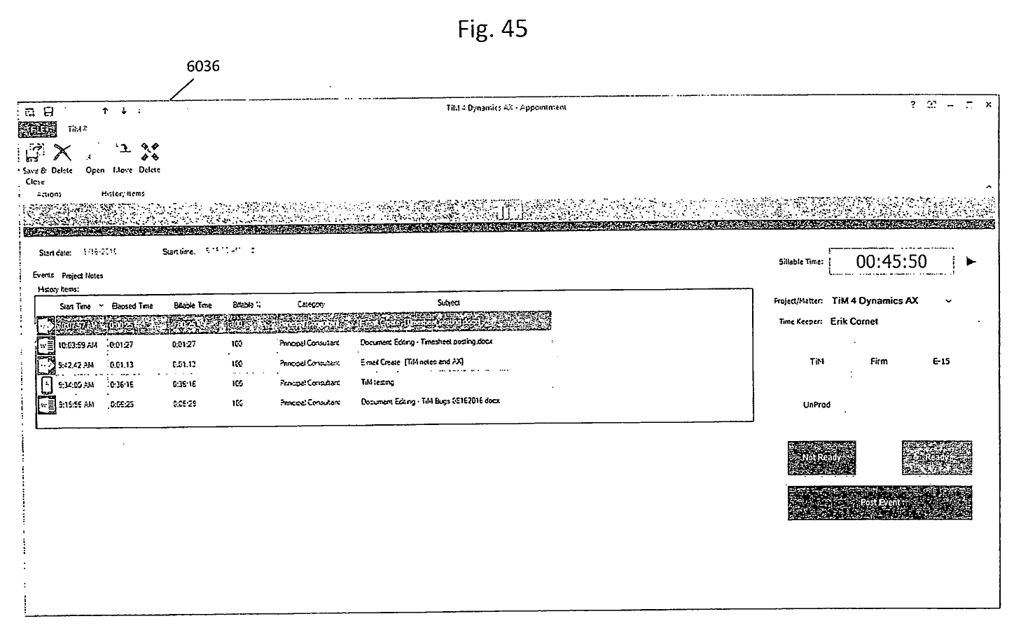

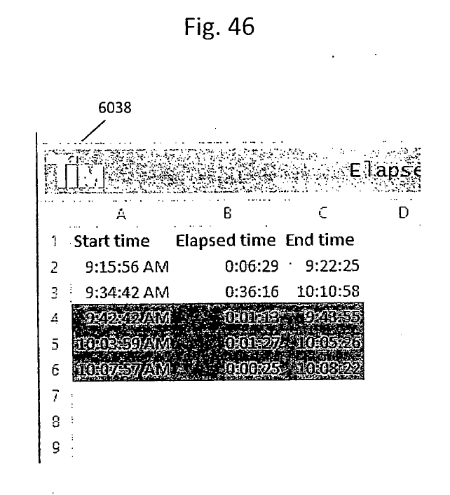

WARN ON OVERLAPPING TIME INSIDE PROJECT BOX ON POSTING 6032: With this radio button chosen and active, system 10 may analyze the time events within the current events characterization tool 5044 as depicted in FIG. 45. For each time event, system 10 may determine the start time and elapsed time to identify any possible overlapping between the various events. Then, as shown in FIG. 46, system 10 may sort the events in ascending order by start time and display the event list in dialog 6038.

System 10 may also calculate and display the end time (defined by start time plus elapsed time) to assist the user in better understanding the duration of the events. For any events that seem to be overlapping, system 10 may display these events with a red background to identify them to the user as shown. In addition, dialog 6038 may display a warning message/question (not shown) such as “There are events in this project box with overlapping times. Post anyway?” in addition to YES/NO buttons (not shown).

The user may then view the information for each overlapping event and decide what to do. If the user decides to proceed with the posting of the events as they stand, he/she may press the YES button and the posting will occur in the standard fashion. However, if the user decides not to post the overlapping events as they stand, he/she may press the NO button. If this happens, the backgrounds on the overlapping events may remain red and the start time may become an editable field.

The user may then edit the start time of any of the overlapping events so that they may no longer overlap. Then, on a subsequent posting, if the event lines are no longer overlapping because of any edits the user may have made, the backgrounds will no longer be red and the system will no longer flag the event as overlapping. In this case, the postings may then happen in a normal fashion. If however, upon a subsequent posting, any of the events are still overlapping, the system will flag the events as described above and the work flow will repeat for the overlapping events.

PREVENT OVERLAPPING TIME INSIDE PROJECT BOX ON POSTING 6034: With this radio button chosen and active, system 10 may analyze the time events within the current events characterization tool 5044 as described above, may determine the start time and elapsed time to identify any possible overlapping between the various events, may sort the events in ascending order by start time and display the event list in dialog 6038, may calculate and display the end time (defined by start time plus elapsed time), and may display these events with a red background to identify them to the user as shown in FIG. 46.

However, in this situation system 10 may not allow the user to make a choice of whether to post the overlapping events as they stand, but may instead require the user to edit the overlapping events such that they no longer overlap. At the same time, system 10 may display a warning message (not shown) such as “There are events in this project box with overlapping time highlighted in red. Posting is not allowed. Correct the event items and re-post.” The only option for the user is to press the OKAY button and proceed with editing the overlapping events so that they may no longer overlap.

Then, on a subsequent posting, if the event lines are no longer overlapping because of any edits the user may have made, the backgrounds will no longer be red and the system will no longer flag the event as overlapping. In this case, the postings may then happen in a normal fashion. If however, upon a subsequent posting, any of the events are still overlapping, the system will flag the events as described above and the work flow will repeat for the overlapping events. This color cue provides a significant physical attribute of the current invention.

Still referring to FIG. 44, Events Tracking dialog 6026 that may contain setting tools and fields that may allow the user to set a variety of other settings associated with the time event. For example, dialog 6026 may include Rounding Options section 6040 with Round matter bucket 6042 radio button and Round each event 6044 radio button. Note that with radio buttons, only one radio button of a particular set of radio buttons may be chosen and enabled.

If Round matter bucket 6042 radio button is chosen and enabled, then system 10 will round the total sum of the time associated with any project/matter to the nearest time multiple set in Time Multiple field 6046. For the example shown in FIG. 44, with Round matter bucket 6042 enabled and Time Multiple field 6046 set to 0.10 hours, system 10 may add up all the time associated with each project/matter and then round the sum of this time to the nearest 0.10 hours.

However, if Round each event 6044 radio button was instead chosen and enabled, system 10 may round the total time of each event to the nearest time multiple set in Time Multiple field 6046. In this case, each event will be first rounded to the time multiple and then the rounded events will be added together for the total. Note that the Min. Increment field 6048 sets the minimum time increment that may be set in the Time Multiple field 6046 (in this example 0.10 hours).

Another event setting that may be set in dialog 6026 may be the capture fence setting 6050. As noted previously, the capture fence setting 6050 is the minimum amount of time that the captured elapsed time element must be in order for the event to be recorded and placed into a matter/project box in a calendar of system 10. This is the minimum amount of time a user must spend on an event such as email, a document, a phone call, a webpage, or other types of programs, applications, or events. The time units may be in seconds or in other units.

In addition, another setting that can be controlled and adjusted through the use of dialog 6026 may be the User Idle Time setting 6052. The User Idle setting 6052 is the amount of time that system 10 may allow the system to continue to track time to the current event while sitting idle without user interaction. That is, if the user does not interact with the computer, backend, iPhone, Android device, or other system 10 enabled device, for example by touching the mouse, the keyboard, the screen or other control component of the device, the system 10 may pause the time tracking of the event. This ensures that the tracked time does not include time during which the user was distracted or otherwise not focused on the event at hand. In the example depicted in FIG. 44, it can be seen that the User Idle Time is set to 180 second or three minutes.

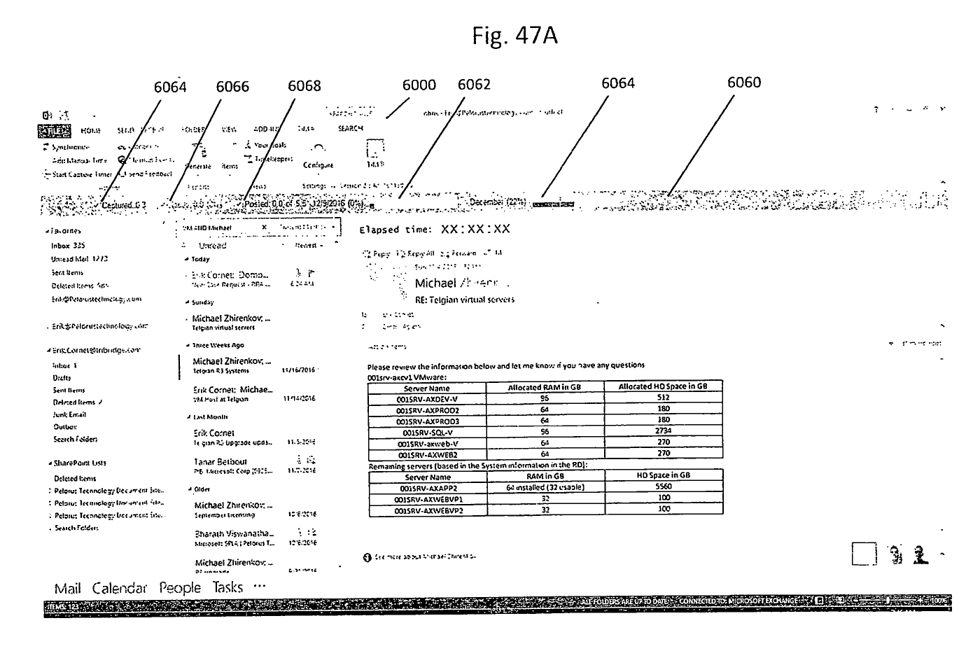

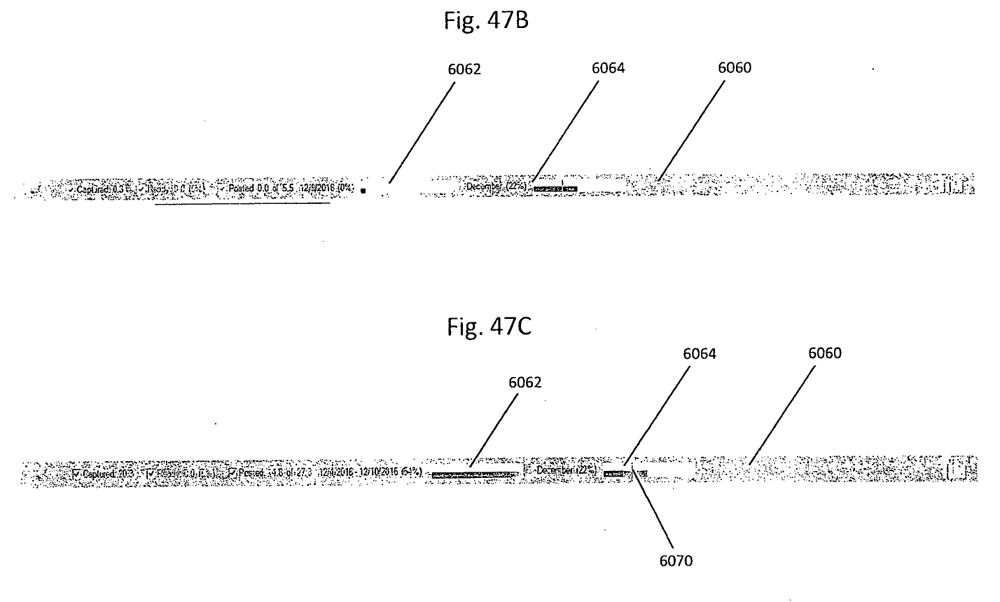

In another embodiment of system 10 as depicted in FIG. 47A, system 10 may provide a status bar 6060 to Microsoft Outlook 6000 when system 10 is configured to interface with Outlook 600 as described in above sections. Status bar 6060 may include a variety of information including graphical representations of usage metrics such as captured time, ready time and posted time goals for the day, week, month, etc. In one example, status bar 6060 may include left progress bar 6062, right progress bar 6064, captured time checkbox 6066, ready time checkbox 6068 and posted time checkbox 6070.

Checkboxes 6064, 6066 and 6068 may be checked or unchecked to dictate what information may be displayed in progress bars 6062 and 6064. For example, if captured time checkbox 6066 is checked, progress bars 6062 and 6064 may graphically display the percentage of time to goal that has been accomplished for captured time. Similarly, if ready time checkbox 6068 and posted time checkbox 6070 have been checked, progress bars 6062 and 6064 may graphically display the percentage of time to goal that has been accomplished for ready time and posted time as well. If any of the checkboxes are unchecked, progress bars 6062, 6064 may not graphically display bars representing those types of time metrics.

In addition, left progress bar 6062 may graphically represent percentages of time metric goals achieved for the day, week, month or other time frames selected, while right progress bar 6064 may graphically represent percentages of time metric goals achieved for the month. Other time intervals for either bar 6062, 6064 may also be used.

Progress bars 6062, 6064 may be linear representations of the percentage of the goals accomplished for each metric selected. That is, the visible portion of the bar displayed within each progress bar 6062, 6064 in comparison with the total length of the progress bar 6062, 6064 may represent the percentage of the goal completed. For example, if the visible bar is halfway across the full length of the bar chart, then 50% of the goal has been achieved. Other types of graphical charts may also be used such as pie charts and other types of charts.

Also, the time metrics may be color coded to differentiate the metrics within progress bars 6062 and 6064, and as shown in FIG. 47A, captured time checkbox 6066 may be blue, ready time checkbox 6068 may be orange and posted time checkbox 6070 may be green. Other colors may also be used. Correspondingly, graphical bars within each progress bar 6062 and 6064 for each selected time metric may have matching color schemes to identity each metric within the bars 6062, 6064. For the example shown in FIG. 47A, right progress bar 6064 may display a combination of a green bar representing the posted time metric and a blue bar representing the captured time metric. The linear length of each colored bar may represent the percentage completed for the goals associated with each time metric.

FIGS. 47B and 47C depict additional examples of this. In the example of FIG. 47B, the captured time goal may be 5.5 hours for the day of 12/9/16 and a total of 0.3 hours may have been captured thus far for the day. Therefore, the blue bar within progress bar 6062 may graphically represent a total of 0.3 hours achieved towards a total goal of 5.5 hours of captured time. Note that the bar may be blue which may represent captured time. In the example of FIG. 47C, the goal for the week may be 27.3 hours of posted time while the actual amount posted time may be 14.8 hours. This is graphically represented in progress bar 6062 by the green bar. Note that the captured time of 20.3 hours may also be represented in the progress bay by the blue bar. The progress bar 6062 may show that the goal may have been achieved if all the captured time in blue is posted in addition to the existing posted green time.

Progress bar 6064 may also include a daily goal indicator line 6070 that indicates where the user may need to be with posted green time by the end of the current day in order to achieve the monthly goal. This daily goal indicator line 6070 may reset to a new position to the right each night such that it may lead the user each day with a new daily goal. As shown in FIG. 47C, indicator line 6070 may be shown in the right progress bar 6064 slightly to the right of the right end of the blue portion of the bar. This shows that the user may need to capture more time that day to thereby move the blue progress bar to the line if they intend to meet their monthly goals. The algorithm within system 10 that sets the daily position of indicator line 6070 may compute its position using the overall goal data, the accomplished time thus far for the current month, the number of days remaining in the month and other data to properly compute the daily position of the line 6070.

It is important to note that progress bars 6062 and 6064 may utilize data from databases associated with local components 200 and backend systems 400 in order to calculate and display the usage time vs. goals in real time to the user. Given this, it can be seen that these progress bars 6062, 6064 may require for system 10 to synchronize data across the components and databases across the system 10 as described above to ensure that the most accurate and up-to-date data is used during the calculations of the progress bars 6062, 6064.

It should be noted that system 10 may also interface and generally interact with other types of programs, applications and devices in addition to the email, Microsoft Office, landline telephony, mobile telephony, etc. described in detail above. For example, system 10 may interface with Internet browser applications such as Firefox, Explorer, Chrome, etc., or with non-browser applications such as enterprise resource planning (ERP) software such as Microsoft Dynamics AX, or with accounting software such as QuickBooks. It should also be noted that system 10 may interface and interact with local computers and backend systems. That is, system 10 may interface with applications and programs that may be installed and run on a single or multiple local computers, either stand-alone or networked, or system 10 may interface with applications and programs that may be installed and run on servers, cloud platforms or other types of backend systems.

For example, system 10 may interface with programs such as Microsoft Office and Firefox browser that may be installed and run on local computers. In addition, system 10 may also interface with programs such as Microsoft Dynamics AX or QuickBooks that may be installed and run on servers, cloud platforms or other types of backend systems. In this second scenario, system 10 may interface with the backend systems via computer networks, the Internet, LANs, wireless systems or through other types of networks or systems.

System 10 may also comprise and be configured with a variety of different databases that may be configured to be accessible by system 10 and by the users' local computers and backend systems. These databases may be configured to store data associated with system 10 and the various programs, applications and backend systems that system 10 may interface with. The databases may also store data associated with the various users and user activities, events, procedures and actions that system 10 may track, interact with or otherwise collect data on.

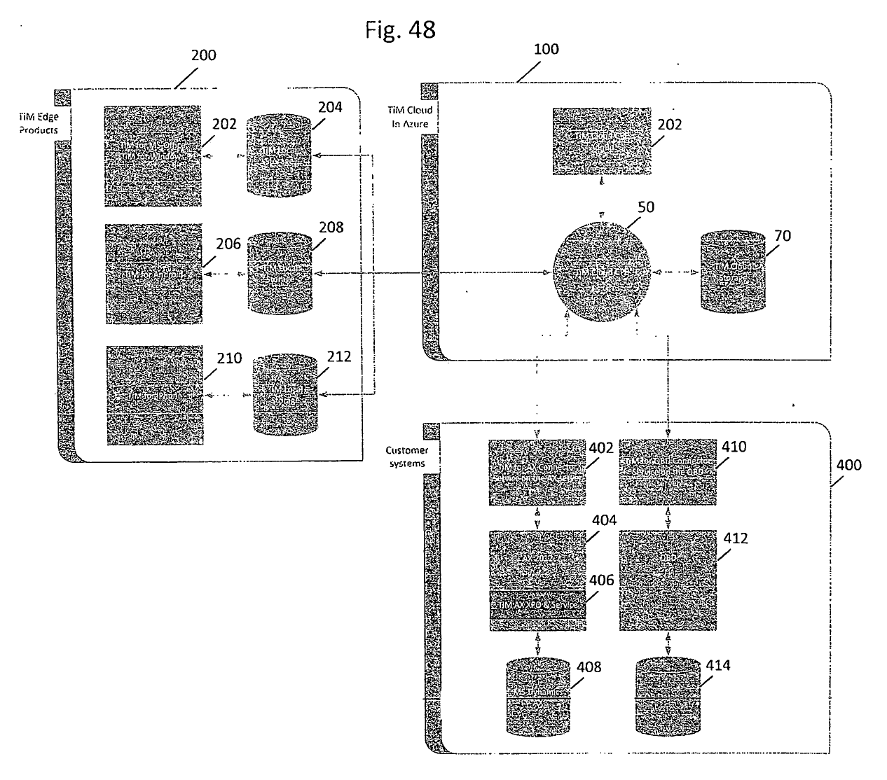

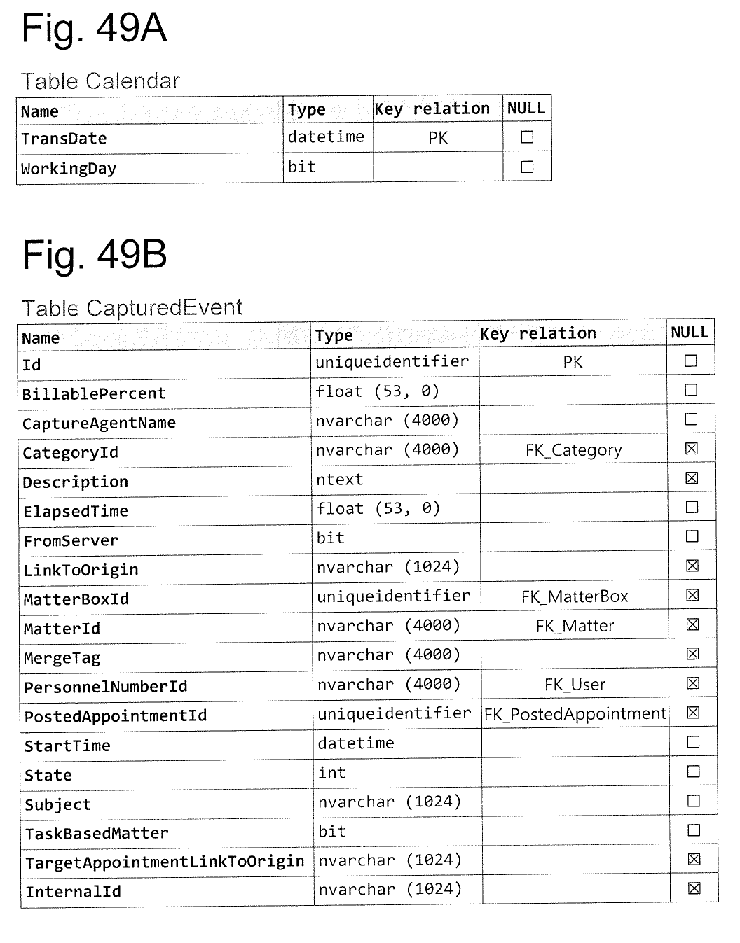

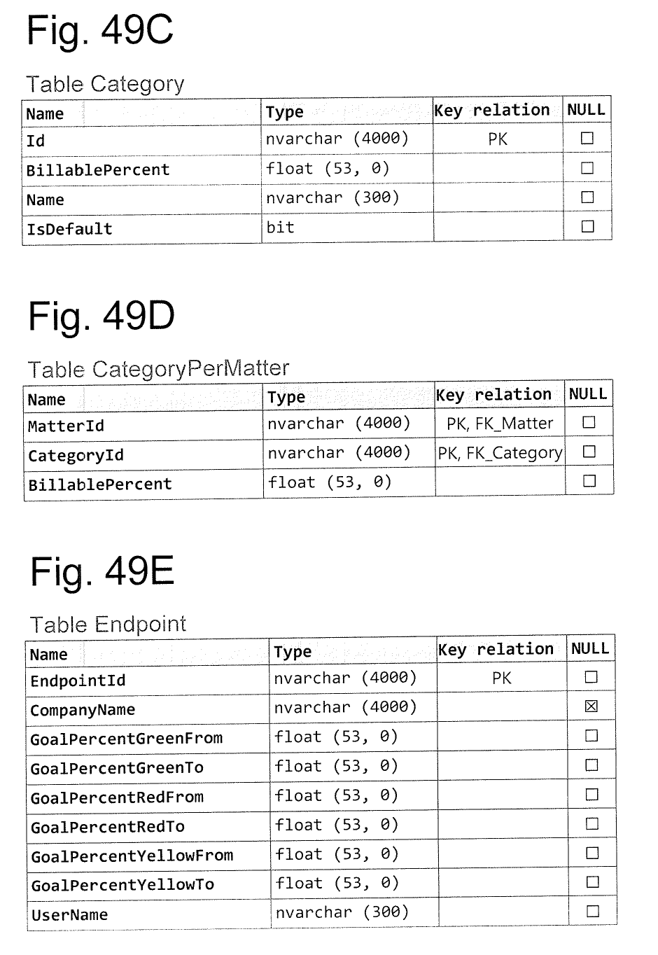

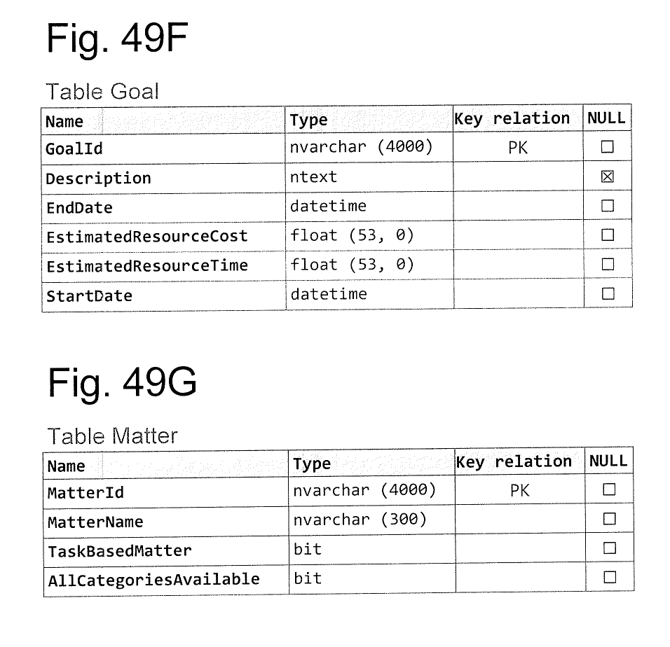

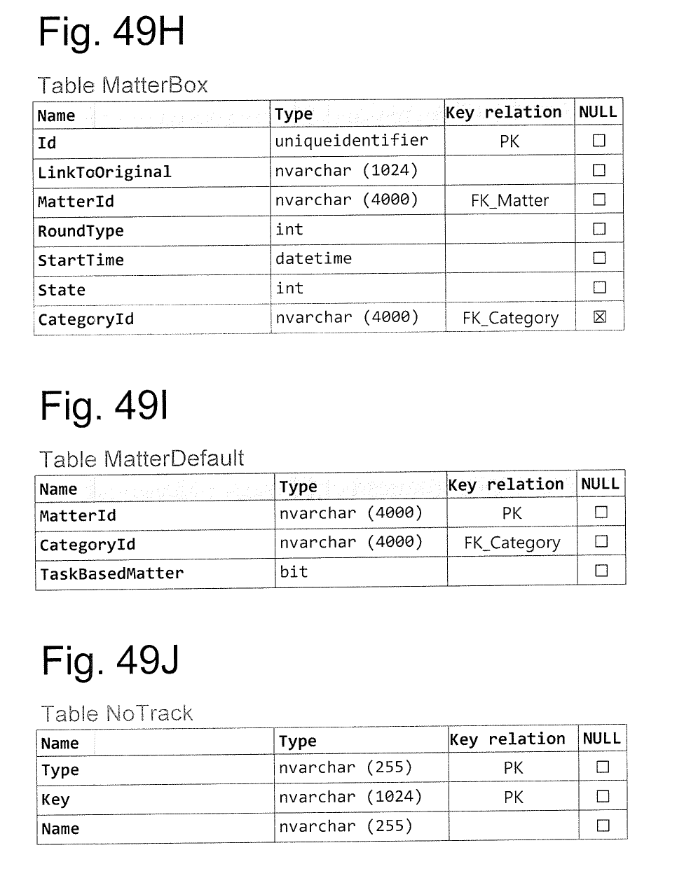

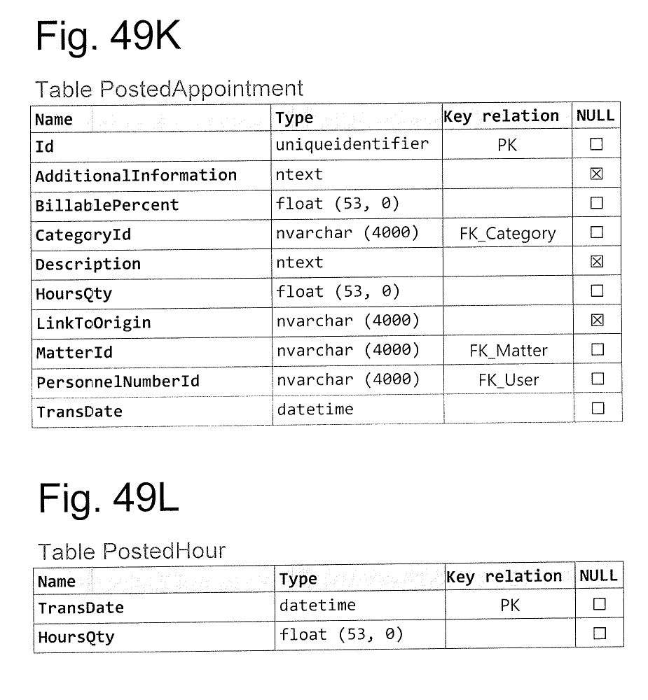

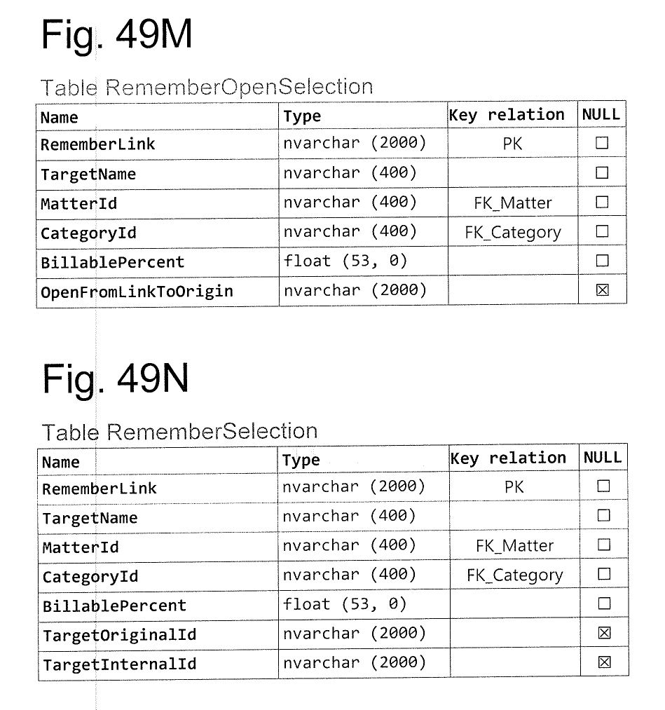

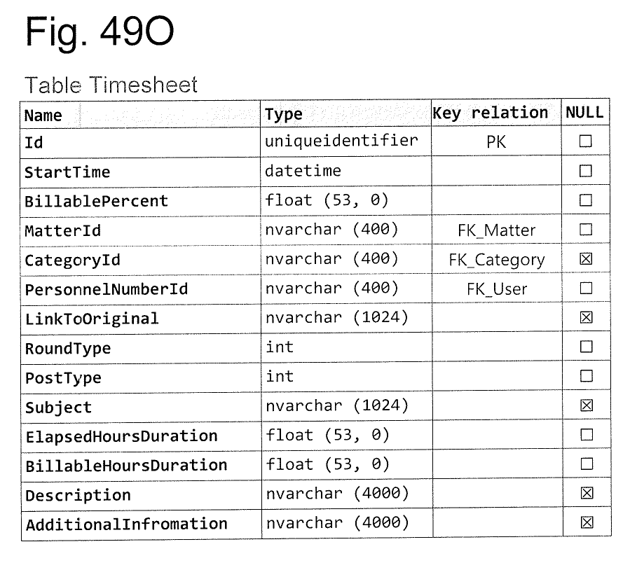

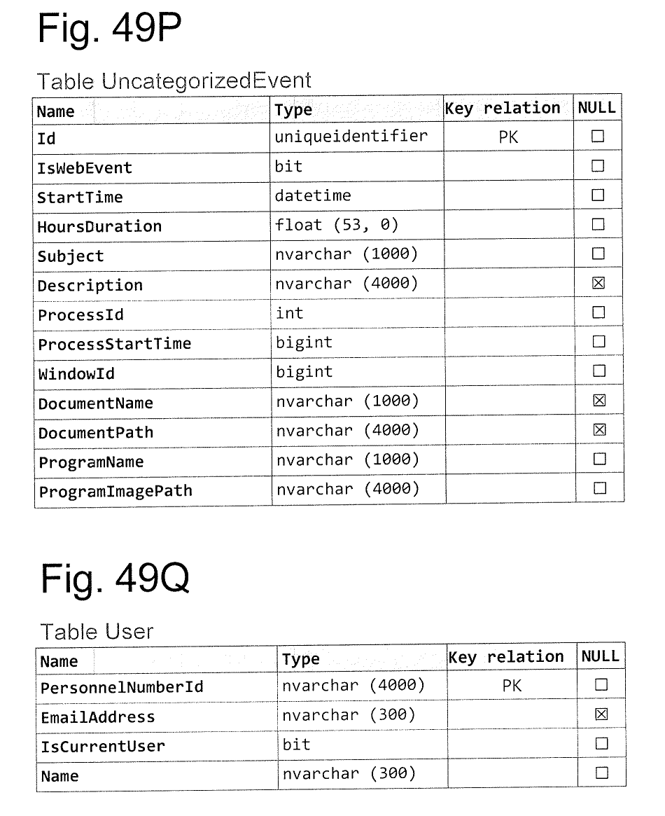

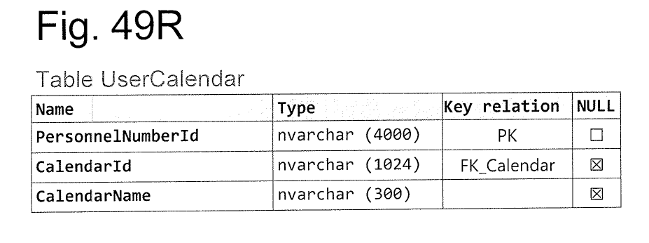

As described in further detail below, the configuration of these various databases and the overall architecture of system 10 may act to increase the efficiency of the dataflow across the users' computers and backend systems thereby improving the performance of the user's computers and these systems as a whole. This will now be described in further detail with reference to FIG. 48 and FIG. 49.

In an embodiment of this type as depicted in FIG. 48, system 10 may comprise of three main components: the cloud based platform 100, the local computer components 200 and the backend system components 400. Cloud based platform 100 may include cloud cross platform exchange (CPE) 50, backend or cloud storage 70 and cloud CPE admin 102. Local computer components 200 may include system 10 components loaded and run on users' local computers in association and in conjunction with local programs and applications.

As shown in FIG. 48, these local components 200 may include but are not limited to a Microsoft Office and Windows component 202, an Android component 206 and an iPhone component 210. These local components 200 may have similar functionality as Microsoft Office interface 33 and cell phone interface 37 as described above with reference to FIG. 1, such as providing the ability for system 10 to interface and share event/project time usage data between the local components 200 and the cloud platform 100.

For example, Microsoft Office and Windows component 202 may have similar functionality as Microsoft Office interface 33 in reference to FIG. 1 as described in prior sections. However, Microsoft Office and Windows component 202 may have additional functionality.

It should also be noted that while Microsoft Office and Windows component 202 is depicted as a single local component 200 in FIG. 48, it may be two or more separate and different local components 200. For example, one of the separate and different components may be a Microsoft Office component that may be designed specifically to interface with Microsoft Office programs. In this scenario, the second separate and different component may be a Window component that may be designed specifically to interface with or otherwise track time usage on other Windows-based programs other than Microsoft Office. As described in sections below, each of these separate components may be associated with the same or different local storage units. In any event, Microsoft Office and Windows component 202 may be a single local component 200 or may comprise multiple local components 200.

In addition, Android component 206 and an iPhone component 210 may provide similar functionality as cell phone interface 37 in reference to FIG. 1 as described in prior sections. It should be clear, however, that Android component 206 may be generally configured to interface with Android mobile devices and iPhone component 210 may be generally configured to interface with Apple OS mobile devices (iPhones, iPads, etc.). In addition, Android component 206 and an iPhone component 210 may have additional functionality compared to cell phone interface 37. Other types of local components 200 that may allow system 10 to interface with other types of local programs and applications not specifically depicted in FIG. 48 may also be included and utilized.

In addition, each system 10 component 202, 204, 206 may have a system 10 database or local storage associated with it. For example, Microsoft Office and Windows component 202 may be configured with local storage 204, Android component 206 may be configured with local storage 208, and iPhone component 210 may be configured with local storage 212. Additional local storage units may also be utilized.

As depicted by the communication arrows in FIG. 48, each local component 200 of system 10 may interface with its respective local storage database through a service or data driver embedded within the local components 200. For instance, Microsoft Office and Windows component 202 may have a driver associated with local storage 204 such that it may write and read data to and from local storage 204 as required by system 10.

Microsoft Office and Windows component 202 may write and read any number and kind of data to and from local storage 204 that system 10 may utilize or otherwise require during its operation. For example, local storage 204 may include the tables shown in FIGS. 49A-49R, with each table containing one or more variables that system 10 may utilize. In one example, system 10 may write the MatterID and MatterName variable to the Table Matter table shown in FIG. 14G when a new matter is created and named by the user.

The tables and variables shown in FIGS. 49A-49R are examples for the purpose of demonstration and that any number of other tables and variables may also be utilized.

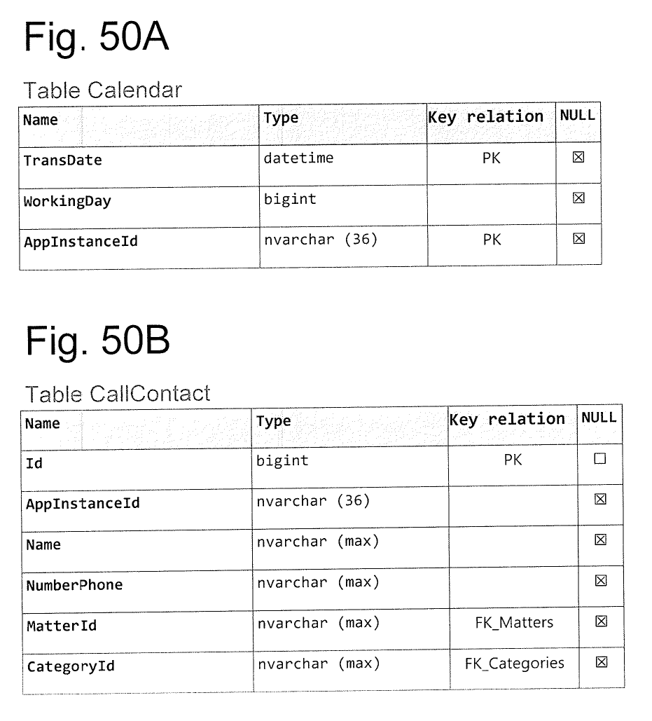

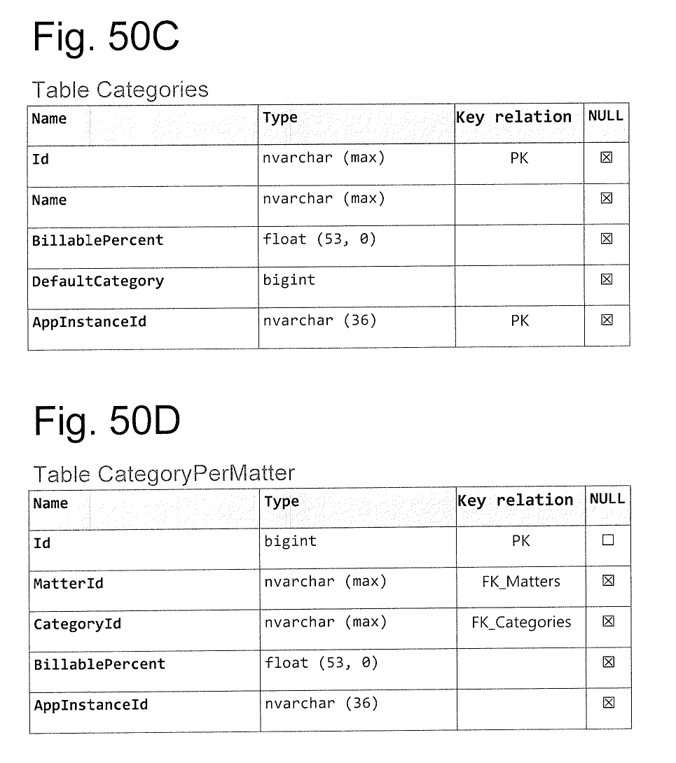

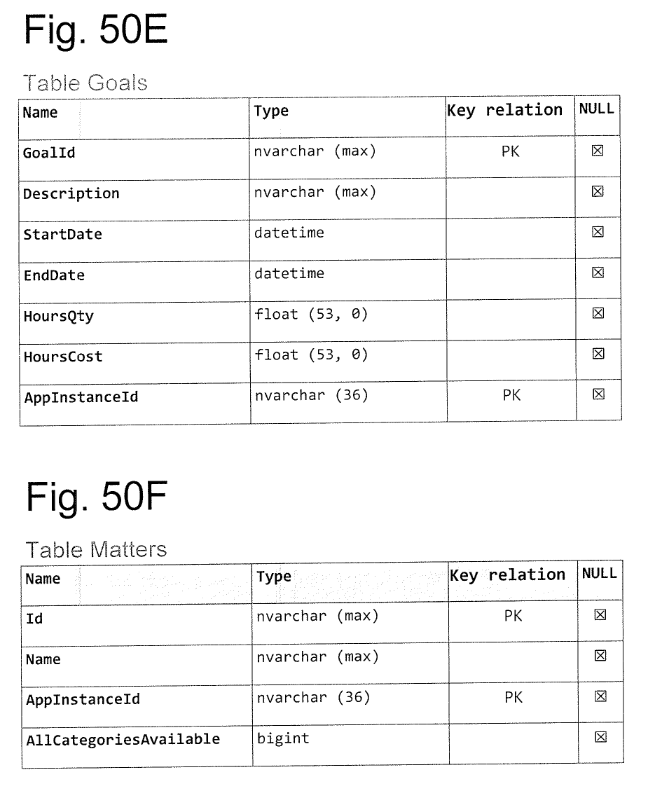

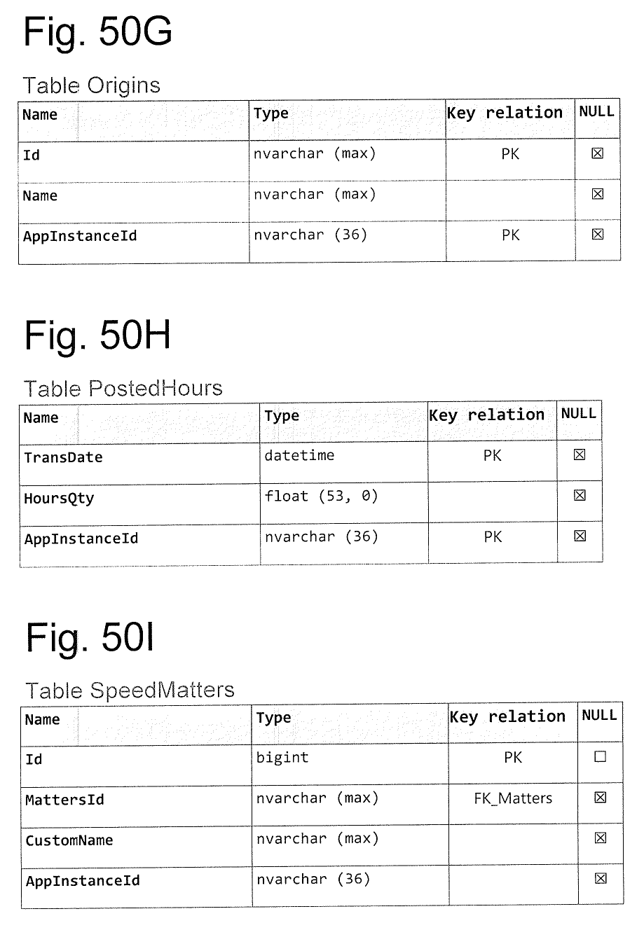

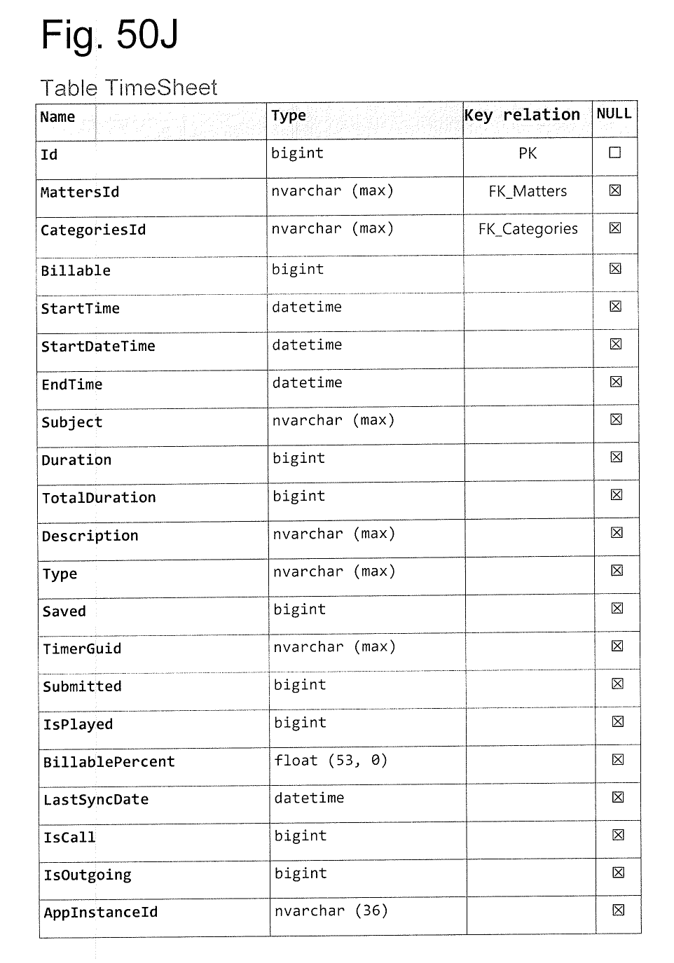

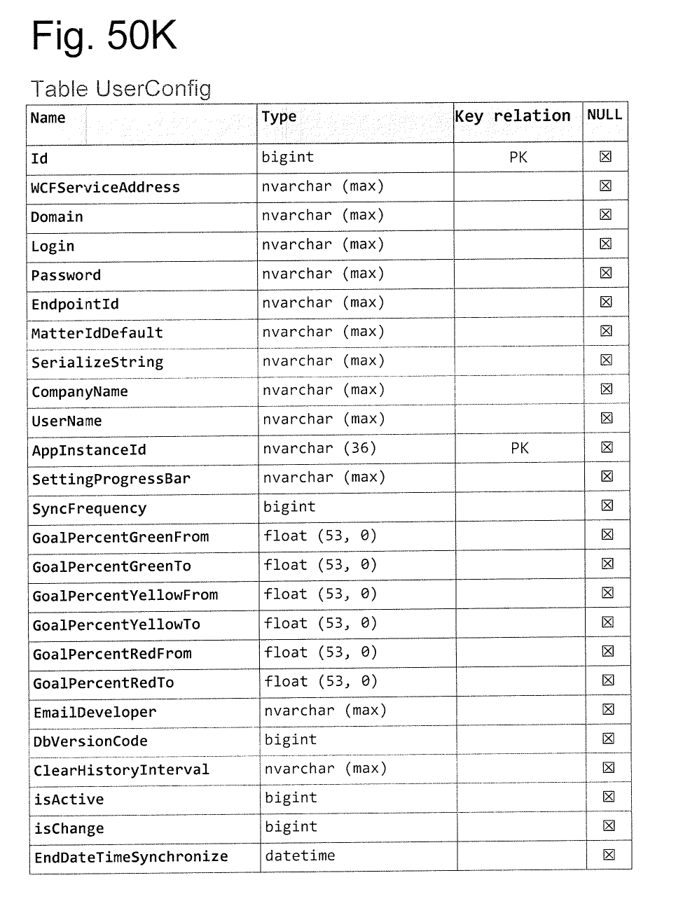

In a similar fashion, Android component 206 may have a driver associated with local storage 208 such that it may write and read data to and from local storage 208. Also, iPhone component 210 may have a driver associated with local storage 212 such that it may write and read data to and from local storage 212. Note that tables in local storage 208 and tables in local storage 212 may have similar structure and variables but this may not always be the case. Example tables that may exist in local storage 208 and in local storage 212 may include the tables shown in FIGS. 50A-50K. For example, system 10 may write the NumberPhone variable to the Table CallContact table shown in FIG. 50B when a new phone number is used and/or entered by the user. Note that the tables and variables shown in FIGS. 50A-50K are examples for the purpose of demonstration and that any number of other tables and variables may also be utilized.

As stated above, cloud based platform 100 may include cloud cross platform exchange (CPE) 50, backend or cloud storage 70 and cloud CPE admin 102. Cloud CPE 50 and backend or cloud storage 70 may comprise a cloud computing platform and service such as Microsoft Azure. Other types of platforms as discussed in prior sections may also be utilized. In addition, cloud storage 70 may be a different type of database or storage platform such as a stand-alone database, a database specifically designed and created for use with system 10 and CPE 50, or any other type of database platform.

As such, cloud CPE 50 may provide for system 10 to interface with Microsoft Office and Windows component 202 and its associated local storage 204, with Android component 206 and its local storage 208, and with iPhone component 210 and its local storage 212. For example, CPE 50 may include drivers associated with local storages 204, 208 and 212 such that it may write and read data to and from the databases 204, 208 and 212 directly. This is depicted by the communication arrows extending from cloud CPE 50 to each of the local storage units 204, 208, 212 as shown in FIG. 48.

In addition, CPE 50 may write and read data to and from the databases 204, 208 and 212 by interfacing with the databases 204, 208 and 212 through local components 200 that may include the drivers necessary for this reading/writing to occur. This is depicted by the communication arrows extending from cloud CPE 50 to each of the local components 202, 206, 210 as shown in FIG. 48.

In either scenario, it can be seen that system 10 may provide for data to be written to local storages 204, 208 and 212 by both local components 200 and by cloud platform 100 such that the data may be shared by the various components across system 10. For example, Microsoft Office and Windows component 202 may write an event time tracking variable to local storage 204, and cloud CPE 50 may then read the newly written event variable from the local storage 204 in order to utilize the variable in its various algorithms, calculations and reports to the user. Similarly, cloud CPE 50 may write a new variable to local storage 204 for Microsoft Office and Windows component 202 to retrieve and utilize in calculations and reports on its end.

It can be seen that this process of sharing data between cloud CPE 50 and the local components 200 via local storage units 204, 208, 212 may provide for a large quantity of data to efficiently flow between local components 200 and cloud platform 100 back and forth as required by system 10. Details on the synchronization of the data flow are described in further detail in later sections.

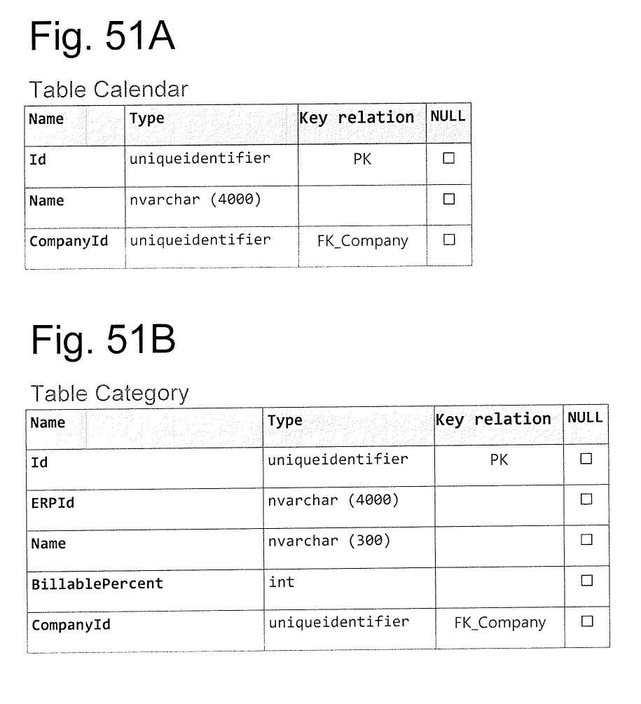

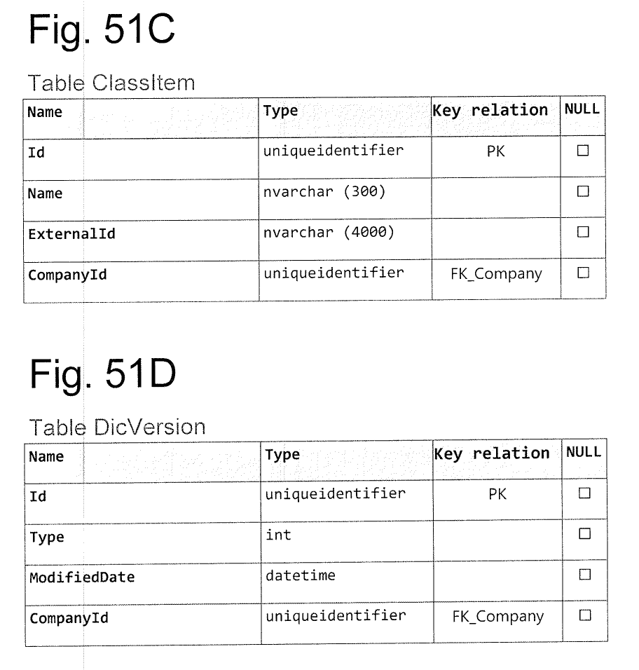

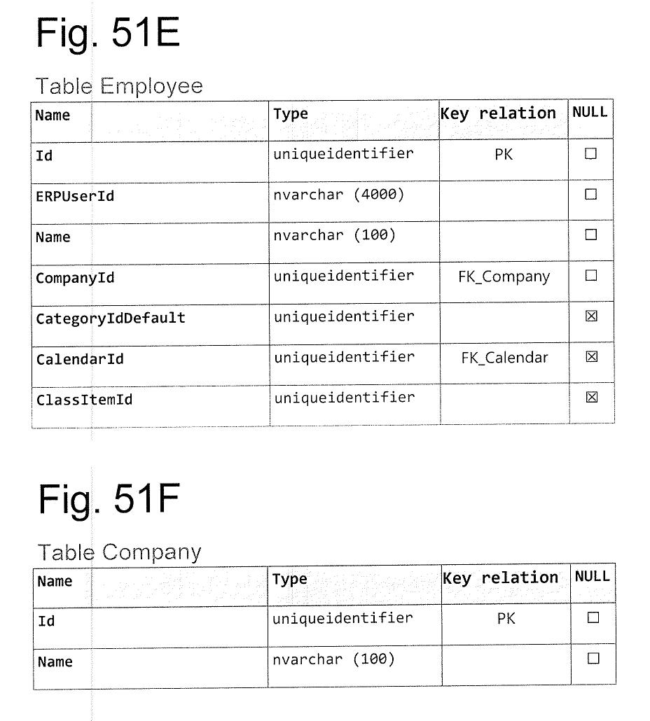

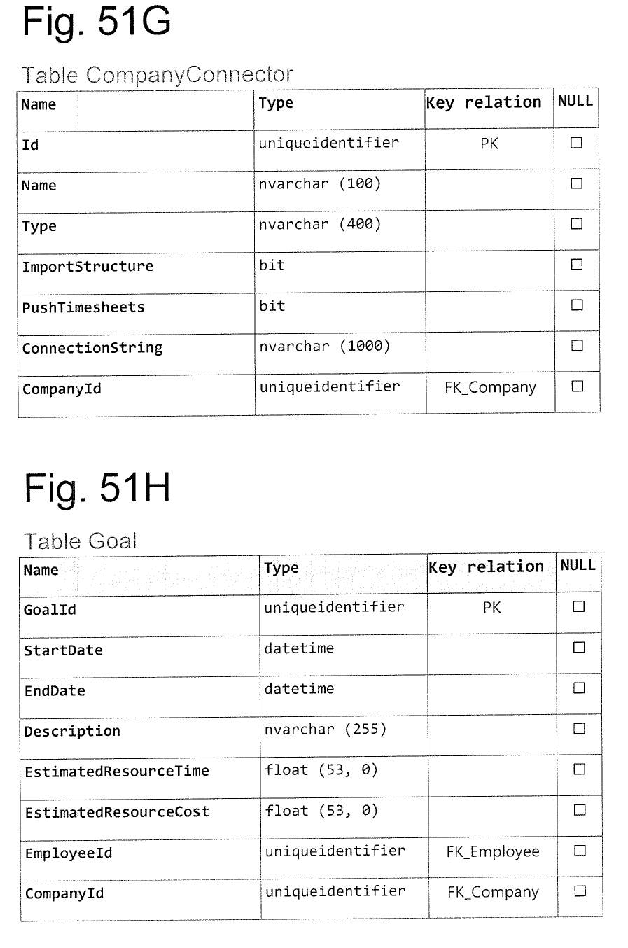

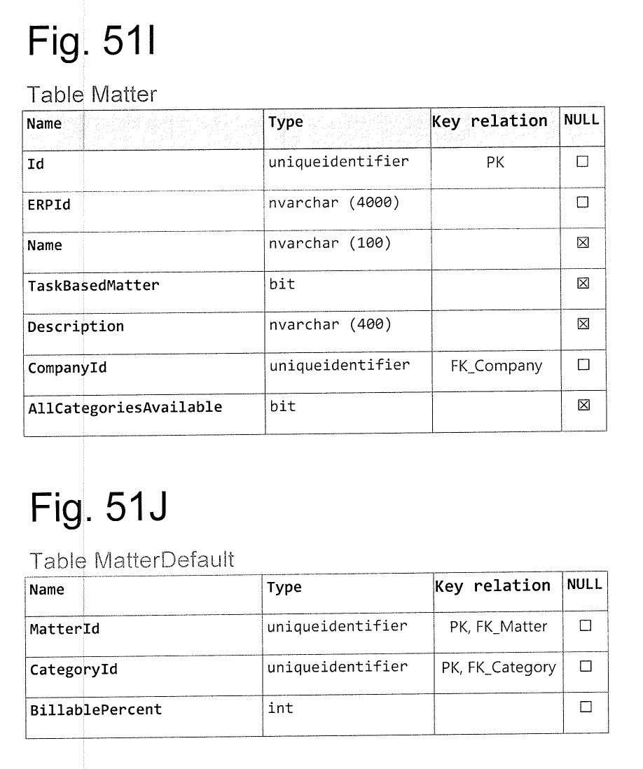

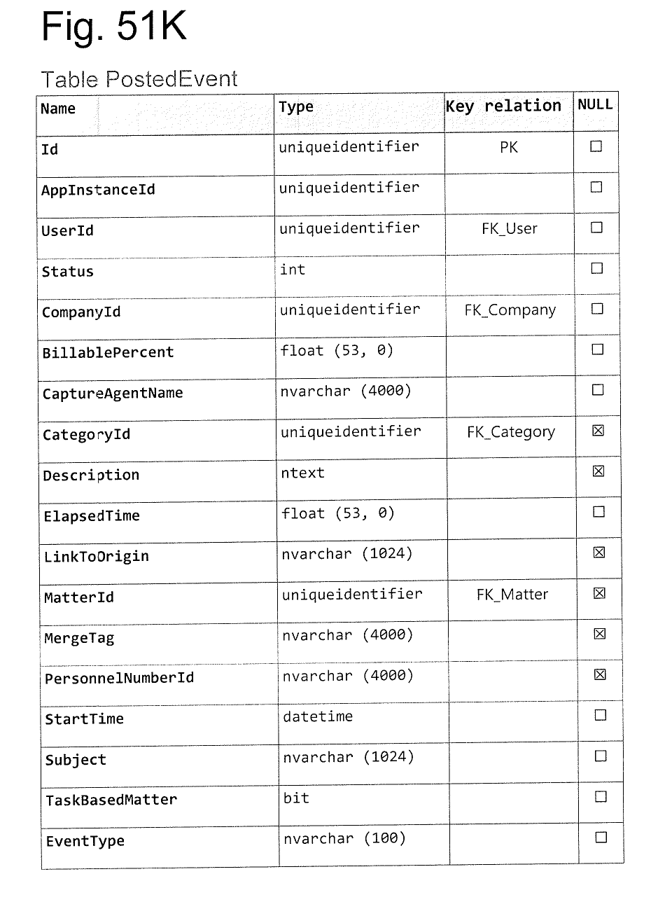

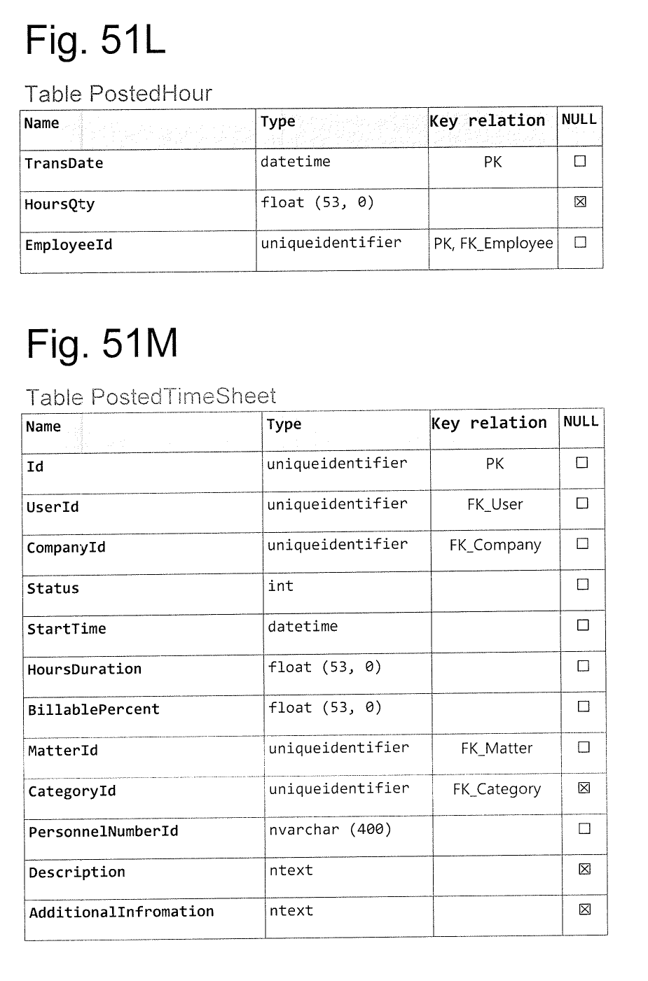

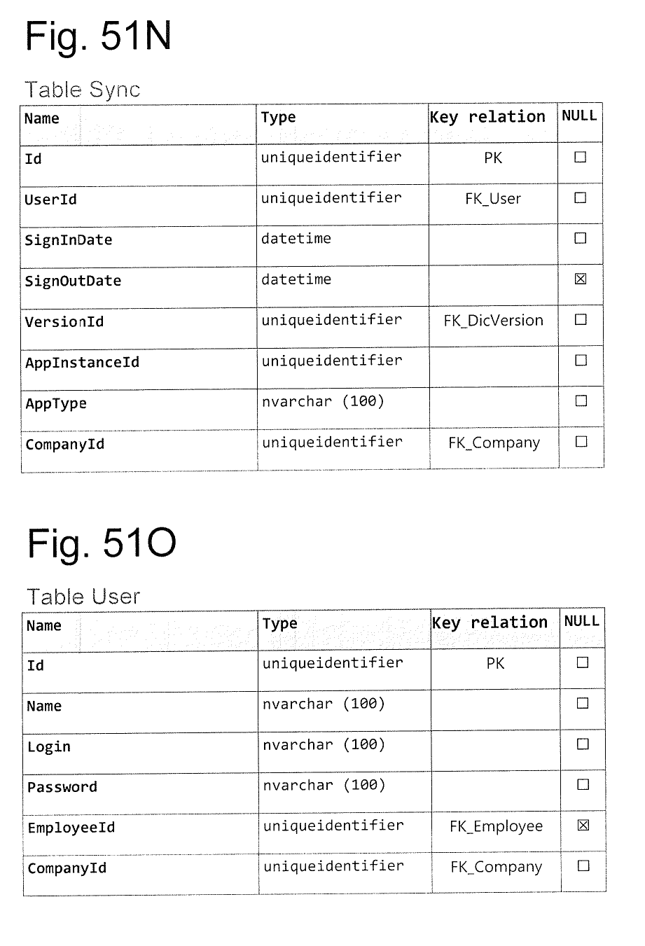

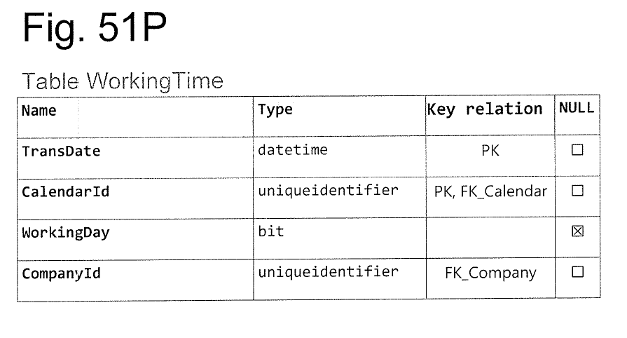

In addition, cloud storage 70 may be configured with cloud CPE 50 such that data flowing from local components 200 to cloud CPE 50 may also be written to and read from cloud storage 70 as necessary for data processing. This provides for local based data to flow to the cloud 100 and for cloud based data to flow to the local components 200 in an optimized manner. Example tables that may exist in cloud storage 70 may include the tables shown in FIGS. 51A-51P. Using the example from above, the MatterID variable that may have been written to the Table Matter table in local storage 204 may also be written to the Table PostedEvent table in cloud storage 70 as depicted in FIG. 51K.

Local storage databases 204, 208 and 212 and cloud storage 70 may be relational databases that may be normalized to a small or the smallest component in order to optimize their efficiency. Accordingly, the variables utilized by system 10 may appear in as few as one of the tables within databases 204, 208, 212, 70 and the system may utilize keys to link the tables and variables across each local storage database 204, 208, 212 and cloud storage 70. This structure further streamlines the data flow across system 10 throughout the users' local and backend systems and the cloud platform thus improving the performance of the computers, the backend systems and the overall platform.

Still referring to FIG. 48, example user backend systems that system 10 may interface with may include but are not limited to enterprise resource planning (ERP) software such as Microsoft Dynamics AX 404 and accounting software such as QuickBooks 412. Other backend systems and platforms may also be incorporated with system 10. In addition, each backend system 404, 412 may have a database or local storage associated with it that may be configured to store data associated with the operation of the backend system. For example, Microsoft Dynamics AX 404 may be configured with backend storage 408 and QuickBooks 412 may be configured with backend storage 414.

For such backend systems, system 10 may include a connector service application, plug-in or other type of software that may be loaded onto or in conjunction with each backend system to allow system 10 to properly interface with the backend system and its database. For example, system 10 may include a connector service 402 on the Microsoft Dynamics AX 404 system and a connector service 410 on the QuickBooks 412 system. These connector services 402, 410 may act as a bridge between each associated backend system and cloud platform 100 to allow system 10 to directly interface with each respective backend system and their associated databases 408, 414 to access data and routines.

In addition, system 10 may include additional code components such as AX XPO 4 and Service Module 406 as shown in FIG. 48 that allow system 10 to interface with backend system 404 and backend database 408 in a bi-directional manner. As such, the backend data in databases 408 and 414 may virtually appear as cloud data located on cloud platform 100 directly. At this point the backend data may then be stored and processed within cloud storage 70 to be utilized by system 10.

In addition, cloud CPE 50 may write data to backend storage units 408, 412 via connector services 402, 410 and/or AX XPO 4 and Service Module 406 such that backend systems 404, 412 may read the data to utilize in their operations. This way, it can be seen that system 10 may provide for data to be written to backend databases 408, 414 by both backend systems 404, 412 and by cloud platform 100 such that the data may be shared by the various components across system 10. For example, backend system 404 (which may be an ERP system in this example) may interact with connector service 402 and/or AX XPO 4 and Service Module 406 and write an event time tracking variable to backend database 408, and cloud CPE 50 may then read the newly written event variable from the backend database via connector service 402 and/or AX XPO 4 and Service Module 406 in order to utilize the variable in its various algorithms, calculations and reports to the user. Similarly, cloud CPE 50 may write a new variable to database 408 via service connector 402 and/or AX XPO 4 and Service Module 406 for backend system 404 to retrieve and utilize in calculations and reports on its end.

It can be seen that this process of sharing data between cloud CPE 50 and the backend systems 400 via service connectors 402, 410 and/or AX XPO 4 and Service Module 406 may provide for a large quantity of data to efficiently flow between backend systems 400 and cloud platform 100 back and forth as required by system 10. Details on the synchronization of the data flow will be described in further detail in later sections.

It can be seen that because of this overall system 10 architecture described above, large amounts of data may be shared more efficiently, simultaneously and in real time, between the programs running on the users' local computers and their backend systems 400 via system 10 and cloud platform 100.

In addition, cloud platform 100 may also include CPE admin 102 that may allow the user to interface directly with cloud CPE 50. CPE admin 102 may be in the form of a webpage, a server control panel, a graphical user interface (GUI) or any other type of interface or tool that may allow the user to sufficiently interface with cloud CPE 50. CPE admin 102 may allow the user to apply settings to CPE 50, enter user information, run reports as described above and generally interact with system 10. Note that cloud platform 100 may be a multi-tenant cloud architecture such that multiple users and systems may interface with cloud platform 100 simultaneously.

As described above, each main local component 200 of system 10 may have an associated database that may be written to and read from both the local components 200 and the cloud CPE 50. And each backend system 400 component may also have an associated database that may also be written to and read from both the backend systems and the cloud CPE 50. Accordingly, given the vast amount of data that may flow to and from local storage units 204, 208, 212, cloud storage 70 and backend databases 408, 414, in order for all the data variables in all the databases and components to be consistent across all of system 10 at any given moment in time, system 10 may include a synchronization system. Such a synchronization system and methodology may be critical for the users' local computers and backend systems to work in efficient partnership while achieving the objectives set forth and expected by the use of system 10.

In addition, such a synchronization system and methodology may also be critical for scenarios where a user may have multiple local computers with system 10 loaded and running on each computer. In this situation, it may be critical that all local computers running system 10 have consistent data across all the system 10 databases that may reside on the different local computers. If some data variables in some of the databases on some of the local computers are not up-to-date and consistent with the same data variables in different databases on different local computers, errors may occur and system 10 may not accurately track the time usage across each matter/project efficiently. It can therefore be seen that a database synchronization system and methodology may greatly increase the performance and efficiency of the users' local computers as they interact with each other and system 10.

As described in prior sections, a user of system 10 may interact with the various elements and components of system 10 in a variety of ways. And in each interaction, the user may cause data to be written, read, updated, edited, created or otherwise altered across various databases within the system 10. Accordingly, a synchronization system may be necessary for each type of interaction that may take place.

For example, a user may create a new matter/project in one of their backend systems 400. In this scenario, the user may create a new matter/project within a backend system that may be designated within the settings of system 10 as a matter/project that may be tracked by system 10 as described above. Once this happens, cloud CPE 50 may be set to poll the backend systems 400 on a predefined interval, for instance every ten minutes, such that the new matter/project made during the polling interval is identified. Note that cloud CPE 50 may also be forced manually by the user to poll the backend systems 400 instead of waiting for a scheduled polling as described above, and that this forced manual polling may be initiated through the cloud CPE admin 102, Microsoft Office and Windows component 202, Android component 206, iPhone component 210 or through other settings control dialog or dashboard. Upon identifying the new matter/project, cloud CPE 50 may interface with the particular backend system in which the new matter/project was created, for example backend system 404 with database 408, and extract the new matter/project information via connector service 402. The new matter/project data may then be stored to cloud storage 70.

Once the new matter/project data is stored in cloud storage 70, the local components 200, for example Microsoft Office and Windows component 202, may utilize exposed web services, APIs or other network systems or protocols to poll cloud CPE 50 and its associated cloud database 70. Note that this polling may be on a predefined timed interval, may be manually forced as described above, or may be triggered by cloud CPE 50 notifying Microsoft Office and Windows component 202 that there may be a new matter/project to be shared. Upon polling cloud CPE 50, the new matter/project may be identified and its information may be extracted from cloud storage 70 and stored to local storage 204. Once the data regarding the new matter/project is stored on local storage 204, it may be available for use by Microsoft Office and Windows component 202.

Similarly, local components 200 other than Microsoft Office and Windows component 202 such as Android component 206 and iPhone component 210 may also utilize system 10 web services or other network systems or protocols to poll cloud CPE 50 and its associated cloud database 70, to identify and store the new matter/project data to their associated local storage units 208, 212 respectfully, and to then utilize and process the data accordingly.

In another example of how the user may interact with system 10 that may then require the system 10 to synchronize data across the databases, the user may create a new category in one of their backend systems 400. In this scenario, the synchronization system and methodology described above for new matter/projects may be followed, but with the new category information and data being polled, stored, pushed and otherwise shared throughout the various databases of system 10 instead of the new matter/project data and information.

In another example of how the user may interact with system 10 that may then require the system 10 to synchronize data across the databases, the user may create a new time goal in the cloud storage 70 or in one of the backend systems 400. In this scenario, the synchronization system and methodology described above for new matter/projects may be followed, but with the new time goal information and data being polled, stored, pushed and otherwise shared throughout the various databases of system 10 instead of the new matter/project data and information.

In addition, the calculation of some of the data metrics that system 10 may compute, analyze and otherwise evaluate may also require the system 10 data synchronization as described above. For instance the “percent complete to goal” or the “actual to goal” metric may not be accurate without data synchronization. In one example to show this, note that the “percent complete to goal” data metric is calculated by dividing the total posted time for any particular matter/project across all system 10 components by the time goal for the individual time period (day, week, month or year) and then multiplying the result by one hundred.

If the user posts time to a particular matter/project across different components, such as on local components Microsoft Office and Windows component 202, on Android component 206 and on iPhone component 210, in order for system 10 to properly calculate the “actual to goal” it must have the total and up-to-date time posting data from each local component to use in the calculation. And if the system 10 data is not synchronized, then the system 10 may not have the accurate sum of the posted time across the different components 202, 206, 210, and the calculation will be in error. It can therefore be seen that the data synchronization across the various components of system 10 is critical for the local computers, the backend systems and system 10 as a whole to function properly by providing for the use of the correct data.

It should be noted that in the above example of synchronizing the time posted data across the various local components 202, 206 and 210, and potentially backend systems 404, 412 with each other and cloud platform 100, that a similar synchronization system and methodology as described above in relation to new matter/projects may be followed, but with the data flowing from the local components 200 and backend systems 400 to the cloud CPE 50 for the metric calculation. For example, as the user posts time usage to each particular matter/project across different components, such as on local components Microsoft Office and Windows component 202, on Android component 206 and on iPhone component 210, each local component 200 may store the time posts to their associated local storage units 204, 208 and 212 respectively.

Cloud CPE 50 may then poll each local storage unit 204, 208, 212 and/or each local component 202, 206, 210 to retrieve the latest and most up-to-date time usage data for each component 200 and store it to cloud storage 70. As described above, this polling may happen on a predefined interval or may be manually forced. Similarly, as the user posts time usage to each particular matter/project across different backend systems, such as backend system 404 and 412, each backend system 400 may store the time posts to their associated backend databases 408, 414 respectively.

Cloud CPE 50 may then poll each backend database 408, 414 and/or each backend system 404, 412 via their associated connector services 402, 410 to retrieve the most up-to-date time usage data for each backend system 400 and store it to cloud storage 70. This polling may also happen on a predefined time interval or may be manually forced. Once all the time usage data across all local components 200 and backend systems 400 has been synchronized by system 10 and stored to cloud storage 70 as described above, CPE 50 may then calculate the various data metrics by using the correct data, thereby ensuring that the most accurate and precise data metrics are provided to the user.

In another example that may require data synchronization, an email time event may create a data record in local storage 204 associated with local Microsoft Office and Windows component 202. In one example, a user may reply to an email that is associated with an identified matter/project, and upon doing so, a new time event record associated with the email activity and the matter/project may be created in local storage 204 by Microsoft Office and Windows component 202. Once the time event record is created, it may be polled by cloud CPE 50 on the next scheduled automatic synchronization event or on a manually forced synchronization event and then stored to cloud storage 70.

In addition, a document time event, such as a time usage recording event associated with the use of Microsoft Word, Excel, PowerPoint, Visio, Visual Studio or other types of programs or applications running on the users' local computer, may cause the creation of a data record in local storage 204 associated with local Microsoft Office and Windows component 202. Upon the creation of this new document time event, cloud CPE 50 may poll local storage 204 on the next scheduled automatic synchronization event or on a manually forced synchronization event and then store the event record to cloud storage 70, thus synchronizing the data across system 10.

As stated in above sections, event entries that may represent captured usage time that have been approved by the user may be “posted” to the financial system of cloud storage 70 for billing, accounting and other analytics purposes. And this process may also require data synchronization across system 10. For example, when a user posts a time event, the event may be pushed from local storage 204 associated with local Microsoft Office and Windows component 202 to cloud storage 70. From here, cloud CPE 50 and cloud storage 70 may push the time event to the users' backend systems 400.

Once this has been successfully accomplished, cloud CPE 50 may receive a confirmation from backend system 400 (possibly through connector services 402 or 410) and may update cloud storage 70 to reflect this confirmation. Cloud CPE 50 and cloud storage 70 may then update local storage 204 and local Microsoft Office and Windows component 202 that the time event has been posted. This synchronization may occur on a predetermined timed interval or through a manually forces synchronization event. This sequence may also trigger system 10 to turn the color code of the posted event to green in the system 10 timesheet calendar which may notify the timekeeper that the time event has been posted to the financial system to be incorporated into invoices and to be available for business analytics and other backend functions.

Other example events that may require data synchronization may be the case of a manual time event or a phone call time event being captured by a local component 200 such as Android component 206 or iPhone component 210. Once these types of time events are initialized, the data synchronization sequence across system 10 may be similar to the data synchronization sequence described in above section with regards to an email time event or a document time event in association with Microsoft Office and Windows component 202 and local storage 204.

Although certain presently preferred embodiments of the invention have been described herein, it will be apparent to those skilled in the art to which the invention pertains that variations and modifications of the described embodiments may be made without departing from the spirit and scope of the invention.

What is claimed is:

1. A system for tracking time spent working by a user, comprising:
one or more user interfaces that are configured to track time spent by the user working on one or more electronic devices or software applications and working on one or more matters;
a cross platform exchange that is connected to the one or more user interfaces, that receives tracked time information from the one or more user interfaces and that associates the tracked time information with the appropriate matter.

2. The system of claim 1, wherein the user is an attorney.

3. The system of claim 1, wherein the user is an accountant.

4. The system of claim 1, wherein the cross platform exchange uses tracked time information to provide financial and progress to goal information.

5. The system of claim 1, wherein the cross platform exchange creates matters with which to associated tracked time information.

6. The system of claim 5, wherein the cross platform exchange creates matters at a platform level and at a business software application level.

7. The system of claim 6, wherein the platform level is one of Apple 10S, Android or Microsoft Windows, and the business software application level is one of Microsoft Outlook, Microsoft Excel or other business application software.

8. The system of claim 7, wherein the cross platform exchange associates tracked information to a calendar.

9. The system of claim 1, wherein the one or more software applications includes electronic mail, instant messaging, video conferencing or a word processing software application.

10. The system of claim 1, wherein the one or more electronic devices includes a cell phone, a land line telephone or video services.

11. The system of claim 1, wherein the cross platform exchange is configured to receive tracked time information regarding manual events.

12. The system of claim 1, further comprising a back end that is connected to the cross platform exchange and that stores tracked time information and information regarding the matters worked on.

13. The system of claim 12, wherein the back end is configured to generate reports, invoices or business analytics based on the stored information.

14. The system of claim 1, further comprising at least one database configured with the one or more user interfaces.

15. The system of claim 14, further comprising at least one database configured with the cross platform exchange to which the cross platform exchange writes information.
